(19) United States
(12) Patent Application Publication
(10) Pub. No.: US 2025/0308187 A1
(43) Pub. Date: Oct. 2, 2025

(54) METHODS OF DISPLAYING MEDIA IN A THREE-DIMENSIONAL ENVIRONMENT

(71) Applicant: Apple Inc., Cupertino, CA (US)

(72) Inventors: James M. DESSERO, Morgan Hill, CA (US); Katherine W. KOLOMBATOVICH, New York, NY (US); William A. SORRENTINO, III, Kentfield, CA (US)

(21) Appl. No.: 19/093,012

(22) Filed: Mar. 27, 2025

Related U.S. Application Data
(60) Provisional application No. 63/571,298, filed on Mar. 28, 2024.

(51) Int. Cl. G06T 19/20

(52) U.S. Cl. CPC G06T 19/20; G06T 2219/2016

(57) ABSTRACT

In some embodiments, while displaying a representation of respective media in a three-dimensional environment with a first size relative to the three-dimensional environment, in response to detecting a change in playback location of the respective media, a computer system updates the representation of the respective media to have a second size relative to the three-dimensional environment.

### CROSS-REFERENCE TO RELATED APPLICATIONS

This application claims the benefit of U.S. Provisional Application No. 63/571,298, filed Mar. 28, 2024, the content of which is herein incorporated herein by reference in its entirety for all purposes.

### TECHNICAL FIELD

The present disclosure relates generally to computer systems that provide computer-generated experiences, including, but not limited to, electronic devices that provide virtual reality and mixed reality experiences via a display.

### BACKGROUND

The development of computer systems for augmented reality has increased significantly in recent years. Example augmented reality environments include at least some virtual elements that replace or augment the physical world. Input devices, such as cameras, controllers, joysticks, touch-sensitive surfaces, and touch-screen displays for computer systems and other electronic computing devices are used to interact with virtual/augmented reality environments. Example virtual elements include virtual objects, such as digital images, video, text, icons, and control elements such as buttons and other graphics.

### SUMMARY

Some methods and interfaces for interacting with environments that include at least some virtual elements (e.g., applications, augmented reality environments, mixed reality environments, and virtual reality environments) are cumbersome, inefficient, and limited. For example, systems that provide insufficient feedback for performing actions associated with virtual objects, systems that require a series of inputs to achieve a desired outcome in an augmented reality environment, and systems in which manipulation of virtual objects are complex, tedious, and error-prone, create a significant cognitive burden on a user, and detract from the experience with the virtual/augmented reality environment. In addition, these methods take longer than necessary, thereby wasting energy of the computer system. This latter consideration is particularly important in battery-operated devices.

Accordingly, there is a need for computer systems with improved methods and interfaces for providing computer-generated experiences to users that make interaction with the computer systems more efficient and intuitive for a user. Such methods and interfaces optionally complement or replace conventional methods for providing extended reality experiences to users. Such methods and interfaces reduce the number, extent, and/or nature of the inputs from a user by helping the user to understand the connection between provided inputs and device responses to the inputs, thereby creating a more efficient human-machine interface.

The above deficiencies and other problems associated with user interfaces for computer systems are reduced or eliminated by the disclosed systems. In some embodiments, the computer system is a desktop computer with an associated display. In some embodiments, the computer system is portable device (e.g., a notebook computer, tablet computer, or handheld device). In some embodiments, the computer system is a personal electronic device (e.g., a wearable electronic device, such as a watch, or a head-mounted device). In some embodiments, the computer system has a touchpad. In some embodiments, the computer system has one or more cameras. In some embodiments, the computer system has (e.g., includes or is in communication with) a display generation component (e.g., a display device such as a head-mounted device (HMD), a display, a projector, a touch-sensitive display (also known as a “touch screen” or “touch-screen display”), or other device or component that presents visual content to a user, for example on or in the display generation component itself or produced from the display generation component and visible elsewhere). In some embodiments, the computer system has one or more eye-tracking components. In some embodiments, the computer system has one or more hand-tracking components. In some embodiments, the computer system has one or more output devices in addition to the display generation component, the output devices including one or more tactile output generators and/or one or more audio output devices. In some embodiments, the computer system has a graphical user interface (GUI), one or more processors, memory and one or more modules, programs or sets of instructions stored in the memory for performing multiple functions. In some embodiments, the user interacts with the GUI through a stylus and/or finger contacts and gestures on the touch-sensitive surface, movement of the user's eyes and hand in space relative to the GUI (and/or computer system) or the user's body as captured by cameras and other movement sensors, and/or voice inputs as captured by one or more audio input devices. In some embodiments, the functions performed through the interactions optionally include image editing, drawing, presenting, word processing, spreadsheet making, game playing, telephoning, video conferencing, e-mailing, instant messaging, workout support, digital photographing, digital videoing, web browsing, digital music playing, note taking, and/or digital video playing. Executable instructions for performing these functions are, optionally, included in a transitory and/or non-transitory computer readable storage medium or other computer program product configured for execution by one or more processors.

There is a need for electronic devices with improved methods and interfaces for interacting with a three-dimensional environment. Such methods and interfaces may complement or replace conventional methods for interacting with a three-dimensional environment. Such methods and interfaces reduce the number, extent, and/or the nature of the inputs from a user and produce a more efficient human-machine interface. For battery-operated computing devices, such methods and interfaces conserve power and increase the time between battery charges.

In some embodiments, a computer system changes a size of a representation of respective media in a three-dimensional environment in response to detecting a change in a playback location of the respective media.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the Figs.

FIG. 1A is a block diagram illustrating an operating environment of a computer system for providing XR experiences in accordance with some embodiments.

FIGS. 1B-1P are examples of a computer system for providing XR experiences in the operating environment of FIG. 1A.

FIG. 2 is a block diagram illustrating a controller of a computer system that is configured to manage and coordinate a XR experience for the user in accordance with some embodiments.

FIG. 3A is a block diagram illustrating a display generation component of a computer system that is configured to provide a visual component of the XR experience to the user in accordance with some embodiments.

FIGS. 3B-3G illustrate the use of Application Programming Interfaces (APIs) to perform operations.

FIG. 4 is a block diagram illustrating a hand tracking unit of a computer system that is configured to capture gesture inputs of the user in accordance with some embodiments.

FIG. 5 is a block diagram illustrating an eye tracking unit of a computer system that is configured to capture gaze inputs of the user in accordance with some embodiments.

FIG. 6 is a flow diagram illustrating a glint-assisted gaze tracking pipeline in accordance with some embodiments.

FIGS. 7A-7Q illustrate examples of a computer system changing a size of a representation of respective media in a three-dimensional environment in response to detecting a change in playback location of the respective media.

FIG. 8 is a flowchart illustrating methods of changing a size of a representation of respective media in a three-dimensional environment in response to detecting a change in playback location of the respective media.

### DESCRIPTION OF EMBODIMENTS

The present disclosure relates to user interfaces for providing an extended reality (XR) experience to a user, in accordance with some embodiments.

The systems, methods, and GUIs described herein improve user interface interactions with virtual/augmented reality environments in multiple ways.

In some embodiments, a computer system changes a size of a representation of respective media in a three-dimensional environment in response to detecting a change in playback location of the respective media. In some embodiments, the computer system is in communication with a display generation component and one or more input devices. In some embodiments, while the computer system displays a representation of respective media in a three-dimensional environment with a first size relative to the three-dimensional environment, wherein the representation of the respective media overlaps a first portion of the three-dimensional environment from a current viewpoint of a user of the computer system, the computer system detects a change in the current playback location of the respective media. In some embodiments, in response to detecting the change in the current playback location of the respective media, the computer system displays the representation of the respective media with a second size relative to the three-dimensional environment such that the representation of the respective media overlaps a second portion of the three-dimensional environment from the current viewpoint of the user, different from the first portion of the three-dimensional environment. In some embodiments, detecting the change in the current playback location of the respective media includes detecting a change in aspect ratio of the respective media.

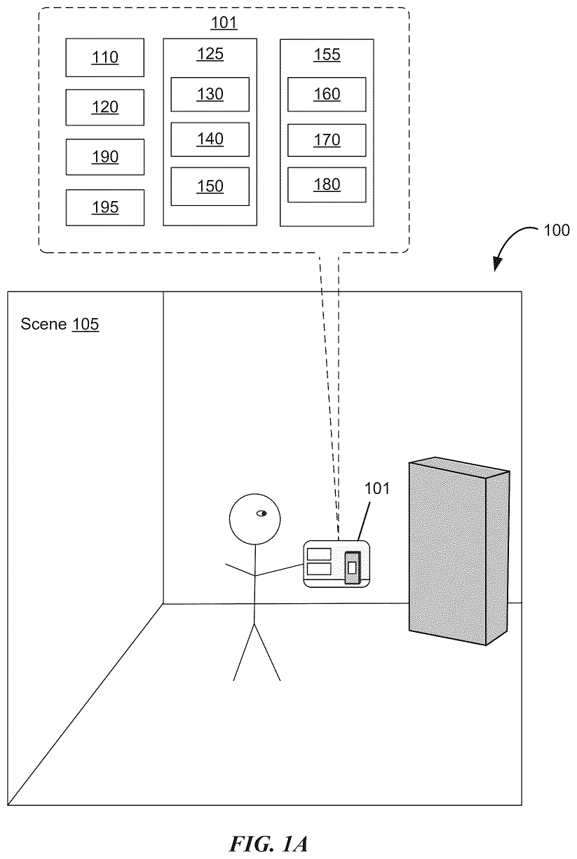

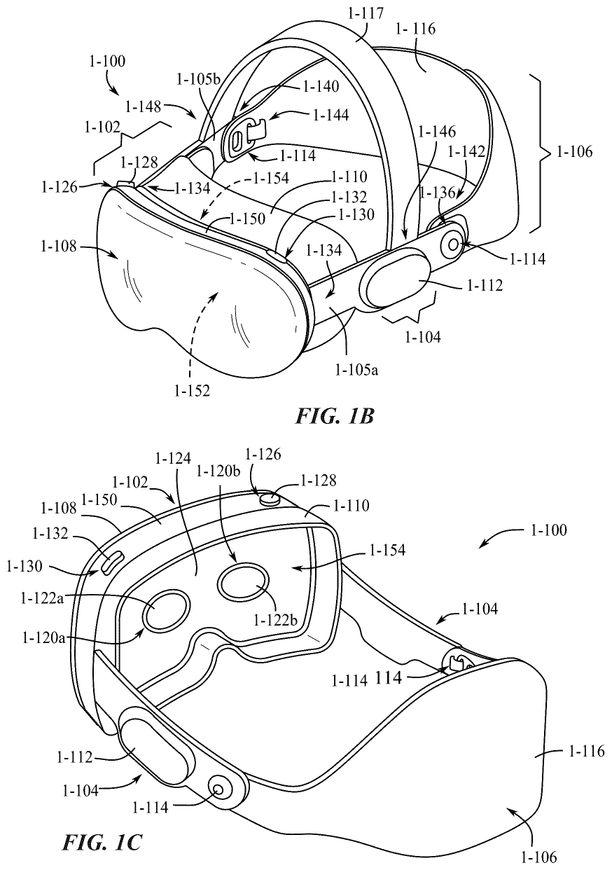

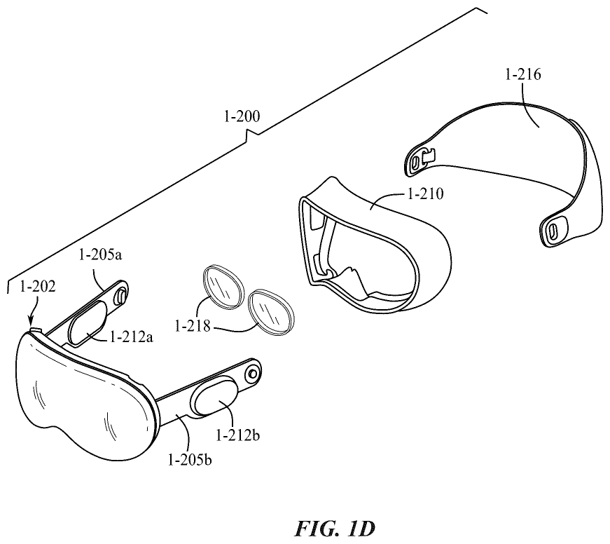

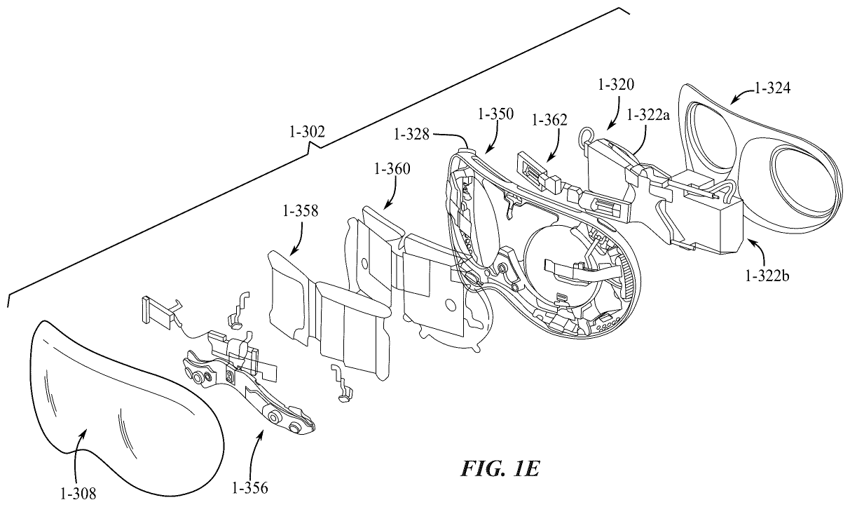

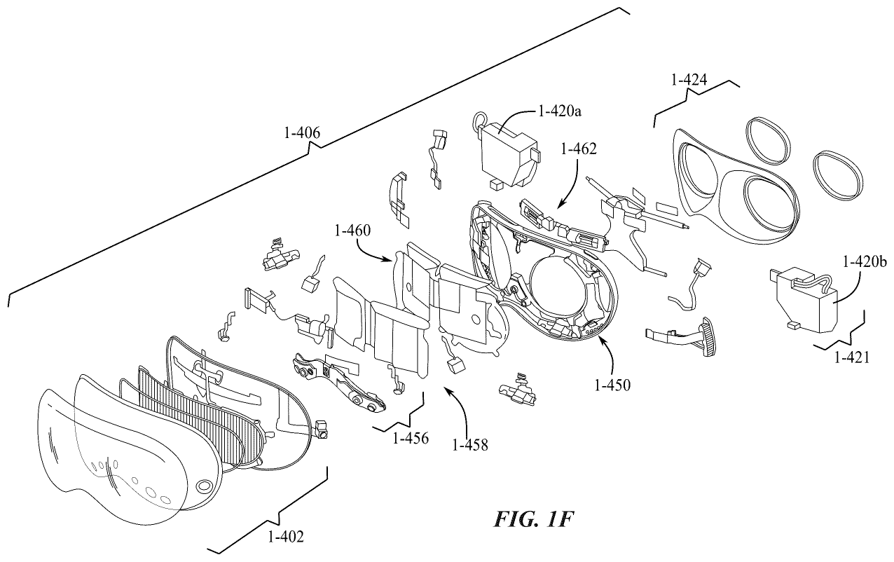

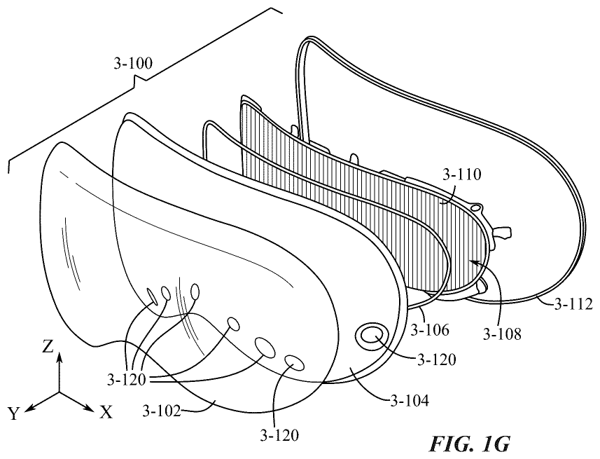

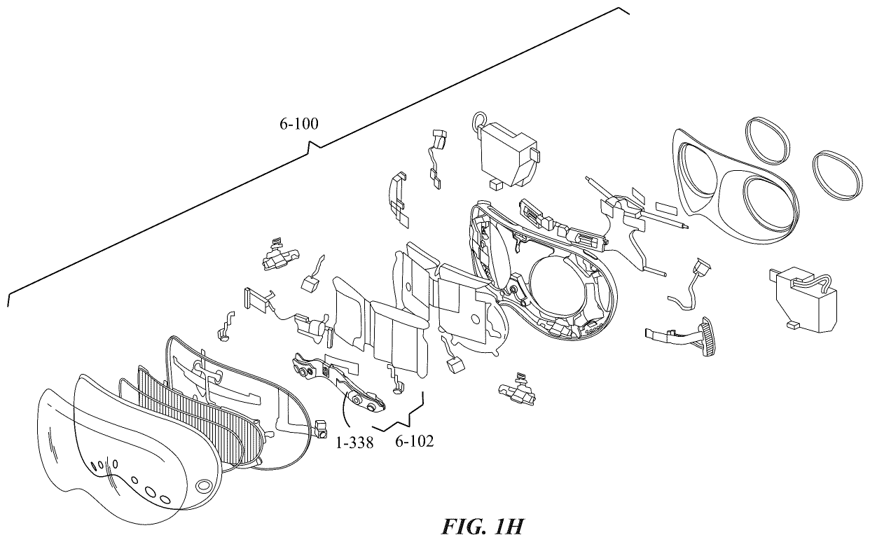

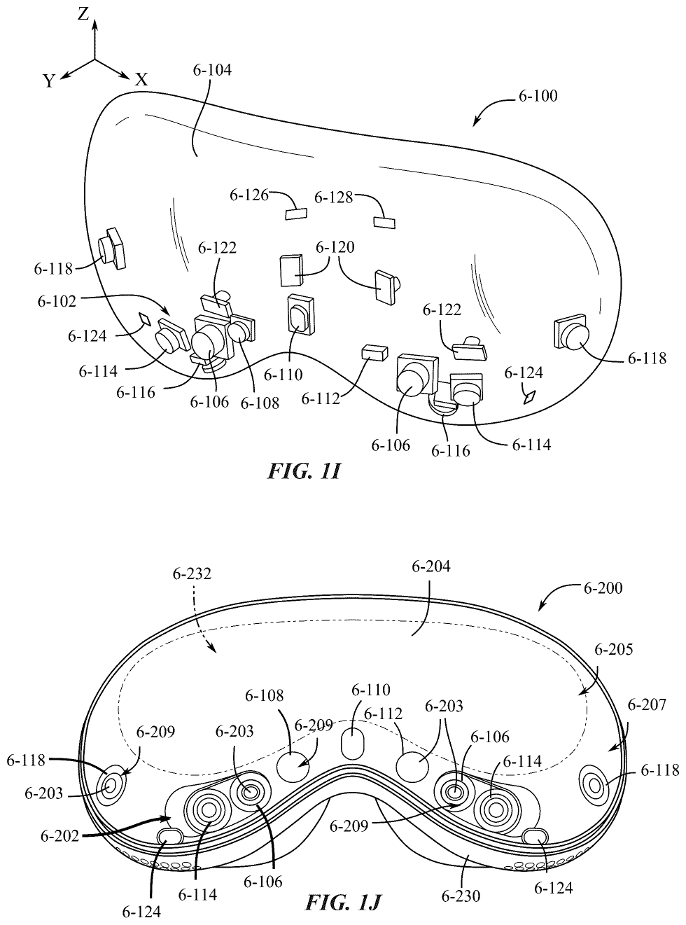

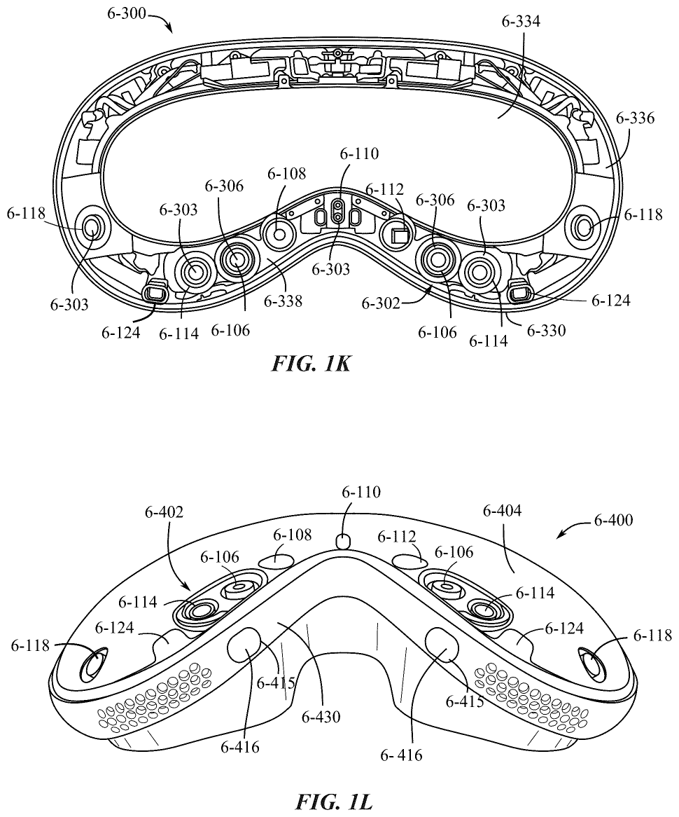

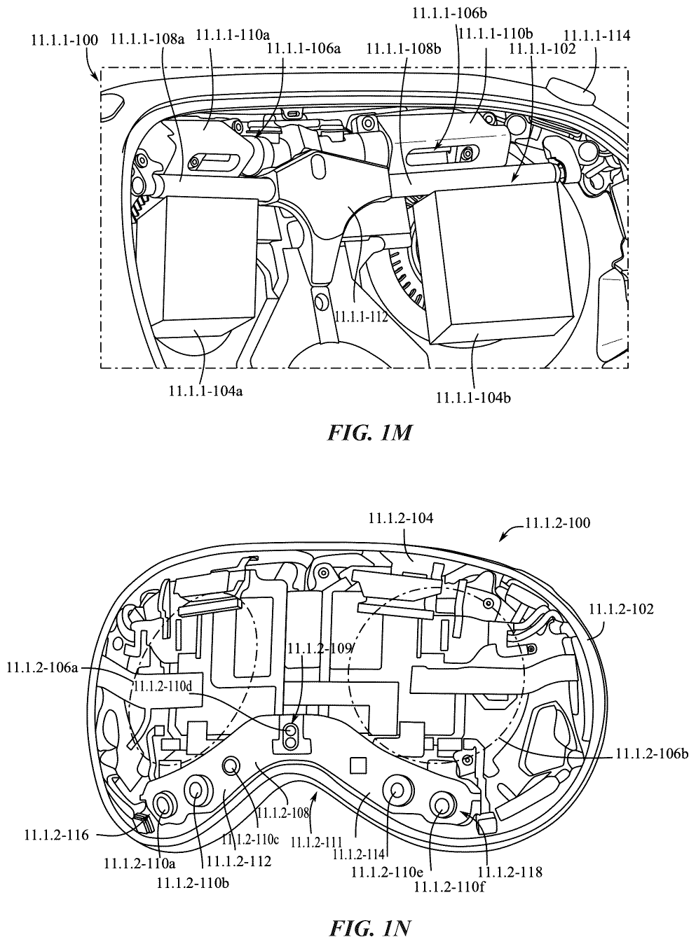

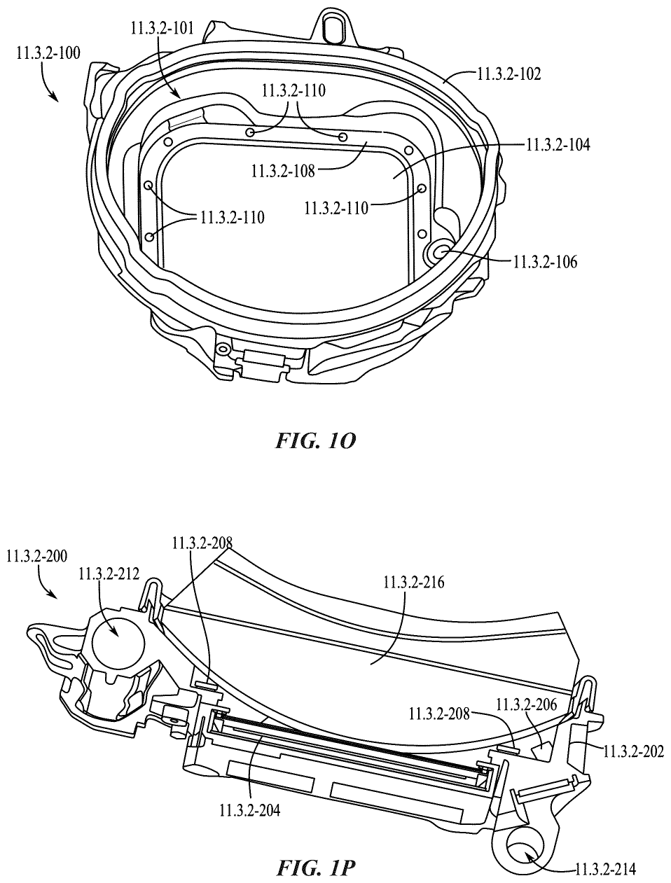

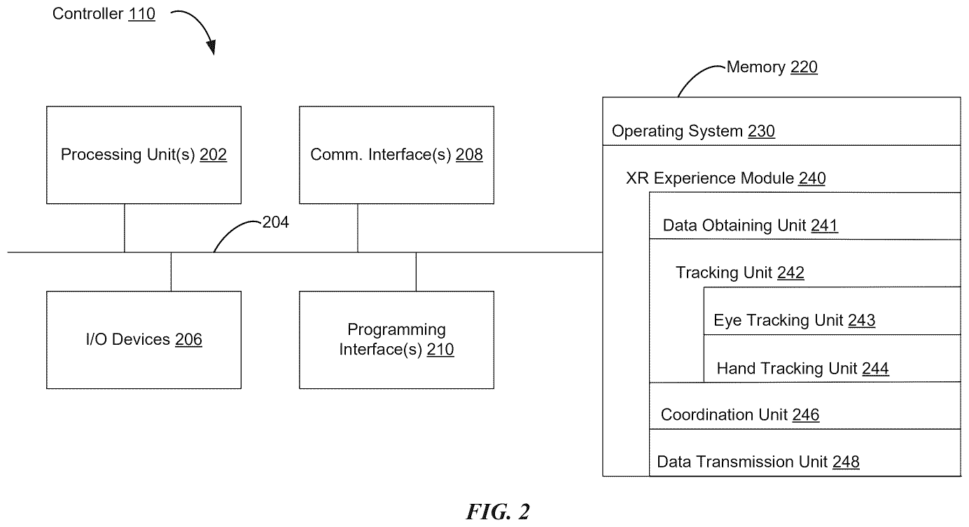

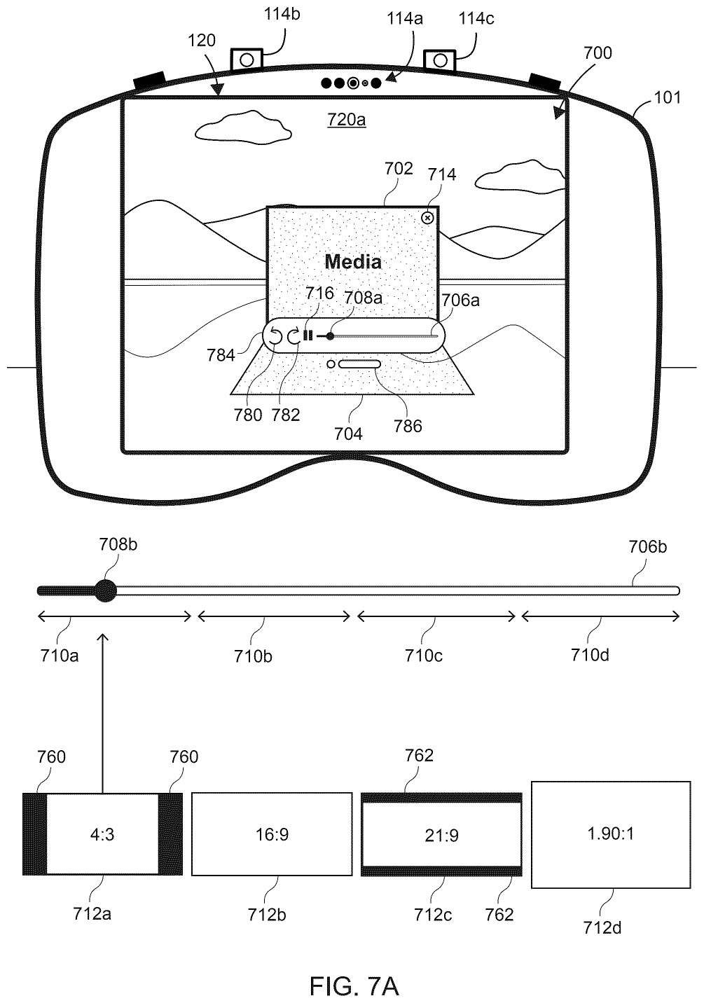

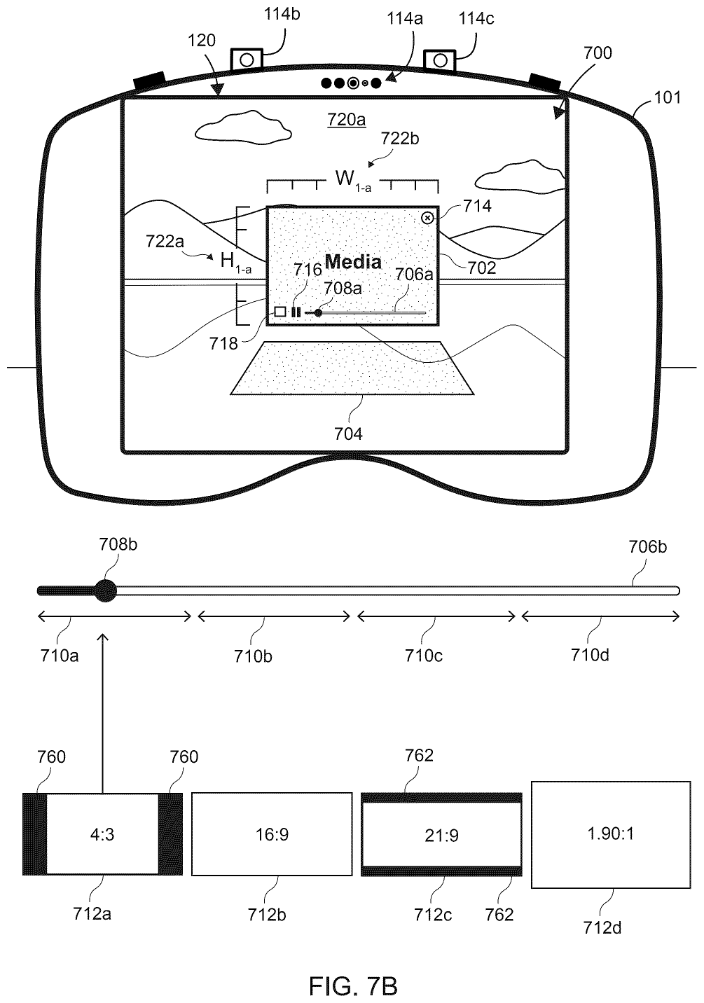

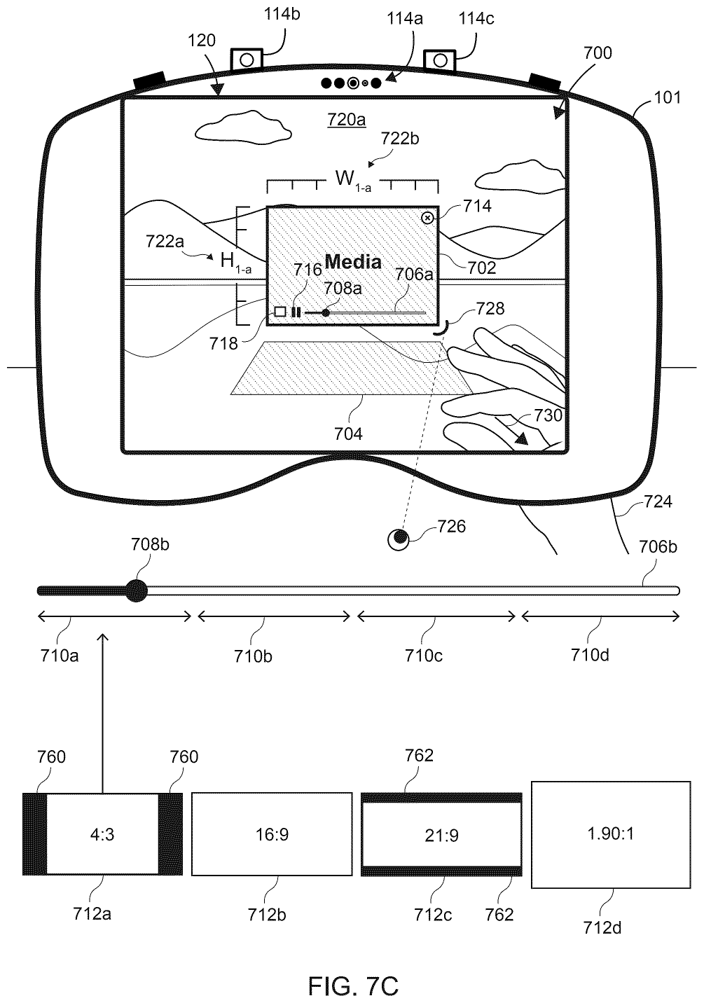

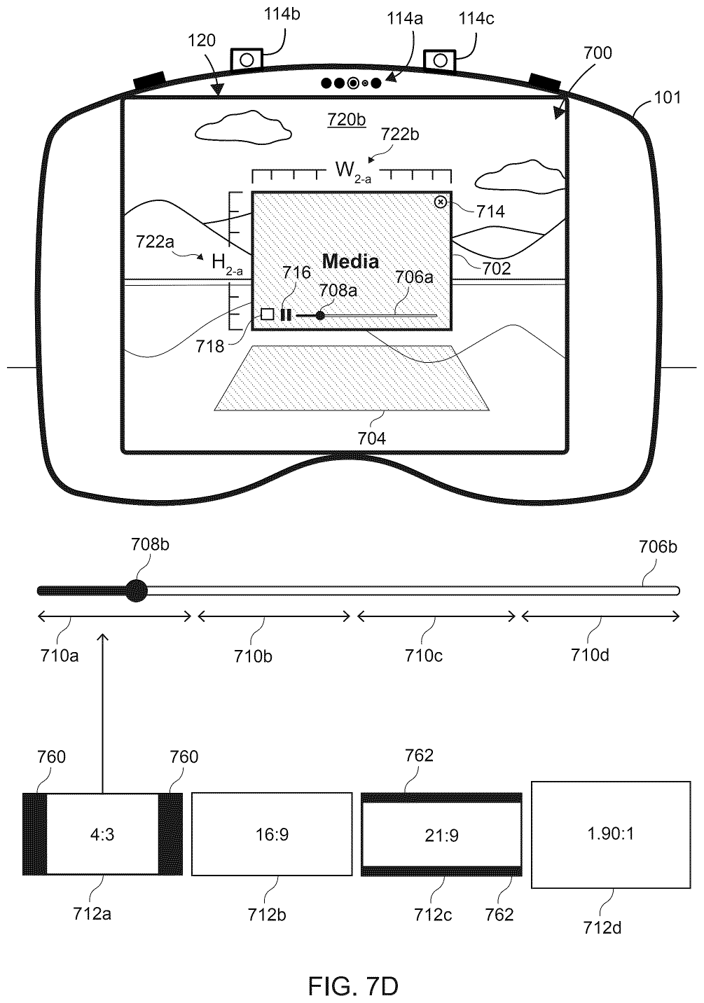

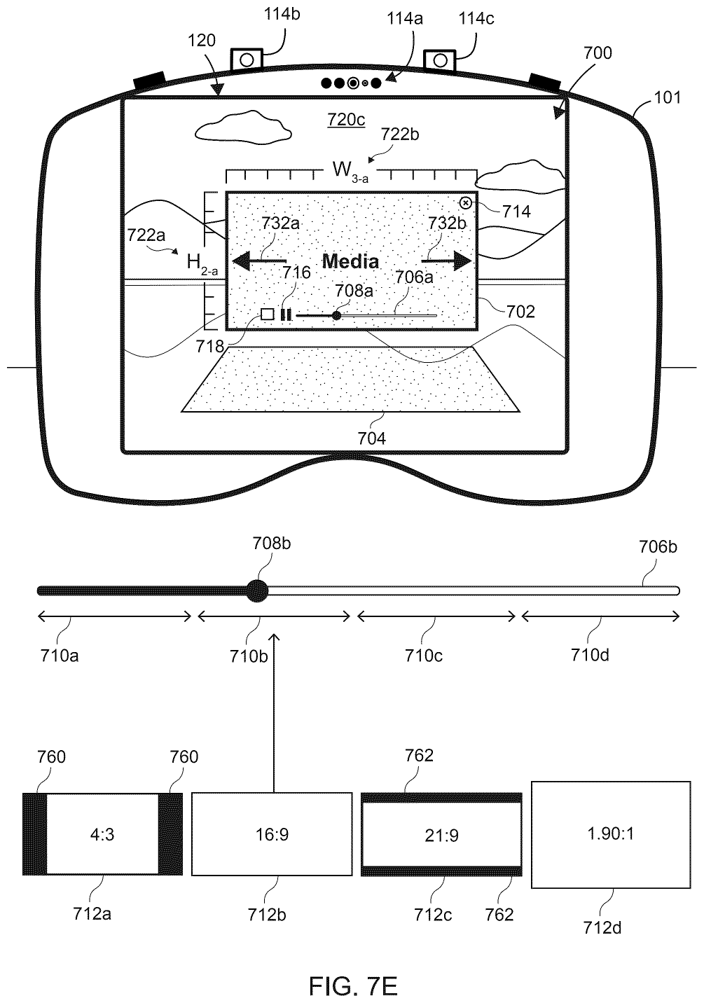

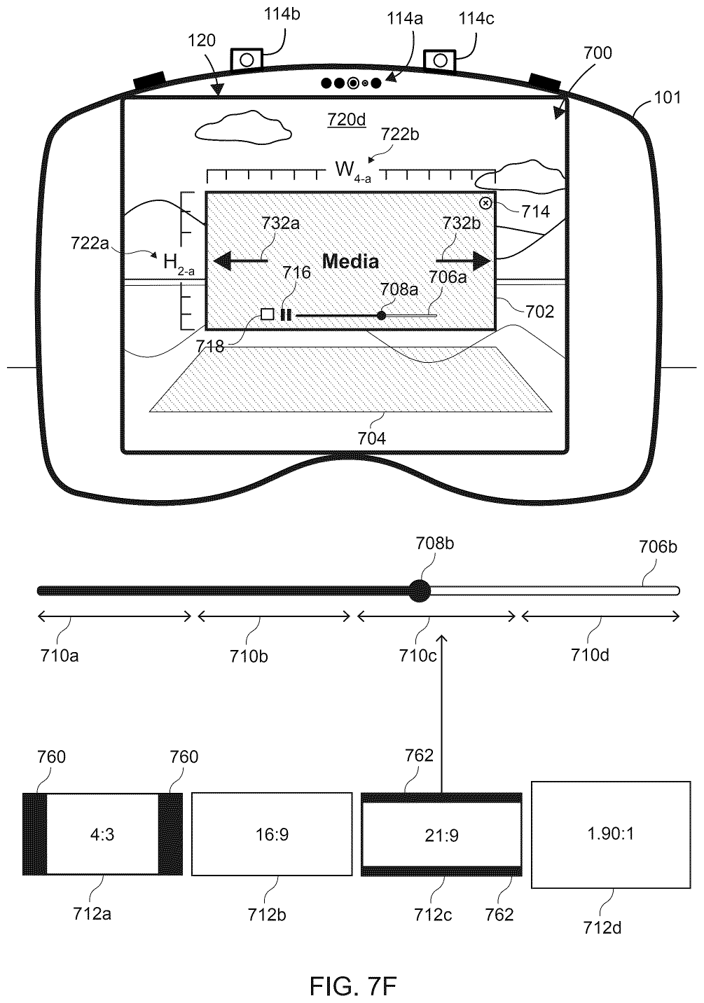

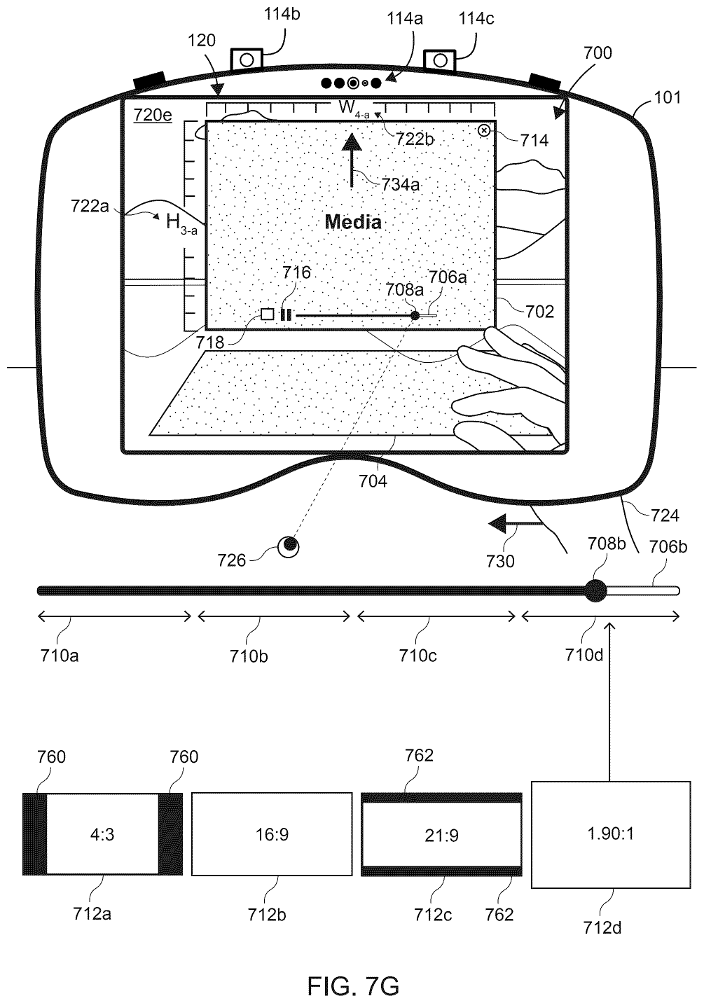

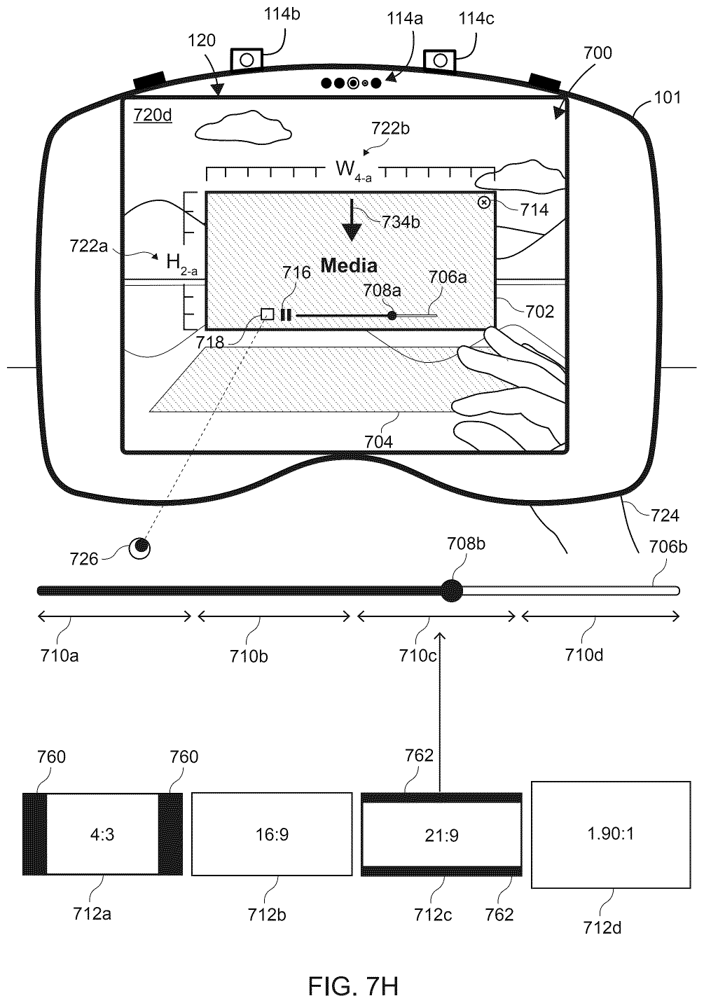

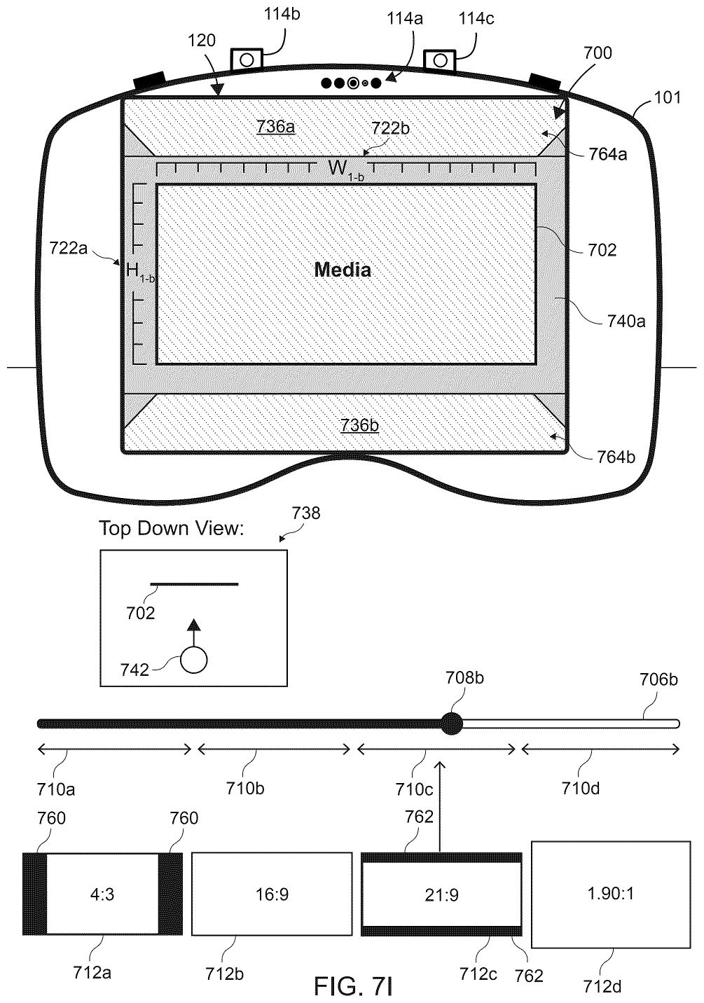

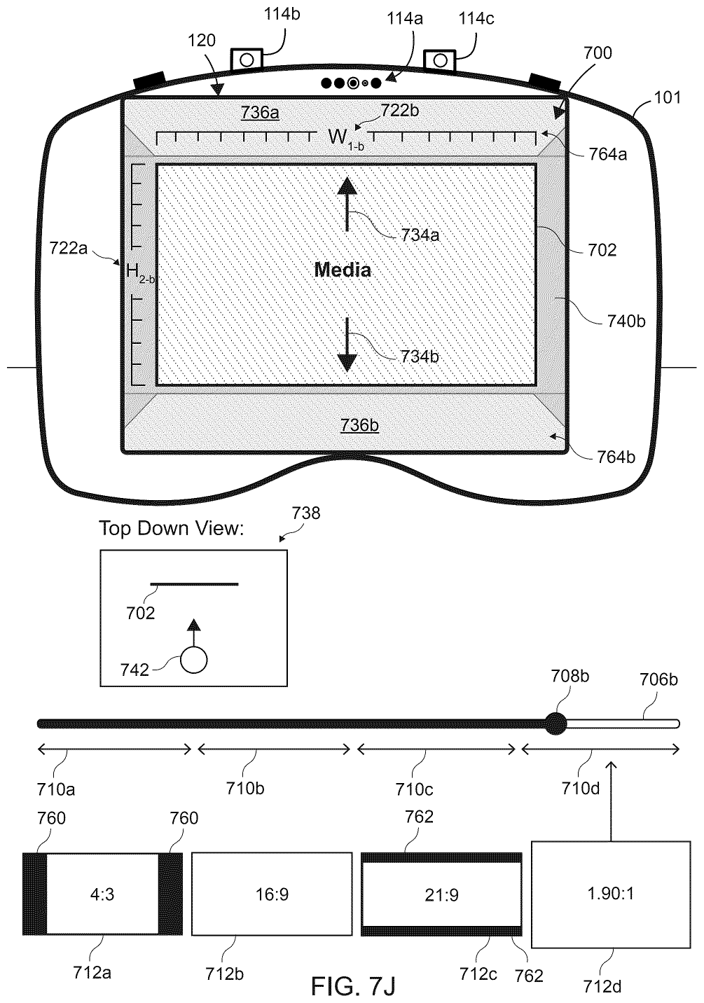

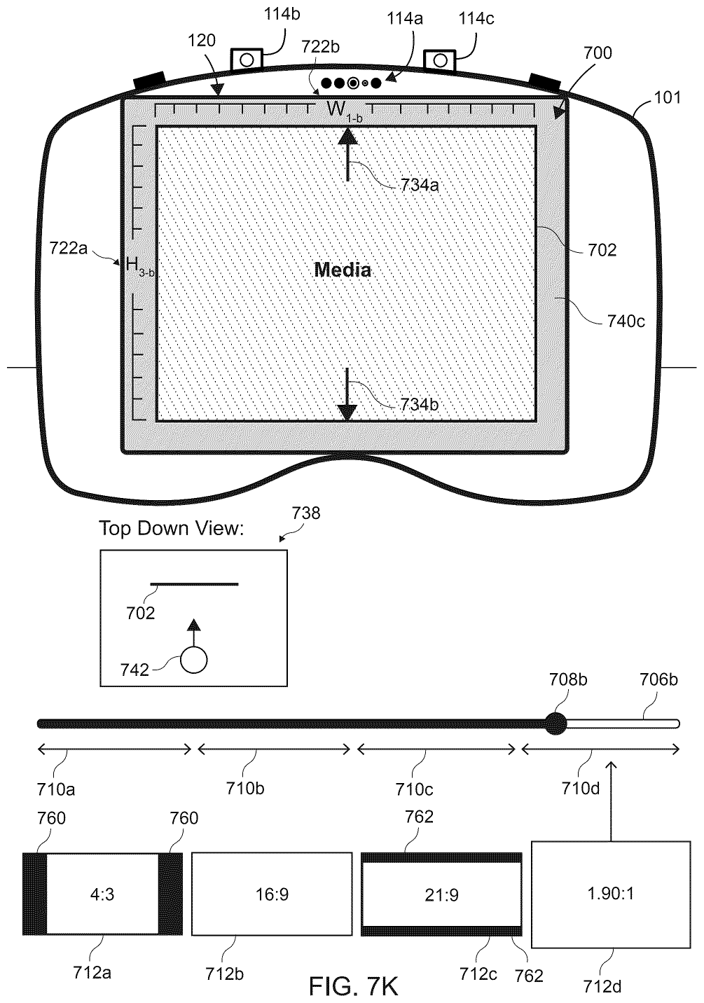

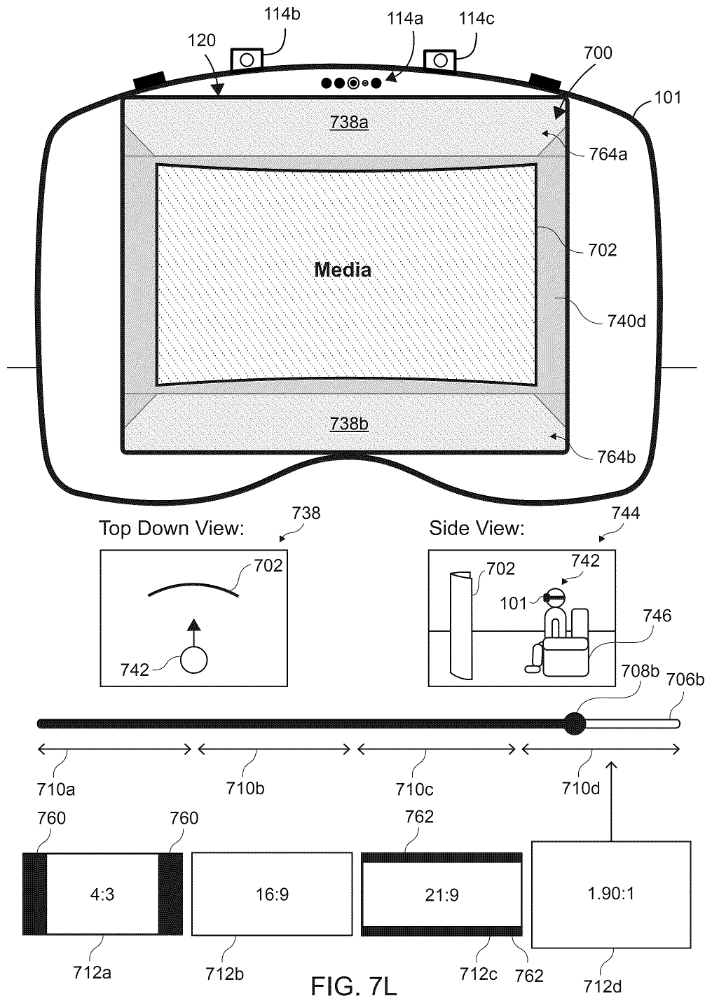

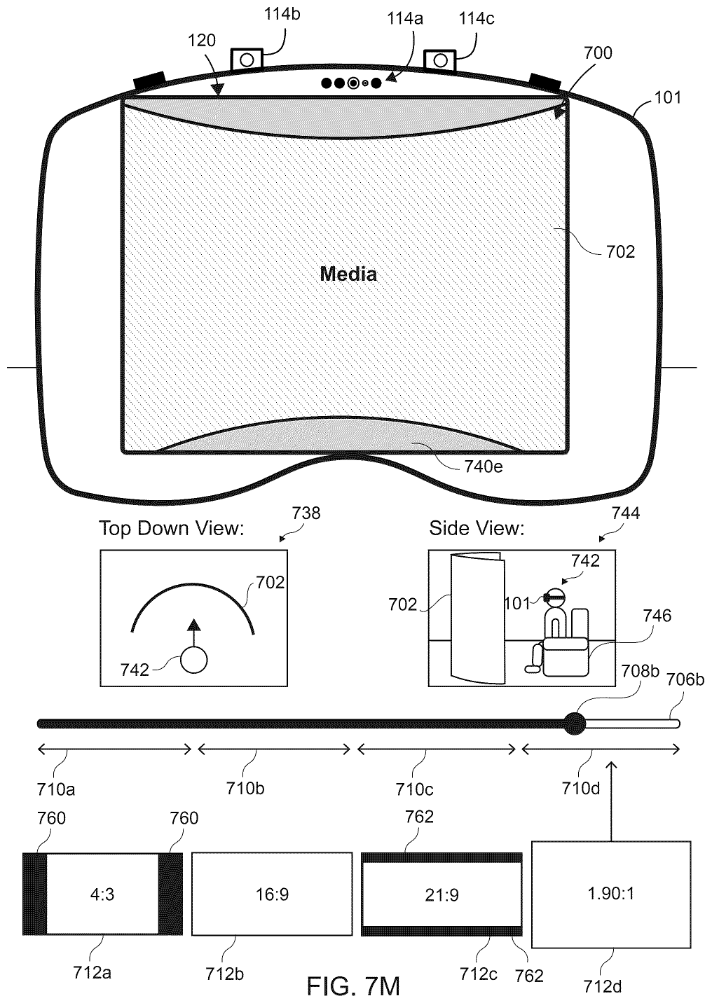

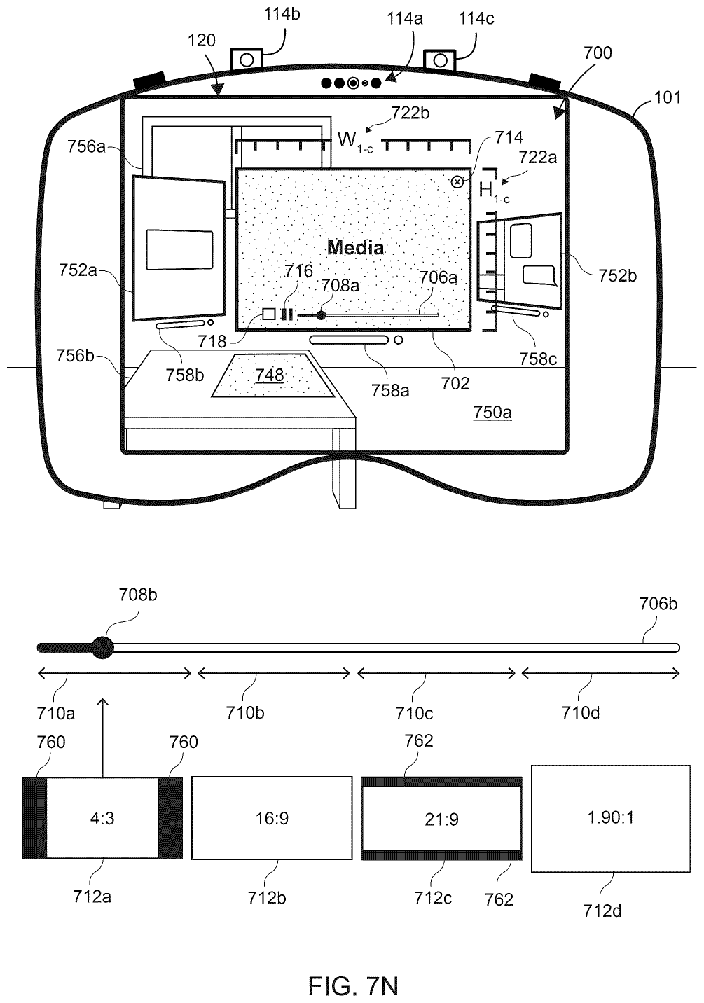

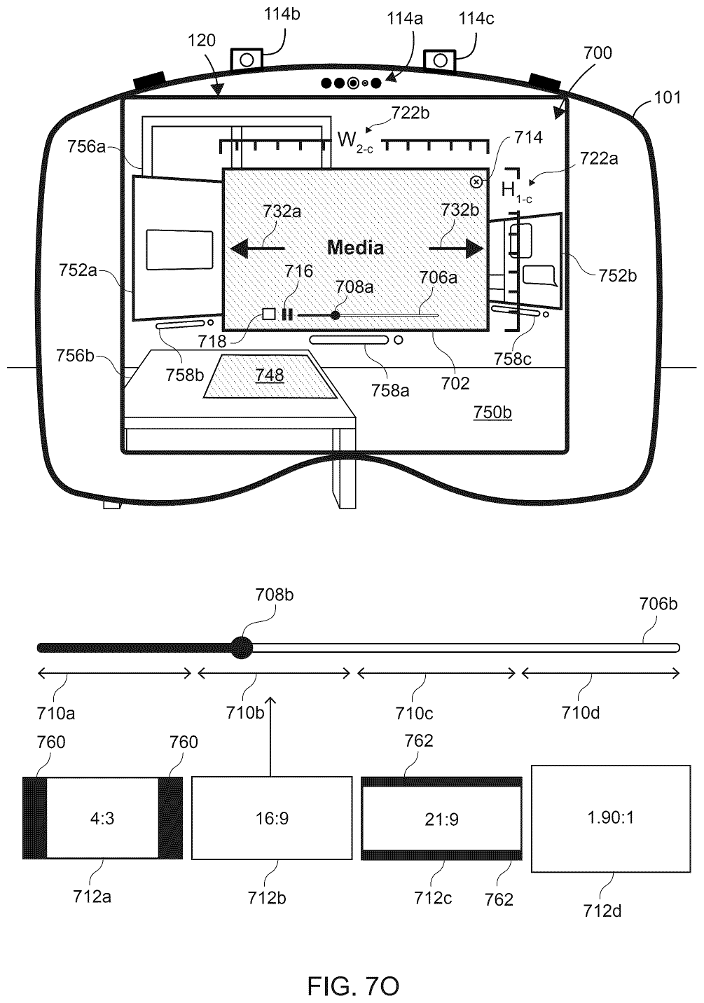

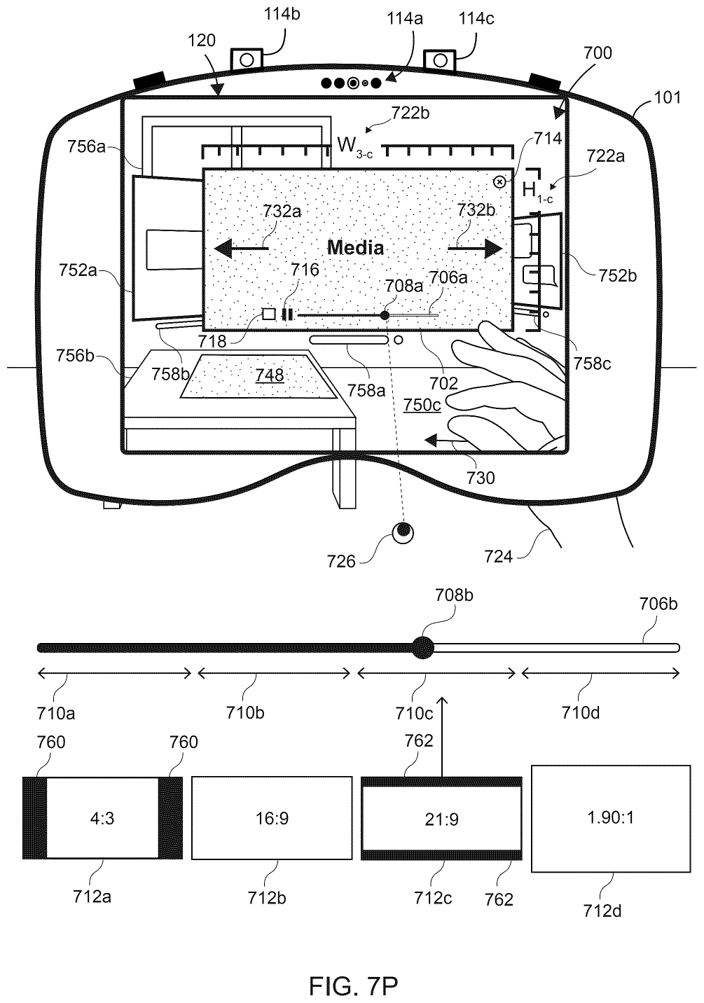

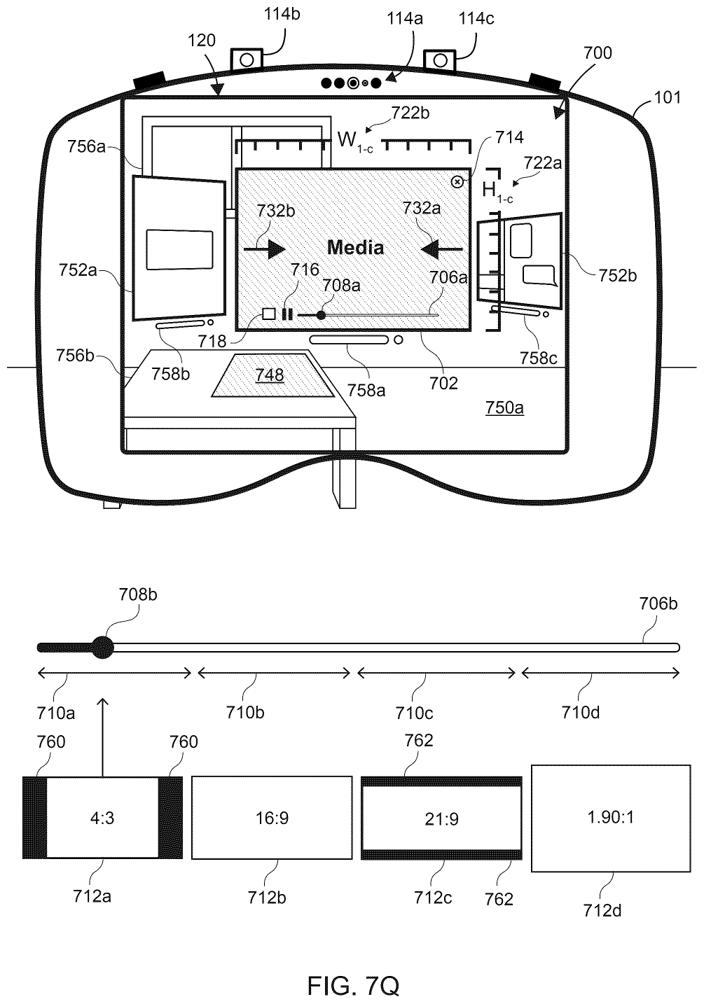

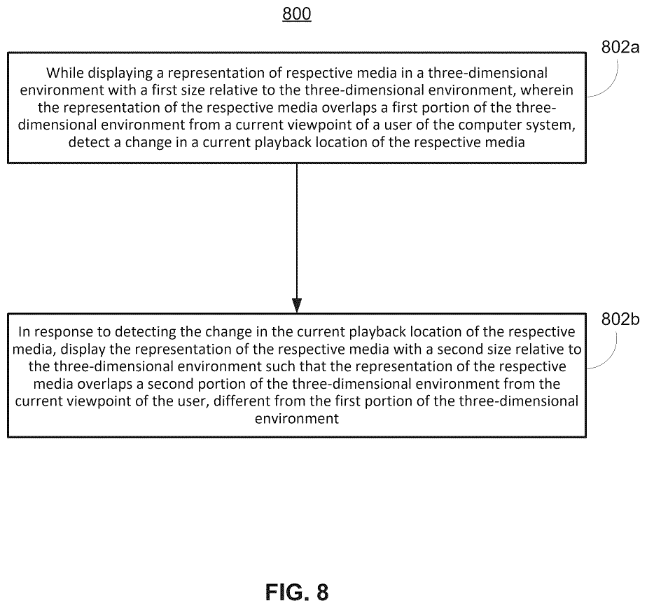

FIGS. 1A-6 provide a description of example computer systems for providing XR experiences to users (such as described below with respect to method 800). FIGS. 7A-7Q illustrate example techniques for changing a size of a representation of respective media in a three-dimensional environment in response to detecting a change in playback location of the respective media. FIG. 8 is a flowchart of methods of changing a size of a representation of respective media in a three-dimensional environment in response to detecting a change in playback location of the respective media. The user interfaces in FIGS. 7A-7Q are used to illustrate the processes in FIG. 8.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, improving privacy and/or security, providing a more varied, detailed, and/or realistic user experience while saving storage space, and/or additional techniques. These techniques also reduce power usage and improve battery life of the device by enabling the user to use the device more quickly and efficiently. Saving on battery power, and thus weight, improves the ergonomics of the device. These techniques also enable real-time communication, allow for the use of fewer and/or less-precise sensors resulting in a more compact, lighter, and cheaper device, and enable the device to be used in a variety of lighting conditions. These techniques reduce energy usage, thereby reducing heat emitted by the device, which is particularly important for a wearable device where a device well within operational parameters for device components can become uncomfortable for a user to wear if it is producing too much heat.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

In some embodiments, as shown in FIG. 1A, the XR experience is provided to the user via an operating environment 100 that includes a computer system 101. The computer system 101 includes a controller 110 (e.g., processors of a portable electronic device or a remote server), a display generation component 120 (e.g., a head-mounted device (HMD), a display, a projector, a touch-screen, etc.), one or more input devices 125 (e.g., an eye tracking device 130, a hand tracking device 140, other input devices 150), one or more output devices 155 (e.g., speakers 160, tactile output generators 170, and other output devices 180), one or more sensors 190 (e.g., image sensors, light sensors, depth sensors, tactile sensors, orientation sensors, proximity sensors, temperature sensors, location sensors, motion sensors, velocity sensors, etc.), and optionally one or more peripheral devices 195 (e.g., home appliances, wearable devices, etc.). In some embodiments, one or more of the input devices 125, output devices 155, sensors 190, and peripheral devices 195 are integrated with the display generation component 120 (e.g., in a head-mounted device or a handheld device).

When describing an XR experience, various terms are used to differentially refer to several related but distinct environments that the user may sense and/or with which a user may interact (e.g., with inputs detected by a computer system 101 generating the XR experience that cause the computer system generating the XR experience to generate audio, visual, and/or tactile feedback corresponding to various inputs provided to the computer system 101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specfies a location and a direction relative to the three-dimensional environment, and as the viewpoint shifts, the view of the three-dimensional environment will also shift in the viewport. For a head mounted device, a viewpoint is typically based on a location an direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typcially move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, 50 cm) of the point of reference in one or more dimensions (e.g., up/down, left/right, and/or forward/backward relative to the position of the point of reference).

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 110 is configured to manage and coordinate a XR experience for the user. In some embodiments, the controller 110 includes a suitable combination of software, firmware, and/or hardware. The controller 110 is described in greater detail below with respect to FIG. 2. In some embodiments, the controller 110 is a computing device that is local or remote relative to the scene 105 (e.g., a physical environment). For example, the controller 110 is a local server located within the scene 105. In another example, the controller 110 is a remote server located outside of the scene 105 (e.g., a cloud server, central server, etc.). In some embodiments, the controller 110 is communicatively coupled with the display generation component 120 (e.g., an HMD, a display, a projector, a touch-screen, etc.) via one or more wired or wireless communication channels 144 (e.g., BLUETOOTH, IEEE 802.11x, IEEE 802.16x, IEEE 802.3x, etc.). In another example, the controller 110 is included within the enclosure (e.g., a physical housing) of the display generation component 120 (e.g., an HMD, or a portable electronic device that includes a display and one or more processors, etc.), one or more of the input devices 125, one or more of the output devices 155, one or more of the sensors 190, and/or one or more of the peripheral devices 195, or share the same physical enclosure or support structure with one or more of the above.

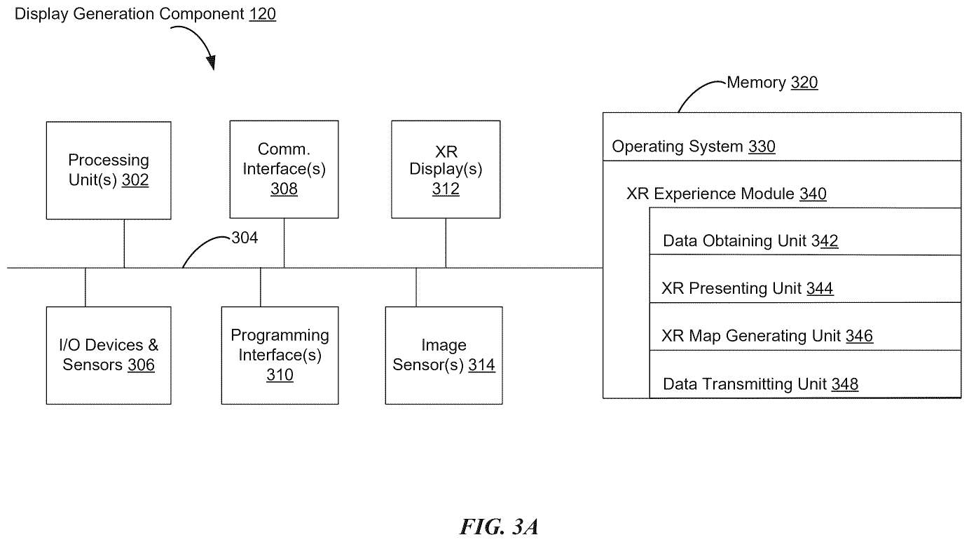

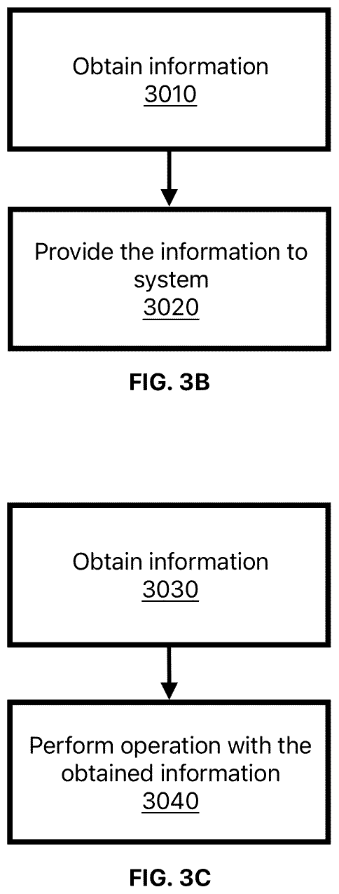

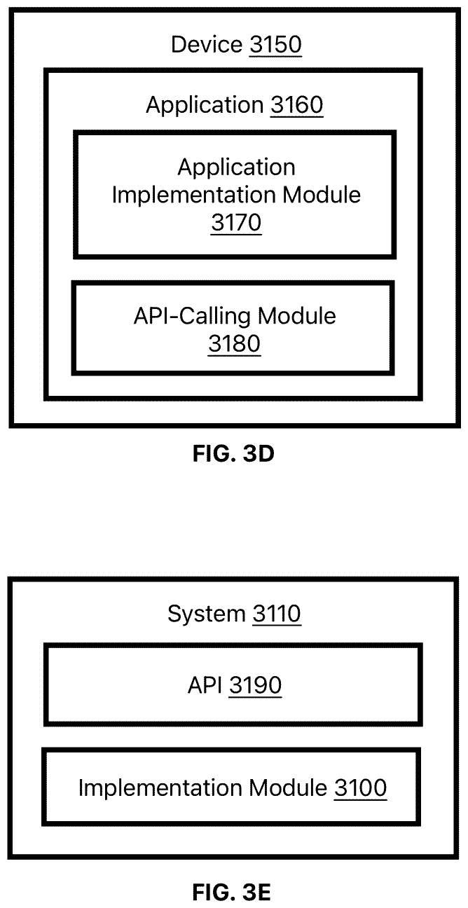

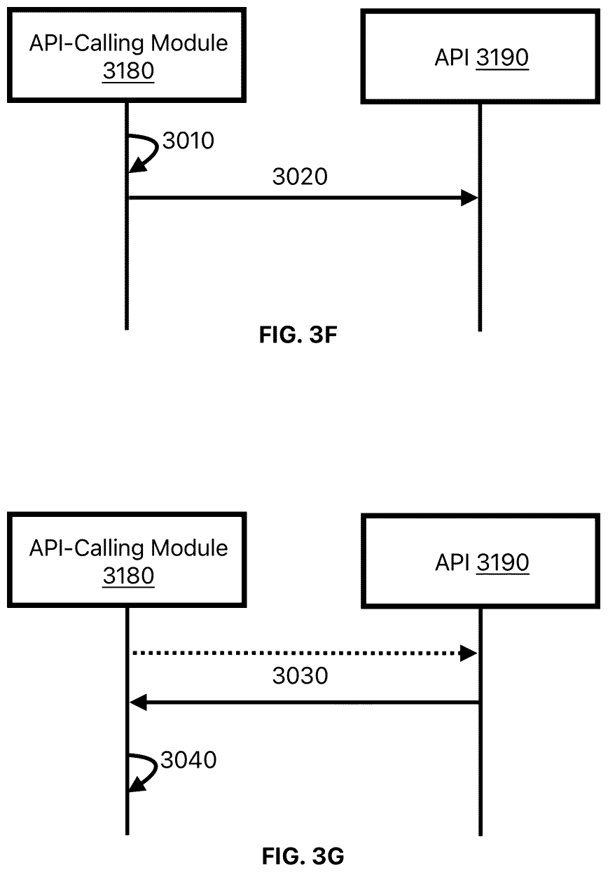

In some embodiments, the display generation component 120 is configured to provide the XR experience (e.g., at least a visual component of the XR experience) to the user. In some embodiments, the display generation component 120 includes a suitable combination of software, firmware, and/or hardware. The display generation component 120 is described in greater detail below with respect to FIG. 3A. In some embodiments, the functionalities of the controller 110 are provided by and/or combined with the display generation component 120.

According to some embodiments, the display generation component 120 provides an XR experience to the user while the user is virtually and/or physically present within the scene 105.

In some embodiments, the display generation component is worn on a part of the user's body (e.g., on his/her head, on his/her hand, etc.). As such, the display generation component 120 includes one or more XR displays provided to display the XR content. For example, in various embodiments, the display generation component 120 encloses the field-of-view of the user. In some embodiments, the display generation component 120 is a handheld device (such as a smartphone or tablet) configured to present XR content, and the user holds the device with a display directed towards the field-of-view of the user and a camera directed towards the scene 105. In some embodiments, the handheld device is optionally placed within an enclosure that is worn on the head of the user. In some embodiments, the handheld device is optionally placed on a support (e.g., a tripod) in front of the user. In some embodiments, the display generation component 120 is a XR chamber, enclosure, or room configured to present XR content in which the user does not wear or hold the display generation component 120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 105 or a part of the user's body (e.g., the user's eye(s), head, or hand)) could similarly be implemented with an HMD where the movement is caused by movement of the HMD relative to the physical environment (e.g., the scene 105 or a part of the user's body (e.g., the user's eye(s), head, or hand)).

While pertinent features of the operating environment 100 are shown in FIG. 1A, those of ordinary skill in the art will appreciate from the present disclosure that various other features have not been illustrated for the sake of brevity and so as not to obscure more pertinent aspects of the example embodiments disclosed herein.

FIGS. 1A-1P illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 1I) for detecting information about a physical environment of the device which can be used (optionally in conjunction with one or more illuminators such as the illuminators described in FIG. 1I) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 1I) that can be used (optionally in conjunction with one or more illuminators such as the illuminators 6-124 described in FIG. 1I) to determine when one or more air gestures have been performed. In some embodiments, the computer system includes one or more input devices for detecting input such as one or more sensors for detecting eye movement (e.g., eye tracking and gaze tracking sensors in FIG. 1I) which can be used (optionally in conjunction with one or more lights such as lights 11.3.2-110 in FIG. 1O) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 1B illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user' head when donning the HMD 1-100.

In at least one example, one or more of the first and second electronic straps 1-105a-b can define internal strap volumes and include one or more electronic components disposed in the internal strap volumes. In one example, as shown in FIG. 1B, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 1B because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 1C illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 1B and 1C, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward facing display screen of the display assembly 1-108 shown in the front perspective view of FIG. 1B. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 1B and 1C can be included, either alone or in any combination, in any of the other examples of devices, features, components, and parts shown in FIGS. 1D-1F and described herein. Likewise, any of the features, components, and/or parts, including the arrangements and configurations thereof shown and described with reference to FIGS. 1D-1F can be included, either alone or in any combination, in the example of the devices, features, components, and parts shown in FIGS. 1B and 1C.

FIG. 1D illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 1D and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 1D can be included, either alone or in any combination, in any of the other examples of devices, features, components, and parts shown in FIGS. 1B, 1C, and 1E-1F and described herein. Likewise, any of the features, components, and/or parts, including the arrangements and configurations thereof shown and described with reference to FIGS. 1B, 1C, and 1E-1F can be included, either alone or in any combination, in the example of the devices, features, components, and parts shown in FIG. 1D.

FIG. 1E illustrates an exploded view of an example of a display unit 1-306 of a HMD. The display unit 1-306 can include a front display assembly 1-308, a frame/housing assembly 1-350, and a curtain assembly 1-324. The display unit 1-306 can also include a sensor assembly 1-356, logic board assembly 1-358, and cooling assembly 1-360 disposed between the frame assembly 1-350 and the front display assembly 1-308. In at least one example, the display unit 1-306 can also include a rear-facing display assembly 1-320 including first and second rear-facing display screens 1-322a, 1-322b disposed between the frame 1-350 and the curtain assembly 1-324.

In at least one example, the display unit 1-306 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-306 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 1E can be included, either alone or in any combination, in any of the other examples of devices, features, components, and parts shown in FIGS. 1B-1D and 1F and described herein. Likewise, any of the features, components, and/or parts, including the arrangements and configurations thereof shown and described with reference to FIGS. 1B-1D and 1F can be included, either alone or in any combination, in the example of the devices, features, components, and parts shown in FIG. 1E.

FIG. 1F illustrates an exploded view of another example of a display unit 1-406 of a HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 1F are described in greater detail herein with reference to FIGS. 1B-1E as well as subsequent figures referenced in the present disclosure. The display unit 1-406 shown in FIG. 1F can be assembled and integrated with the securement mechanisms shown in FIGS. 1B-1E, including the electronic straps, bands, and other components including light seals, connection assemblies, and so forth.

Any of the features, components, and/or parts, including the arrangements and configurations thereof shown in FIG. 1F can be included, either alone or in any combination, in any of the other examples of devices, features, components, and parts shown in FIGS. 1B-1E and described herein. Likewise, any of the features, components, and/or parts, including the arrangements and configurations thereof shown and described with reference to FIGS. 1B-1E can be included, either alone or in any combination, in the example of the devices, features, components, and parts shown in FIG. 1F.

FIG. 1G illustrates a perspective, exploded view of a front cover assembly 3-100 of an HMD device described herein, for example the front cover assembly 3-1 of the HMD 3-100 shown in FIG. 1G or any other HMD device shown and described herein. The front cover assembly 3-100 shown in FIG. 1G can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 1G, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 1G can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 1G.

FIG. 1H illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 1I illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 1J. Terms such as “vertical,” “up,” “down,” and similar terms refer to orientations or directions as indicated by the Z-axis shown in FIG. 1J. Terms such as “frontward,” “rearward,” “forward,” backward,” and similar terms refer to orientations or directions as indicated by the Y-axis shown in FIG. 1J.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 1I. FIG. 1I shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin. for hand and body tracking, headset tracking, and facial avatar

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 1I can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 1I can be included, either alone or in any combination, in any of the other examples of devices, features, components, and parts shown in FIGS. 1J-1L and described herein. Likewise, any of the features, components, and/or parts, including the arrangements and configurations thereof shown and described with reference to FIGS. 1J-1L can be included, either alone or in any combination, in the example of the devices, features, components, and parts shown in FIG. 1I.

FIG. 1J illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 1I, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 1K and 1L. Other sensors, sensor types, number of sensors, and relative positions thereof can be included in one or more other examples of HMDs.

Any of the features, components, and/or parts, including the arrangements and configurations thereof shown in FIG. 1J can be included, either alone or in any combination, in any of the other examples of devices, features, components, and parts shown in FIGS. 1I and 1K-1L and described herein. Likewise, any of the features, components, and/or parts, including the arrangements and configurations thereof shown and described with reference to FIGS. 1I and 1K-1L can be included, either alone or in any combination, in the example of the devices, features, components, and parts shown in FIG. 1J.

FIG. 1K illustrates a front view of a portion of an example of an HMD device 6-300 including a display 6-334, brackets 6-336, 6-338, and frame or housing 6-330. The example shown in FIG. 1K does not include a front cover or shroud in order to illustrate the brackets 6-336, 6-338. For example, the shroud 6-204 shown in FIG. 1J includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 1K can be included, either alone or in any combination, in any of the other examples of devices, features, components, and parts shown in FIGS. 1I-1J and 1L and described herein. Likewise, any of the features, components, and/or parts, including the arrangements and configurations thereof shown and described with reference to FIGS. 1I-1J and 1L can be included, either alone or in any combination, in the example of the devices, features, components, and parts shown in FIG. 1K.

FIG. 1L illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 1I-1K. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 1L can be included, either alone or in any combination, in any of the other examples of devices, features, components, and parts shown in FIGS. 1I-1K and described herein. Likewise, any of the features, components, and/or parts, including the arrangements and configurations thereof shown and described with reference to FIGS. 1I-1K can be included, either alone or in any combination, in the example of the devices, features, components, and parts shown in FIG. 1L.

FIG. 1M illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 1M can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 1M.

FIG. 1N illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 1N because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 1N, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 1N can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 1N.

FIG. 1O illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 1O can be replicated in another (e.g., second) optical module disposed with the HMD to interact (e.g., project light and capture images) of another eye of the user.

Any of the features, components, and/or parts, including the arrangements and configurations thereof shown in FIG. 1O can be included, either alone or in any combination, in any of the other examples of devices, features, components, and parts shown in FIG. 1P or otherwise described herein. Likewise, any of the features, components, and/or parts, including the arrangements and configurations thereof shown and described with reference to FIG. 1P or otherwise described herein can be included, either alone or in any combination, in the example of the devices, features, components, and parts shown in FIG. 1O.

FIG. 1P illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 1P can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 1P.

FIG. 2 is a block diagram of an example of the controller 110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some embodiments, the one or more communication buses 204 include circuitry that interconnects and controls communications between system components. In some embodiments, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some embodiments, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some embodiments, the memory 220 or the non-transitory computer readable storage medium of the memory 220 stores the following programs, modules and data structures, or a subset thereof including an optional operating system 230 and a XR experience module 240.

The operating system 230 includes instructions for handling various basic system services and for performing hardware dependent tasks. In some embodiments, the XR experience module 240 is configured to manage and coordinate one or more XR experiences for one or more users (e.g., a single XR experience for one or more users, or multiple XR experiences for respective groups of one or more users). To that end, in various embodiments, the XR experience module 240 includes a data obtaining unit 241, a tracking unit 242, a coordination unit 246, and a data transmitting unit 248.

In some embodiments, the data obtaining unit 241 is configured to obtain data (e.g., presentation data, interaction data, sensor data, location data, etc.) from at least the display generation component 120 of FIG. 1A, and optionally one or more of the input devices 125, output devices 155, sensors 190, and/or peripheral devices 195. To that end, in various embodiments, the data obtaining unit 241 includes instructions and/or logic therefor, and heuristics and metadata therefor.

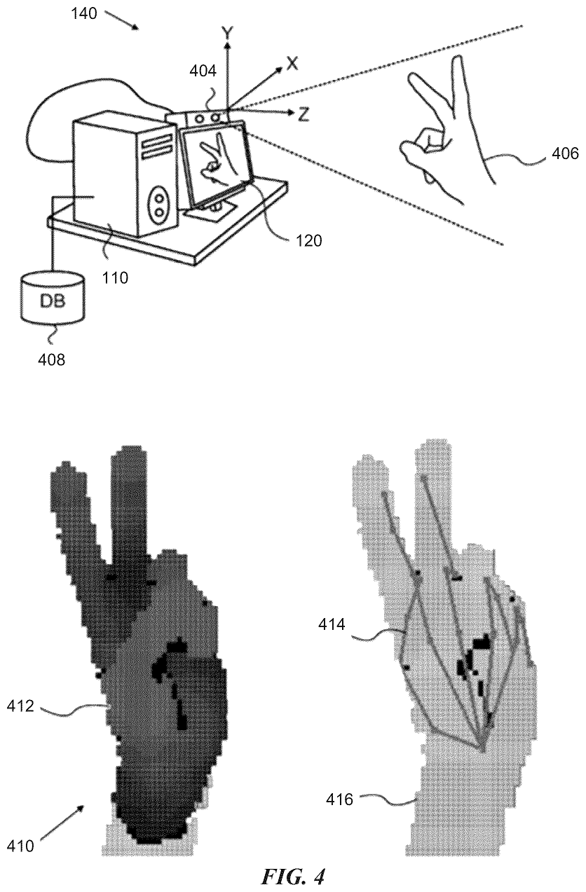

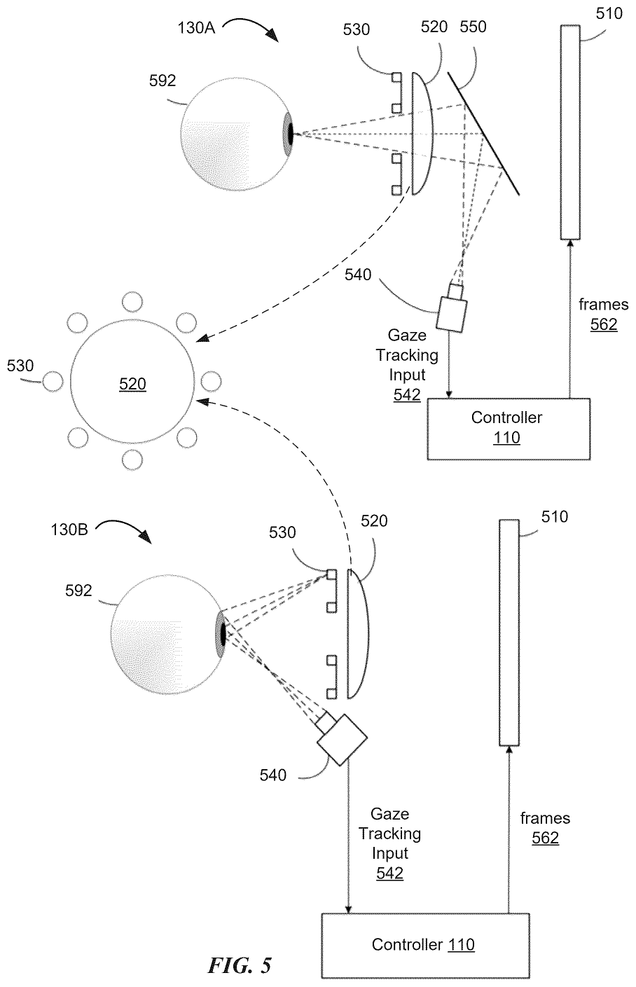

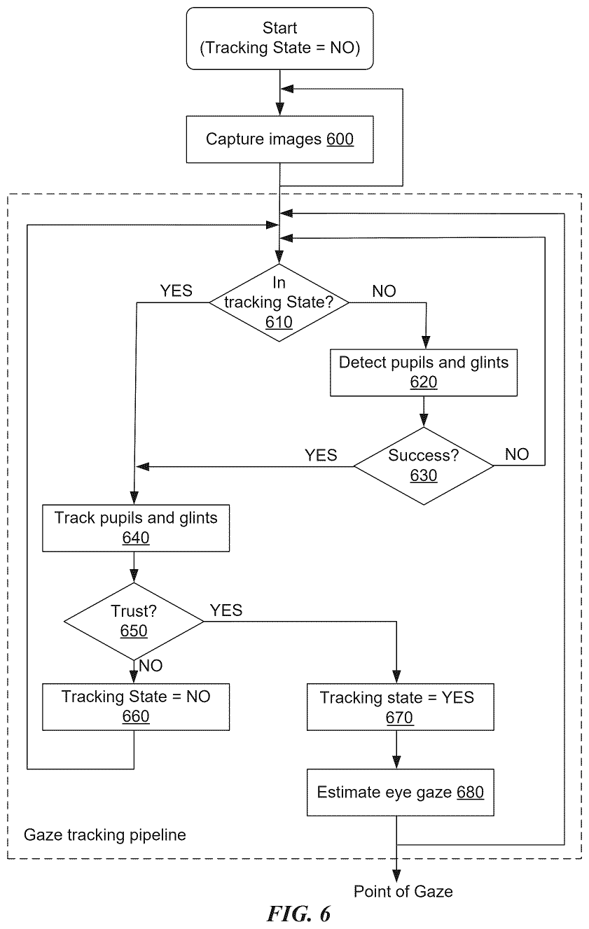

In some embodiments, the tracking unit 242 is configured to map the scene 105 and to track the position/location of at least the display generation component 120 with respect to the scene 105 of FIG. 1A, and optionally, to one or more of the input devices 125, output devices 155, sensors 190, and/or peripheral devices 195. To that end, in various embodiments, the tracking unit 242 includes instructions and/or logic therefor, and heuristics and metadata therefor. In some embodiments, the tracking unit 242 includes hand tracking unit 244 and/or eye tracking unit 243. In some embodiments, the hand tracking unit 244 is configured to track the position/location of one or more portions of the user's hands, and/or motions of one or more portions of the user's hands with respect to the scene 105 of FIG. 1A, relative to the display generation component 120, and/or relative to a coordinate system defined relative to the user's hand. The hand tracking unit 244 is described in greater detail below with respect to FIG. 4. In some embodiments, the eye tracking unit 243 is configured to track the position and movement of the user's gaze (or more broadly, the user's eyes, face, or head) with respect to the scene 105 (e.g., with respect to the physical environment and/or to the user (e.g., the user's hand)) or with respect to the XR content displayed via the display generation component 120. The eye tracking unit 243 is described in greater detail below with respect to FIG. 5.

In some embodiments, the coordination unit 246 is configured to manage and coordinate the XR experience presented to the user by the display generation component 120, and optionally, by one or more of the output devices 155 and/or peripheral devices 195. To that end, in various embodiments, the coordination unit 246 includes instructions and/or logic therefor, and heuristics and metadata therefor.

In some embodiments, the data transmitting unit 248 is configured to transmit data (e.g., presentation data, location data, etc.) to at least the display generation component 120, and optionally, to one or more of the input devices 125, output devices 155, sensors 190, and/or peripheral devices 195. To that end, in various embodiments, the data transmitting unit 248 includes instructions and/or logic therefor, and heuristics and metadata therefor.

Although the data obtaining unit 241, the tracking unit 242 (e.g., including the eye tracking unit 243 and the hand tracking unit 244), the coordination unit 246, and the data transmitting unit 248 are shown as residing on a single device (e.g., the controller 110), it should be understood that in other embodiments, any combination of the data obtaining unit 241, the tracking unit 242 (e.g., including the eye tracking unit 243 and the hand tracking unit 244), the coordination unit 246, and the data transmitting unit 248 may be located in separate computing devices.

Moreover, FIG. 2 is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 3A is a block diagram of an example of the display generation component 120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 120 (e.g., HMD) includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some embodiments, the one or more communication buses 304 include circuitry that interconnects and controls communications between system components. In some embodiments, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 312 are configured to provide the XR experience to the user. In some embodiments, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 312 correspond to diffractive, reflective, polarized, holographic, etc. waveguide displays. For example, the display generation component 120 (e.g., HMD) includes a single XR display. In another example, the display generation component 120 includes a XR display for each eye of the user. In some embodiments, the one or more XR displays 312 are capable of presenting MR and VR content. In some embodiments, the one or more XR displays 312 are capable of presenting MR or VR content.

In some embodiments, the one or more image sensors 314 are configured to obtain image data that corresponds to at least a portion of the face of the user that includes the eyes of the user (and may be referred to as an eye-tracking camera). In some embodiments, the one or more image sensors 314 are configured to obtain image data that corresponds to at least a portion of the user's hand(s) and optionally arm(s) of the user (and may be referred to as a hand-tracking camera). In some embodiments, the one or more image sensors 314 are configured to be forward-facing so as to obtain image data that corresponds to the scene as would be viewed by the user if the display generation component 120 (e.g., HMD) was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some embodiments, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some embodiments, the memory 320 or the non-transitory computer readable storage medium of the memory 320 stores the following programs, modules and data structures, or a subset thereof including an optional operating system 330 and a XR presentation module 340.

The operating system 330 includes instructions for handling various basic system services and for performing hardware dependent tasks. In some embodiments, the XR presentation module 340 is configured to present XR content to the user via the one or more XR displays 312. To that end, in various embodiments, the XR presentation module 340 includes a data obtaining unit 342, a XR presenting unit 344, a XR map generating unit 346, and a data transmitting unit 348.

In some embodiments, the data obtaining unit 342 is configured to obtain data (e.g., presentation data, interaction data, sensor data, location data, etc.) from at least the controller 110 of FIG. 1A. To that end, in various embodiments, the data obtaining unit 342 includes instructions and/or logic therefor, and heuristics and metadata therefor.

In some embodiments, the XR presenting unit 344 is configured to present XR content via the one or more XR displays 312. To that end, in various embodiments, the XR presenting unit 344 includes instructions and/or logic therefor, and heuristics and metadata therefor.

In some embodiments, the XR map generating unit 346 is configured to generate a XR map (e.g., a 3D map of the mixed reality scene or a map of the physical environment into which computer-generated objects can be placed to generate the extended reality) based on media content data. To that end, in various embodiments, the XR map generating unit 346 includes instructions and/or logic therefor, and heuristics and metadata therefor.

In some embodiments, the data transmitting unit 348 is configured to transmit data (e.g., presentation data, location data, etc.) to at least the controller 110, and optionally one or more of the input devices 125, output devices 155, sensors 190, and/or peripheral devices 195. To that end, in various embodiments, the data transmitting unit 348 includes instructions and/or logic therefor, and heuristics and metadata therefor.

Although the data obtaining unit 342, the XR presenting unit 344, the XR map generating unit 346, and the data transmitting unit 348 are shown as residing on a single device (e.g., the display generation component 120 of FIG. 1A), it should be understood that in other embodiments, any combination of the data obtaining unit 342, the XR presenting unit 344, the XR map generating unit 346, and the data transmitting unit 348 may be located in separate computing devices.

Moreover, FIG. 3A is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 3A could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform method 700 (FIG. 7) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application. FIG. 4 is a schematic, pictorial illustration of an example embodiment of the hand tracking device 140. In some embodiments, hand tracking device 140 (FIG. 1A) is controlled by hand tracking unit 244 (FIG. 2) to track the position/location of one or more portions of the user's hands, and/or motions of one or more portions of the user's hands with respect to the scene 105 of FIG. 1A (e.g., with respect to a portion of the physical environment surrounding the user, with respect to the display generation component 120, or with respect to a portion of the user (e.g., the user's face, eyes, or head), and/or relative to a coordinate system defined relative to the user's hand. In some embodiments, the hand tracking device 140 is part of the display generation component 120 (e.g., embedded in or attached to a head-mounted device). In some embodiments, the hand tracking device 140 is separate from the display generation component 120 (e.g., located in separate housings or attached to separate physical support structures).

In some embodiments, the hand tracking device 140 includes image sensors 404 (e.g., one or more IR cameras, 3D cameras, depth cameras, and/or color cameras, etc.) that capture three-dimensional scene information that includes at least a hand 406 of a human user. The image sensors 404 capture the hand images with sufficient resolution to enable the fingers and their respective positions to be distinguished. The image sensors 404 typically capture images of other parts of the user's body, as well, or possibly all of the body, and may have either zoom capabilities or a dedicated sensor with enhanced magnification to capture images of the hand with the desired resolution. In some embodiments, the image sensors 404 also capture 2D color video images of the hand 406 and other elements of the scene. In some embodiments, the image sensors 404 are used in conjunction with other image sensors to capture the physical environment of the scene 105, or serve as the image sensors that capture the physical environments of the scene 105. In some embodiments, the image sensors 404 are positioned relative to the user or the user's environment in a way that a field of view of the image sensors or a portion thereof is used to define an interaction space in which hand movement captured by the image sensors are treated as inputs to the controller 110.

In some embodiments, the image sensors 404 output a sequence of frames containing 3D map data (and possibly color image data, as well) to the controller 110, which extracts high-level information from the map data. This high-level information is typically provided via an Application Program Interface (API) to an application running on the controller, which drives the display generation component 120 accordingly. For example, the user may interact with software running on the controller 110 by moving his hand 406 and changing his hand posture.

In some embodiments, the image sensors 404 project a pattern of spots onto a scene containing the hand 406 and capture an image of the projected pattern. In some embodiments, the controller 110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 404. In the present disclosure, the image sensors 404 are assumed to define an orthogonal set of x, y, z axes, so that depth coordinates of points in the scene correspond to z components measured by the image sensors. Alternatively, the image sensors 404 (e.g., a hand tracking device) may use other methods of 3D mapping, such as stereoscopic imaging or time-of-flight measurements, based on single or multiple cameras or other types of sensors.

In some embodiments, the hand tracking device 140 captures and processes a temporal sequence of depth maps containing the user's hand, while the user moves his hand (e.g., whole hand or one or more fingers). Software running on a processor in the image sensors 404 and/or the controller 110 processes the 3D map data to extract patch descriptors of the hand in these depth maps. The software matches these descriptors to patch descriptors stored in a database 408, based on a prior learning process, in order to estimate the pose of the hand in each frame. The pose typically includes 3D locations of the user's hand joints and finger tips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 110. This program may, for example, move and modify images presented on the display generation component 120, or perform other functions, in response to the pose and/or gesture information.

In some embodiments, a gesture includes an air gesture. An air gesture is a gesture that is detected without the user touching (or independently of) an input element that is part of a device (e.g., computer system 101, one or more input device 125, and/or hand tracking device 140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand. In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 110 in electronic form, over a network, for example, or it may alternatively be provided on tangible, non-transitory media, such as optical, magnetic, or electronic memory media. In some embodiments, the database 408 is likewise stored in a memory associated with the controller 110. Alternatively or additionally, some or all of the described functions of the computer may be implemented in dedicated hardware, such as a custom or semi-custom integrated circuit or a programmable digital signal processor (DSP). Although the controller 110 is shown in FIG. 4, by way of example, as a separate unit from the image sensors 404, some or all of the processing functions of the controller may be performed by a suitable microprocessor and software or by dedicated circuitry within the housing of the image sensors 404 (e.g., a hand tracking device) or otherwise associated with the image sensors 404. In some embodiments, at least some of these processing functions may be carried out by a suitable processor that is integrated with the display generation component 120 (e.g., in a television set, a handheld device, or head-mounted device, for example) or with any other suitable computerized device, such as a game console or media player. The sensing functions of image sensors 404 may likewise be integrated into the computer or other computerized apparatus that is to be controlled by the sensor output.

FIG. 4 further includes a schematic representation of a depth map 410 captured by the image sensors 404, in accordance with some embodiments. The depth map, as explained above, comprises a matrix of pixels having respective depth values. The pixels 412 corresponding to the hand 406 have been segmented out from the background and the wrist in this map. The brightness of each pixel within the depth map 410 corresponds inversely to its depth value, i.e., the measured z distance from the image sensors 404, with the shade of gray growing darker with increasing depth. The controller 110 processes these depth values in order to identify and segment a component of the image (i.e., a group of neighboring pixels) having characteristics of a human hand. These characteristics, may include, for example, overall size, shape and motion from frame to frame of the sequence of depth maps.

FIG. 4 also schematically illustrates a hand skeleton 414 that controller 110 ultimately extracts from the depth map 410 of the hand 406, in accordance with some embodiments. In FIG. 4, the hand skeleton 414 is superimposed on a hand background 416 that has been segmented from the original depth map. In some embodiments, key feature points of the hand (e.g., points corresponding to knuckles, finger tips, center of the palm, end of the hand connecting to wrist, etc.) and optionally on the wrist or arm connected to the hand are identified and located on the hand skeleton 414. In some embodiments, location and movements of these key feature points over multiple image frames are used by the controller 110 to determine the hand gestures performed by the hand or the current state of the hand, in accordance with some embodiments.

FIG. 5 illustrates an example embodiment of the eye tracking device 130 (FIG. 1A). In some embodiments, the eye tracking device 130 is controlled by the eye tracking unit 243 (FIG. 2) to track the position and movement of the user's gaze with respect to the scene 105 or with respect to the XR content displayed via the display generation component 120. In some embodiments, the eye tracking device 130 is integrated with the display generation component 120. For example, in some embodiments, when the display generation component 120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 130 is separate from the display generation component 120. For example, when display generation component is a handheld device or a XR chamber, the eye tracking device 130 is optionally a separate device from the handheld device or XR chamber. In some embodiments, the eye tracking device 130 is a head-mounted device or part of a head-mounted device. In some embodiments, the head-mounted eye-tracking device 130 is optionally used in conjunction with a display generation component that is also head-mounted, or a display generation component that is not head-mounted. In some embodiments, the eye tracking device 130 is not a head-mounted device, and is optionally used in conjunction with a head-mounted display generation component. In some embodiments, the eye tracking device 130 is not a head-mounted device, and is optionally part of a non-head-mounted display generation component.

In some embodiments, the display generation component 120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5, in some embodiments, eye tracking device 130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 130 optionally captures images of the user's eyes (e.g., as a video stream captured at 60-120 frames per second (fps)), analyze the images to generate gaze tracking information, and communicate the gaze tracking information to the controller 110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 130 is calibrated using a device-specific calibration process to determine parameters of the eye tracking device for the specific operating environment 100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 130, images captured by the eye tracking cameras can be processed using a glint-assisted method to determine the current visual axis and point of gaze of the user with respect to the display, in accordance with some embodiments.

As shown in FIG. 5, the eye tracking device 130 (e.g., 130A or 130B) includes eye lens(es) 520, and a gaze tracking system that includes at least one eye tracking camera 540 (e.g., infrared (IR) or near-IR (NIR) cameras) positioned on a side of the user's face for which eye tracking is performed, and an illumination source 530 (e.g., IR or NIR light sources such as an array or ring of NIR light-emitting diodes (LEDs)) that emit light (e.g., IR or NIR light) towards the user's eye(s) 592. The eye tracking cameras 540 may be pointed towards mirrors 550 located between the user's eye(s) 592 and a display 510 (e.g., a left or right display panel of a head-mounted display, or a display of a handheld device, a projector, etc.) that reflect IR or NIR light from the eye(s) 592 while allowing visible light to pass (e.g., as shown in the top portion of FIG. 5), or alternatively may be pointed towards the user's eye(s) 592 to receive reflected IR or NIR light from the eye(s) 592 (e.g., as shown in the bottom portion of FIG. 5).

In some embodiments, the controller 110 renders AR or VR frames 562 (e.g., left and right frames for left and right display panels) and provides the frames 562 to the display 510. The controller 110 uses gaze tracking input 542 from the eye tracking cameras 540 for various purposes, for example in processing the frames 562 for display. The controller 110 optionally estimates the user's point of gaze on the display 510 based on the gaze tracking input 542 obtained from the eye tracking cameras 540 using the glint-assisted methods or other suitable methods. The point of gaze estimated from the gaze tracking input 542 is optionally used to determine the direction in which the user is currently looking.

The following describes several possible use cases for the user's current gaze direction, and is not intended to be limiting. As an example use case, the controller 110 may render virtual content differently based on the determined direction of the user's gaze. For example, the controller 110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 110 may direct external cameras for capturing the physical environments of the XR experience to focus in the determined direction. The autofocus mechanism of the external cameras may then focus on an object or surface in the environment that the user is currently looking at on the display 510. As another example use case, the eye lenses 520 may be focusable lenses, and the gaze tracking information is used by the controller to adjust the focus of the eye lenses 520 so that the virtual object that the user is currently looking at has the proper vergence to match the convergence of the user's eyes 592. The controller 110 may leverage the gaze tracking information to direct the eye lenses 520 to adjust focus so that close objects that the user is looking at appear at the right distance.

In some embodiments, the eye tracking device is part of a head-mounted device that includes a display (e.g., display 510), two eye lenses (e.g., eye lens(es) 520), eye tracking cameras (e.g., eye tracking camera(s) 540), and light sources (e.g., illumination sources 530 (e.g., IR or NIR LEDs), mounted in a wearable housing. The light sources emit light (e.g., IR or NIR light) towards the user's eye(s) 592. In some embodiments, the light sources may be arranged in rings or circles around each of the lenses as shown in FIG. 5. In some embodiments, eight illumination sources 530 (e.g., LEDs) are arranged around each lens 520 as an example. However, more or fewer illumination sources 530 may be used, and other arrangements and locations of illumination sources 530 may be used.

In some embodiments, the display 510 emits light in the visible light range and does not emit light in the IR or NIR range, and thus does not introduce noise in the gaze tracking system. Note that the location and angle of eye tracking camera(s) 540 is given by way of example, and is not intended to be limiting. In some embodiments, a single eye tracking camera 540 is located on each side of the user's face. In some embodiments, two or more NIR cameras 540 may be used on each side of the user's face. In some embodiments, a camera 540 with a wider field of view (FOV) and a camera 540 with a narrower FOV may be used on each side of the user's face. In some embodiments, a camera 540 that operates at one wavelength (e.g., 850 nm) and a camera 540 that operates at a different wavelength (e.g., 940 nm) may be used on each side of the user's face.

Embodiments of the gaze tracking system as illustrated in FIG. 5 may, for example, be used in computer-generated reality, virtual reality, and/or mixed reality applications to provide computer-generated reality, virtual reality, augmented reality, and/or augmented virtuality experiences to the user.

FIG. 6 illustrates a glint-assisted gaze tracking pipeline, in accordance with some embodiments. In some embodiments, the gaze tracking pipeline is implemented by a glint-assisted gaze tracking system (e.g., eye tracking device 130 as illustrated in FIGS. 1A and 5). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 6, the gaze tracking cameras may capture left and right images of the user's left and right eyes. The captured images are then input to a gaze tracking pipeline for processing beginning at 610. As indicated by the arrow returning to element 600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 610, for the current captured images, if the tracking state is YES, then the method proceeds to element 640. At 610, if the tracking state is NO, then as indicated at 620 the images are analyzed to detect the user's pupils and glints in the images. At 630, if the pupils and glints are successfully detected, then the method proceeds to element 640. Otherwise, the method returns to element 610 to process next images of the user's eyes.

At 640, if proceeding from element 610, the current frames are analyzed to track the pupils and glints based in part on prior information from the previous frames. At 640, if proceeding from element 630, the tracking state is initialized based on the detected pupils and glints in the current frames. Results of processing at element 640 are checked to verify that the results of tracking or detection can be trusted. For example, results may be checked to determine if the pupil and a sufficient number of glints to perform gaze estimation are successfully tracked or detected in the current frames. At 650, if the results cannot be trusted, then the tracking state is set to NO at element 660, and the method returns to element 610 to process next images of the user's eyes. At 650, if the results are trusted, then the method proceeds to element 670. At 670, the tracking state is set to YES (if not already YES), and the pupil and glint information is passed to element 680 to estimate the user's point of gaze.

FIG. 6 is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 101 for providing XR experiences to users, in accordance with various embodiments.

In some embodiments, the captured portions of real world environment 602 are used to provide a XR experience to the user, for example, a mixed reality environment in which one or more virtual objects are superimposed over representations of real world environment 602.

Thus, the description herein describes some embodiments of three-dimensional environments (e.g., XR environments) that include representations of real world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

### User Interfaces and Associated Processes

Attention is now directed towards embodiments of user interfaces (“UI”) and associated processes that may be implemented on a computer system, such as portable multifunction device or a head-mounted device, with a display generation component, one or more input devices, and (optionally) one or cameras.

FIGS. 7A-7Q illustrate examples of a computer system changing a size of a representation of respective media in a three-dimensional environment in response to detecting a change in playback location of the respective media.

FIG. 7A illustrates a computer system 101 (e.g., an electronic device) displaying (e.g., via a display generation component 120) a representation 702 in a three-dimensional environment 700. In some embodiments, computer system 101 is a head-mounted device (e.g., a head-mounted display) worn by a user of computer system 101 (e.g., user 742 as shown and described with reference to FIGS. 7I-7M). In some embodiments, computer system 101 includes a display generation component 120. For example, the display generation component is configured to display one or more virtual objects (e.g., virtual content included in a virtual window or a user interface) in three-dimensional environment 700. In some embodiments, the one or more virtual objects are displayed within (e.g., superimposed on) a virtual environment (e.g., as shown and described with reference to FIGS. 7A-7M). In some embodiments, the one or more virtual objects are displayed within (e.g., superimposed on) a representation of a physical environment of a user (e.g., as shown and described with reference to FIGS. 7N-7Q). For example, one or more virtual objects and one or more objects from a physical environment of the user are visible to the user in three-dimensional environment 700. In some embodiments, three-dimensional environment 700 is visible to the user of computer system 101 through display generation component 120 (e.g., optionally through a transparent and/or translucent display). For example, three-dimensional environment 700 is visible to the user of computer system 101 while the user is wearing computer system 101. In some embodiments, three-dimensional environment 700 has one or more characteristics of the three-dimensional environment described with reference to method 800. In some embodiments, computer system 101 includes a plurality of image sensors (e.g., image sensors 314 of FIG. 3). The image sensors optionally include one or more of a visible light camera, an infrared camera, a depth sensor, or any other sensor computer system 101 would be able to use to capture one or more images of a user or a part of the user (e.g., one or more hands of the user) while the user interacts with computer system 101.

In FIG. 7A, three-dimensional environment 700 includes a representation of a virtual environment. As shown in FIG. 7A, the representation of the virtual environment includes a plurality of mountains and a lake (e.g., a simulated reflection of the mountains is displayed on the lake in three-dimensional environment 700). In some embodiments, the virtual environment is a representation of a real-world geographic location. In some embodiments, the representation of the virtual environment shown in FIG. 7A has one or more characteristics of the representation of the virtual environment described with reference to method 800. In some embodiments, a portion 720a of the representation of the virtual environment is visible to the user of computer system 101. A second portion of the representation of the virtual environment is overlapped and/or occluded by representation 702 and is not visible from the current viewpoint of the user of computer system 101.

In some embodiments, representation 702 is a representation of media (e.g., having one or more characteristics of the representation of the respective media described with reference to method 800). For example, representation 702 is a virtual window that media is displayed within in three-dimensional environment 700. In some embodiments, the media included in representation 702 includes video and/or audio content. For example, the media is a movie, TV show, a live broadcast (e.g., associated with a streaming service), or an online video (e.g., associated with a social media and/or video sharing service). In some embodiments, the media has one or more characteristics of the respective media described with reference to method 800. In some embodiments, representation 702 includes one or more user interface elements that are optionally selectable (e.g., the one or more user interface elements are described as affordances below, such as close-out affordance 714 or playback affordance 716). For example, computer system 101 selects a user interface element (e.g., an affordance) in response to an input that includes attention (e.g., based on gaze, cursor, and/or hand position) directed toward the user interface element and optionally an air gesture (e.g., an air pinch performed with a hand of the user of computer system 101)). For example, as shown in FIG. 7A, representation 702 includes a close-out affordance 714. In some embodiments, close-out affordance 714 is selectable to cease display of the media in three-dimensional environment 700. In some embodiments, close-out affordance 714 is selectable to cease display of representation 702 in three-dimensional environment 700.

In some embodiments, in FIG. 7A, representation 702 is displayed at a fixed location in three-dimensional environment 700 (e.g., representation 702 is docked at a location in three-dimensional environment 700). For example, representation 702 is not configured to be moved in response to user input (e.g., while the media is played back in three-dimensional environment 700). Alternatively, in some embodiments, representation 702 is configured to be moved in three-dimensional environment 700 in response to user input (e.g., such as shown and described with reference to FIGS. 7N-7Q). For example, representation 702 is not displayed at a fixed location in three-dimensional environment 700 (e.g., representation 702 is not docked at a location in three-dimensional environment 700 (e.g., while the media is played back in three-dimensional environment 700)).

As shown in FIG. 7A, a virtual object 784 is displayed adjacent to representation 702 (e.g., in front of representation 702 from the current viewpoint of a user of computer system 101). In some embodiments, virtual object 784 includes one or more selectable options for controlling playback of the media displayed within representation 702. In some embodiments, one or more virtual objects (e.g., virtual object 784) are displayed at a location that is separate from the location of representation 702 and can be moved independently from representation 702 (e.g., in response to a select and drag input such as an air pinch and drag or other gesture). This enables a user to move media player controls separately from a representation of media content, allowing for a more flexible arrangement of virtual elements in three-dimensional environment 700, and in particular allows the media controls to be placed in a location where they are easily accessible to the user without interfering with visibility of the representation of media content. In FIG. 7A, virtual object 784 includes a playback affordance 716. In some embodiments, playback affordance 716 is selectable to change a playback status of the media in three-dimensional environment 700 (e.g., playback affordance 716 is selectable to play or pause playback of the media in three-dimensional environment 700). In FIG. 7A, virtual object 784 includes a playback progress bar 706a. For example, playback progress bar 706a represents a current playback location of the media (e.g., as represented by the position of playback indicator 708a on playback progress bar 706a). In some embodiments, playback progress bar 706a is selectable to change a playback location of the media (e.g., selecting a portion of playback progress bar 706a scrubs the video content of the media to a different playback location). In some embodiments, playback indicator 708a is selectable to change a playback location of the media (e.g., as shown and described with reference to FIGS. 7G-7H). In FIG. 7A, virtual object 784 includes rewind affordance 780 and fast-forward affordance 782. In some embodiments, rewind affordance 780 and fast-forward affordance 782 are selectable to change a playback location of the media, optionally by a pre-set amount of time (e.g., rewinding or fast-forwarding through video content by 5, 10, 15, 20, 25, 30, or 60 seconds). In some embodiments, virtual object 784 includes one or more additional selectable options, such as an affordance for sharing the content (e.g., via one or more applications accessible to a user on computer system 101), and/or an affordance to display a different representation of a virtual environment in three-dimensional environment 700 (e.g., affordance 718 as shown and described with reference to FIG. 7B). As shown in FIG. 7A, virtual object 784 is displayed with an affordance 786. In some embodiments, affordance 786 is selectable to move virtual object 784 to a different location in three-dimensional environment 700 (e.g., affordance 786 has one or more characteristics of affordances 758a-758c shown and described with reference to FIGS. 7N-7Q).

Additionally, or alternatively, in some embodiments, computer system 101 displays one or more playback controls (e.g., playback affordance 716, playback indicator 708a, and/or playback progress bar 706a) within representation 702 (e.g., as shown and described with reference to FIG. 7B). For example, computer system 101 displays representation 702 with one or more playback controls within an adjacent virtual object (e.g., virtual object 784 shown in FIG. 7A) when representation 702 is displayed at a fixed location in three-dimensional environment 702 (e.g., when representation 702 is not configured to be moved in response to user input), and displays one or more playback controls within representation 702 when representation 702 is not displayed at a fixed location in three-dimensional environment 702 (e.g., when representation 702 is configured to be moved in response to user input). It should be appreciated that although FIGS. 7B-7H illustrate playback controls displayed within representation 702, in some embodiments the playback controls are displayed within a virtual object adjacent to representation 702, such as within virtual object 784 shown and described with reference to FIG. 7A.

In FIG. 7A, a simulated lighting effect 704 is displayed in three-dimensional environment 700. In some embodiments, computer system 101 displays simulated lighting effect 704 to simulate how light from the media would reflect in a real-world environment from the viewpoint of the user of computer system 101. For example, simulated lighting effect 704 includes simulated light reflected off the lake in three-dimensional environment 700. In some embodiments, simulated lighting effect 704 includes one or more visual effects that correspond to one or more visual effects of the media included in representation 702 (e.g., as represented in FIG. 7A by the fill pattern of representation 702 and simulated lighting effect 704). For example, the simulated lighting effect 704 includes a brightness, color, and/or saturation that is based on a brightness, color, and/or saturation of the media. In some embodiments, as the media is played back in three-dimensional environment 700, one or more visual effects of the media (e.g., of representation 702) change (e.g., the brightness, color, and/or saturation of the media change). In some embodiments, as one or more visual effects of the media change during playback, the one or more visual effects of simulated lighting effect 704 change (e.g., based on one or more changes in brightness, color, and/or saturation of the media during the playback of the media in three-dimensional environment 700). In some embodiments, simulated lighting effect 704 has one or more characteristics of the simulated lighting effect described with reference to method 800.

In some embodiments, the media included in representation 702 includes one or more portions with different aspect ratios. For example, the media is a movie, and different scenes of the movie are displayed using different aspect ratios. FIG. 7A illustrates a representation 706b corresponding to playback progress bar 706a. Representation 706b includes a representation 708b corresponding to playback indicator 708a. In some embodiments, the location of playback indicator representation 708b relative to playback progress bar representation 706b represents a current playback location of the media (e.g., having one or more characteristics of the current playback location of the respective media as described with reference to method 800). For example, the location of playback indicator representation 708b relative to playback progress bar representation 706b indicates an amount of the media that has been played back (represented by the shaded portion of playback progress bar representation 706b) and an amount of the media that is left to be played back (represented by the non-shaded portion of playback progress bar representation 706b). As shown in FIG. 7A, representation 706b includes four playback portions 710a-710d. In some embodiments, playback portions 710a-710d correspond to different portions of the media (e.g., scenes of a movie) that include different aspect ratios. For example, as shown in FIG. 7A, the media includes four aspect ratios 712a-712d. As shown in FIG. 7A, first portion 710a of the media is to be displayed at aspect ratio 712a (e.g., a 4:3 aspect ratio), second portion 710b of the media is to be played back at aspect ratio 712b (e.g., a 16:9 aspect ratio), third portion 710c of the media is to be played back at aspect ratio 712c (e.g., a 21:9 aspect ratio), and fourth portion 710d of the media is to be played back at aspect ratio 712d (e.g., a 1.90:1 aspect ratio). It should be appreciated that the media may include a different number of portions with different aspect ratios (e.g., more or less than four different portions with different aspect ratios). It should also be appreciated that the aspect ratios shown in FIGS. 7A-7Q are an example, and the media may include different aspect ratios (e.g., an aspect ratio of a portion of the media is 4:3, 16:9, 1.85:1, 1.90:1, 2:1, 21:9, 2.35:1, 2.39:1, or 12:5). In some embodiments, computer system 101 detects a respective aspect ratio of the media from information associated with the media (e.g., as described with reference to the respective media in method 800). For example, computer system 101 detects a respective aspect ratio of the media from metadata embedded in a file of the media. For example, computer system 101 parses data that is used to playback the media to detect a respective aspect ratio (e.g., or optionally a change in aspect ratio) of the media.

As shown in FIG. 7A, the current playback location (e.g., represented by playback indicator representation 708b) of the media includes aspect ratio 712a (e.g., because the current playback location is within first portion 710a of the media that corresponds to aspect ratio 712a). In some embodiments, in accordance with a determination that the current playback location of the media is to be displayed at aspect ratio 712a, computer system 101 displays representation 702 with a first size relative to three-dimensional environment 700 (e.g., the size of representation 702 shown in FIG. 7A). For example, as shown in FIG. 7A, a portion 720a of three-dimensional environment 700 is visible, via display generation component 120, from the viewpoint of the user of computer system 101 when representation 702 is displayed with the first size relative to three-dimensional environment 700. In some embodiments, as shown in FIG. 7A, a portion of three-dimensional environment 700 different from portion 720a is not visible from the viewpoint of the user of computer system 101 because it is overlapped by representation 702 (e.g., the portion of three-dimensional environment 700 that is overlapped by representation 702 includes a portion of the mountains and a portion of the lake).

In some embodiments, computer system 101 detects a respective aspect ratio (or a change in the aspect ratio) of the media from content of the media. For example, as shown in FIG. 7A, aspect ratio 712a is illustrated with pillarboxing 760 (e.g., vertical black bars displayed on a left and right side of content). In some embodiments, computer system 101 detects that the media will be displayed in three-dimensional environment 700 with one or more artifacts (e.g., pillarboxing 760, letterboxing 762 (e.g., shown in aspect ratio 712c), and/or visual distortions of content of the media). For example, the media will be displayed with the one or more artifacts (e.g., in representation 702 in three-dimensional environment 700) because the respective aspect ratio (e.g., aspect ratio 712a) does not correspond to one or more dimensions (e.g., width and/or height) of representation 702 in three-dimensional environment 700. In some embodiments, in response to detecting the content of the media (e.g., including the one or more artifacts), computer system 101 displays representation 702 in three-dimensional environment 700 with a size that corresponds to the respective aspect ratio of the media. For example, as shown in FIG. 7A, computer system 101 displays representation 702 with a size (e.g., the first size) in three-dimensional environment 700 corresponding to aspect ratio 712a such that the media is not displayed with pillarboxing 760 (e.g., or with any other visual distortions that would otherwise be visible if the size of representation 702 did not correspond to aspect ratio 712a).

FIG. 7B illustrates a schematic representation of a first dimension (e.g., height 722a) and a second dimension (e.g., 722b) of representation 702 in three-dimensional environment 700. As shown in FIG. 7B, height 722a corresponds to a first value H₁₋ₐ and width 722b corresponds to a first value W₁₋ₐ (e.g., displaying representation 702 with the first size includes displaying representation with a height 722a of the first value H₁₋ₐ and a width 722b of the first value W₁₋ₐ). The schematic representations of height 722a and width 722b are used to illustrate changes in one or more dimensions of representation 702 in FIGS. 7B-7Q. As shown in FIG. 7B, schematic representations of height 722a and width 722b include a plurality of segments (tick marks). For example, in FIG. 7B, height 722a includes four segments and width 722b includes six segments. In some embodiments, a segment corresponds to a unit of measurement (e.g., in FIG. 7B, width 722b is two units of measurement greater than height 722a). It should be appreciated that, in some embodiments, the segments illustrated in the schematic representations of height 722a and width 722b correspond to a consistent unit of measurement throughout FIGS. 7B-7Q (e.g., height 722a of representation 702 is the same in FIG. 7D and FIG. 7E because height 722a of representation 702 includes six segments in both FIG. 7D and FIG. 7E). In some embodiments, the ratio of height 722a to width 722b of representation 702 corresponds to a respective aspect ratio associated with a current playback location of the media (e.g., in FIG. 7B, the ratio of height 722a to width 722b of representation 702 corresponds to aspect ratio 712a associated with playback portion 710a). It should be appreciated that the schematic representations of height 722a and width 722b are illustrated only for reference in FIGS. 7B-7Q, and do not represent objects that are displayed by computer system 101 and/or otherwise visible in three-dimensional environment 700.

In FIG. 7B, playback affordance 716, playback indicator 708a, and playback progress bar 706a are displayed within representation 702. In some embodiments, computer system 101 displays playback affordance 716, playback indicator 708a, and/or playback progress bar 706a within a virtual object different from representation 702 (e.g., within virtual object 784 shown and described with reference to FIG. 7A).

As shown in FIG. 7B, representation 702 includes an affordance 718. In some embodiments, affordance 718 is selectable to display a different representation of a virtual environment in three-dimensional environment 700 (e.g., affordance 718 is selectable to display the representation of the virtual environment included in three-dimensional environment 700 in FIGS. 7I-7M). In some embodiments, as shown in FIG. 7A, affordance 718 is included within representation 702. In some embodiments, affordance 718 is displayed outside of representation 702 (e.g., within a virtual object including one or more playback controls (e.g., virtual object 784 shown and described with reference to FIG. 7A), or in a different virtual object including one or more controls for controlling (e.g., the display of) and/or selecting one or more virtual environments). In some embodiments, affordance 718 is included in a user interface (e.g., of an application, or within a system user interface). In some embodiments, computer system 101 does not display representation 702 with affordance 718.

FIG. 7C illustrates computer system 101 detecting a user input corresponding to a request to change the size of representation 702 in three-dimensional environment 700. As shown in FIG. 7C, representation 702 is displayed with a re-size affordance 728. In some embodiments, re-size affordance 728 is selectable to change the size of representation 702 in three-dimensional environment 700. In some embodiments, re-size affordance 728 is consistently displayed with representation 702 in three-dimensional environment 700. In some embodiments, re-size affordance 728 is displayed in three-dimensional environment 700 in response to user input. For example, as shown in FIG. 7C, re-size affordance 728 is displayed in three-dimensional environment 700 in response to gaze 726 (e.g., of the user of computer system 101) being directed toward a location in three-dimensional environment 700 corresponding to re-size affordance 728 (e.g., computer system 101 displays re-size affordance 728 in three-dimensional environment 700 in accordance with a determination that gaze 726 is directed toward a corner of representation 702 (e.g., or optionally a location adjacent to a corner of representation 702)). In some embodiments, the user input corresponding to the request to change the size of representation 702 includes a hand gesture (e.g., including hand movement). For example, as shown in FIG. 7C, while gaze 726 of the user of computer system 101 is directed toward a location corresponding to re-size affordance 728, the user moves hand 724 in a direction 730 while performing an air pinch gesture.

In some embodiments, the media is played back in three-dimensional environment 700 while representation 702 is displayed (e.g., the media includes video and/or audio content). For example, as shown in FIG. 7C, a current playback location of the media (e.g., represented by playback indicator representation 708b) changes in FIG. 7C (e.g., compared to FIG. 7B). In some embodiments, computer system 101 maintains display of representation 702 with the same size in three-dimensional environment 700 in response to the change in playback location of the media because the current playback location remains within first portion 710a of the media including aspect ratio 712a. In some embodiments, while the media is played back in three-dimensional environment 700, a visual appearance of the media changes (e.g., color, brightness, and/or saturation of the video content of media change as the media is played back in three-dimensional environment 700). In some embodiments, in response to the change in the visual appearance of the media, computer system 101 changes one or more visual effects of simulated lighting effect 704 to correspond to the change in the visual appearance of the media (e.g., a change in the visual appearance of the media and the one or more visual effects of the simulated lighting effect 704 is represented by the difference in the fill pattern of simulated lighting effect 704 and representation 702 between FIG. 7B and FIG. 7C).

FIG. 7D illustrates computer system 101 displaying representation 702 with a different size relative to three-dimensional environment 700 in response to the user input detected by computer system 101 in FIG. 7C. As shown in FIG. 7D, computer system 101 changes height 722a of representation 702 to a second value H₂₋ₐ and width 722b of representation 702 to a second value W₂₋ₐ. In some embodiments, in response to the user input shown in FIG. 7C, computer system 101 changes height 722a and width 722b of representation 702 proportionally. For example, representation 702 is displayed with the same aspect ratio (e.g., proportion of width to height) in FIG. 7D as in FIG. 7C. For example, proportionally changing height 722a and width 722b of representation 702 in response to the user input illustrated in FIG. 7C ensures representation 702 is displayed with a consistent aspect ratio corresponding to aspect ratio 712a (e.g., because the current playback location (as represented by playback indicator representation 708b) is still within first portion 710a) such that the media is not displayed with one or more artifacts (e.g., pillarboxing 760 and/or letterboxing 762). In some embodiments, displaying representation 702 with a different size in three-dimensional environment 700 causes a different portion of three-dimensional environment 700 (e.g., of the representation of the virtual environment) to be overlapped by representation 702 (e.g., from the current viewpoint of the user of computer system 101). For example, as shown in FIG. 7D, a different portion of three-dimensional environment 700 (portion 720b) is visible based on the change in size of representation 702 (e.g., a difference between portion 720a and portion 720b of three-dimensional environment 700 corresponds to a difference between the size of representation 702 in FIG. 7C and representation 702 in FIG. 7D). In some embodiments, computer system 101 changes a size of simulated lighting effect 704 when changing the size of representation 702. For example, as shown in FIG. 7D, simulated lighting effect is displayed with a different size (e.g., compared to in FIG. 7C) corresponding to the changed size of representation 702.

In some embodiments, computer system 101 changes a size of representation 702 relative to three-dimensional environment 700 in response to changes in playback location of the media (e.g., caused by playback of the media in the three-dimensional environment 700 and/or user input). For example, a first playback location (e.g., within first portion 710a) includes a first aspect ratio (e.g., aspect ratio 712a), and a second playback location (e.g., within second portion 710b), different from the first playback location, includes a second aspect ratio (e.g., aspect ratio 712b), different from the first aspect ratio. For example, computer system 101 changes a size of representation 702 from a first size corresponding to the first aspect ratio to a second size, different from the first size, corresponding to the second aspect ratio. As described below, a size of representation 702 may be changed to correspond to a respective aspect ratio of the media by changing a first dimension of representation 702 and not a second dimension of representation 702 (e.g., by changing width 722b and not height 722a, and/or by changing height 722a and not width 722b). It should be appreciated that although a Figure may illustrate computer system 101 changing a first dimension and not a second dimension of representation 702, in some embodiments, computer system 101 changes the second dimension and not the first dimension, or changes both the first dimension and the second dimension such that the size of representation 702 corresponds to an aspect ratio at a respective playback location of the media.

FIG. 7E illustrates computer system 101 displaying representation 702 with a different size in three-dimensional environment 700 (compared to the size of representation 702 shown in FIG. 7D) in response to a change in the current playback location of the media (e.g., based on playback of the media in three-dimensional environment 700). As shown in FIG. 7E, the current playback location (as represented by playback indicator representation 708b) of the media is within second portion 710b of the media corresponding to aspect ratio 712b. For example, the video content of the media at the playback location in FIG. 7E includes a different visual appearance compared to the visual appearance associated with the playback location in FIG. 7D (e.g., represented by the change in the fill pattern of representation 702 and simulated lighting effect 704 from FIG. 7D to FIG. 7E). In response to detecting that a change in the current playback location of the media includes a change in the aspect ratio of the media (e.g., from aspect ratio 712a to aspect ratio 712b), computer system 101 changes width 722b of representation 702 relative to three-dimensional environment 700. For example, as shown in FIG. 7E, representation 702 is displayed with a third value W₃₋ₐ of width 722b (e.g., different from second value W₂₋ₐ shown in FIG. 7D). In some embodiments, computer system 101 displays an animation of representation 702 gradually changing size relative to three-dimensional environment 700 when the current playback location of the media changes to within second portion 710b until representation 702 is displayed with a size corresponding to aspect ratio 712b (e.g., width 722b of representation 702 expands over a period of time (e.g., 1, 2, 5, 10, 15, 20, 25, 30, or 60 seconds)). In some embodiments, computer system 101 expands width 722b from the center of representation 702. For example, as shown in FIG. 7E, computer system 101 increases width 722b in a first direction 732a and in a second direction 732b (e.g., opposite first direction 732a) relative to three-dimensional environment 700. In some embodiments, computer system 101 increases width 722b proportionally (e.g., by the same amount in first direction 732a and second direction 732b). In some embodiments, computer system 101 does not increase width 722b proportionally (e.g., width 722b increases by a different amount in first direction 732a compared to second direction 732b). In some embodiments, as shown in FIG. 7E, computer system 101 changes width 722b of representation 702 without changing height 722a. For example, representation 702 maintains displayed in three-dimensional environment 700 with second value H₂₋ₐ of height 722a (e.g., the same value of height 722a shown in FIG. 7D) despite width 722b changing from second value W₂₋ₐ to third value W₃₋ₐ. In some embodiments, displaying representation 702 with height 722a of second value H₂₋ₐ and width 722b of third value W₃₋ₐ (e.g., by changing width 722b without changing height 722a) enables representation 702 to be displayed in three-dimensional environment 700 with a size that corresponds to aspect ratio 712b (e.g., while maintaining a consistent position of representation 702 in three-dimensional environment 700). For example, aspect ratio 712b is a larger aspect ratio than aspect ratio 712a, and increasing width 722b of representation 702 without changing height 722a enables representation 702 to be displayed in three-dimensional environment 700 with a larger aspect ratio (corresponding to aspect ratio 712b of the media).

In some embodiments, displaying representation 702 with a different width 722b in three-dimensional environment 700 causes a different portion of three-dimensional environment 700 (e.g., of the representation of the virtual environment) to be overlapped by representation 702 (e.g., from the current viewpoint of the user of computer system 101). For example, as shown in FIG. 7E, a different portion of three-dimensional environment 700 (portion 720c) is visible based on the change in width 722b of representation 702 (e.g., a difference between portion 720b and portion 720c of three-dimensional environment 700 corresponds to a difference between the size of representation 702 in FIG. 7D and representation 702 in FIG. 7E). In some embodiments, as shown in FIG. 7E, computer system 101 changes a size (e.g., width) of simulated lighting effect 704 corresponding to the changed size of representation 702 when changing width 722b of representation 702.

FIG. 7F illustrates computer system 101 displaying representation 702 with a different size in three-dimensional environment 700 (compared to the size of representation 702 shown in FIG. 7E) in response to a change in a current playback location of the media (e.g., based on playback of the media in three-dimensional environment 700). As shown in FIG. 7F, the current playback location (as represented by playback indicator representation 708b) of the media is within third portion 710c of the media corresponding to aspect ratio 712c. For example, the video content of the media at the playback location in FIG. 7F includes a different visual appearance compared to at the playback location in FIG. 7E (e.g., representation by the change in the fill pattern of representation 702 and simulated lighting effect 704 from FIG. 7E to FIG. 7F). In response to detecting the change in the current playback location of the media to a playback location corresponding to aspect ratio 712c, computer system 101 changes width 722b of representation 702 relative to three-dimensional environment 700 without changing height 722a of representation 702. For example, as shown in FIG. 7F, representation 702 is displayed with a fourth value W₄₋ₐ of width (e.g., different from third value W₃₋ₐ shown in FIG. 7E) and the second value H₂₋ₐ of height (e.g., the same value of height 722a of representation 702 is displayed with in FIG. 7E). In some embodiments, computer system 101 expands the width 722b from the center of representation 702 (e.g., as described with reference to FIG. 7E). In some embodiments, computer system 101 displays an animation of representation 702 gradually changing size relative to three-dimensional environment 700 when the current playback location of the media changes to within third portion 710c until representation 702 is displayed with a size corresponding to aspect ratio 712c (e.g., width 722b of representation 702 expands over a period of time (e.g., 1, 2, 5, 10, 15, 20, 25, 30, or 60 seconds)). In some embodiments, displaying representation 702 with height 722a of second value H₂₋ₐ and width 722b of fourth value W₄₋ₐ (e.g., by changing width 722b without changing height 722a) enables representation 702 to be displayed in three-dimensional environment 700 with a size that corresponds to aspect ratio 712c (e.g., while maintaining a consistent position of representation 702 in three-dimensional environment 700). For example, aspect ratio 712c is a larger aspect ratio than aspect ratio 712b, and increasing width 722b of representation 702 without changing height 722a enables representation 702 to be displayed in three-dimensional environment 700 with a larger aspect ratio (corresponding to aspect ratio 712c of the media). Further, by displaying representation 702 with a size that corresponds to aspect ratio 712c, computer system 101 prevents the media from being displayed with one or more artifacts (e.g., letterboxing 762) in three-dimensional environment 700 (e.g., within representation 702). As shown in FIG. 7F, a different portion of three-dimensional environment 700 is overlapped (e.g., from the current viewpoint of the user of computer system 101) when representation 702 is displayed with width 722b of fourth value W₄₋ₐ. For example, a different portion of three-dimensional environment 700 (portion 720d) is visible based on the change in width 722b of representation 702 (e.g., a difference between portion 720d and portion 720c of three-dimensional environment 700 corresponds to a difference between the size of representation 702 in FIG. 7E and representation 702 in FIG. 7F). In some embodiments, as shown in FIG. 7F, computer system 101 changes a size of simulated lighting effect 704 in three-dimensional environment 700 corresponding to the changed size of representation 702.

FIG. 7G illustrates computer system 101 displaying representation 702 with a different size in three-dimensional environment 700 (compared to the size of representation 702 shown in FIG. 7F) in response to a change in a current playback location of the media (e.g., based on playback of the media in three-dimensional environment 700). As shown in FIG. 7G, the current playback location (as represented by playback indicator representation 708b) of the media is within fourth portion 710d of the media corresponding to aspect ratio 712d. For example, the video content of the media at the playback location in FIG. 7G includes a different visual appearance compared to at the playback location in FIG. 7F (e.g., represented by the change in the fill pattern of representation 702 and simulated lighting effect 704 from FIG. 7F to FIG. 7G). In some embodiments, computer system 101 changes the size of representation 702 differently when changing to a size corresponding to aspect ratio 712d compared to changing representation 702 to a size corresponding to aspect ratios 712a-712c. For example, in response to detecting the change in the current playback location of the media to a playback location corresponding to aspect ratio 712d, computer system changes height 722a of representation 702. As shown in FIG. 7G, representation 702 is displayed with a third value H₃₋ₐ of height (e.g., different from second value H₂₋ₐ of height 722a shown in FIG. 7F). In some embodiments, computer system 101 displays an animation of representation 702 gradually changing size relative to three-dimensional environment 700 when the current playback location of the media changes to within fourth portion 710d until representation 702 is displayed with a size corresponding to aspect ratio 712d (e.g., height 722a of representation 702 expands over a period of time (e.g., 1, 2, 5, 10, 15, 20, 25, 30, or 60 seconds)).

In some embodiments, when changing a size of representation 702 in three-dimensional environment 700 to correspond to aspect ratio 712d, computer system 101 changes height 722a of representation 702 and not width 722b. For example, as shown in FIG. 7G, computer system 101 displays representation 702 with the fourth value W₄₋ₐ of width (e.g., the same value of width 722b of representation 702 is displayed with in FIG. 7F). In some embodiments, displaying representation 702 with height 722a of third value H₃₋ₐ and width 722b of fourth value W₄₋ₐ (e.g., by changing height 722a without changing width 722b) enables representation 702 to be displayed in three-dimensional environment 700 with a size that corresponds to aspect ratio 712d (e.g., while maintaining a consistent position of representation 702 in three-dimensional environment 700). As shown in FIG. 7G, a different portion of three-dimensional environment 700 is overlapped (e.g., from the current viewpoint of the user of computer system 101) when representation 702 is displayed with height 722a of third value H₃₋ₐ. For example, a different portion of three-dimensional environment 700 (portion 720e) is visible based on the change in height 722a of representation 702 (e.g., a difference between portion 720e and portion 720d of three-dimensional environment 700 corresponds to a difference between the size of representation 702 in FIG. 7F and representation 702 in FIG. 7G). In some embodiments, as shown in FIG. 7G, computer system 101 changes a size of simulated lighting effect 704 in three-dimensional environment 700 corresponding to the changed size of representation 702.

In some embodiments, computer system 101 changes height 722a of representation 702 in different manners based on the type of virtual environment that is included in three-dimensional environment 700 (e.g., to prevent obstruction of visual features (e.g., a simulated lighting effect) visible in the virtual environment). For example, in accordance with a determination that three-dimensional environment 700 includes a representation of a virtual environment of a first type (e.g., such as the mountain and lake environment shown in FIGS. 7A-H), computer system 101 expands height 722a of representation 702 from the bottom of representation 702 (e.g., upward and not downward) when changing the size of representation 702 to correspond to aspect ratio 712d (e.g., such that the lake and/or simulated lighting effect 704 is displayed consistently in three-dimensional environment 700). For example, as shown in FIG. 7G, computer system 101 increases height 722a in a first direction 734a (e.g., an upward direction) and not in a second direction opposite first direction 734a (e.g., a downward direction). In some embodiments, in accordance with a determination that three-dimensional environment 700 includes a representation of a virtual environment of a second type, different from the first type (e.g., such as the representation of the virtual environment shown in FIGS. 7I-7M), computer system 101 expands height 722a of representation 702 from the center of representation 702 (e.g., as shown and described with reference to FIGS. 7I-7K).

In FIG. 7G, computer system 101 detects a user input corresponding to a request to navigate through the media. For example, navigation through the media includes scrubbing through video content to change the current playback location. As shown in FIG. 7G, the user input includes gaze 726 directed to playback progress bar 706a (e.g., and/or playback indicator 708a) and a hand gesture performed by hand 724 (e.g., an air pinch with movement in a direction 730). In some embodiments, the user input includes movement (e.g., of hand 724) in a direction (e.g., direction 730) corresponding to a requested playback location (e.g., in accordance with a determination that the user input includes movement in direction 730, computer system 101 navigates backward through the media, and in accordance with a determination that the user input includes movement in a direction opposite from direction 730, computer system 101 navigates forward through the media).

In response to the user input shown in FIG. 7G, computer system 101 changes the current playback location (e.g., represented by playback indicator representation 708b) in FIG. 7H. In some embodiments, the change in playback location of the media changes a visual appearance of the media (e.g., as described above). As shown in FIG. 7H, the current playback location of the media is within third portion 710c of the media corresponding to aspect ratio 712c. In accordance with a determination that the navigation of the media includes a change to aspect ratio 712c (e.g., from aspect ratio 712d shown in FIG. 7G), computer system 101 changes a size of representation 702 to correspond to aspect ratio 712c by reducing height 722a of representation 702 from third value H₃₋ₐ to second value H₂₋ₐ. In some embodiments, computer system 101 displays an animation of representation 702 gradually changing size relative to three-dimensional environment 700 while and/or after the user input is performed (e.g., computer system 101 changes height 722a over a period of time (e.g., 1, 2, 5, 10, 20, 25, 30, or 60 seconds) during and/or after detecting the user input). In some embodiments, computer system 101 reduces height 722a of representation 702 within 0.1, 0.2, 0.5, 1, 2, or 5 seconds of the user changing the playback location of the media to within third portion 710c (e.g., computer system 101 changes the size of representation immediately upon the user changing the playback location of the media to within third portion 710c). As shown in FIG. 7H, reducing height 722a to second value H₂₋ₐ includes decreasing height 722a from the top of representation 702 (e.g., in a downward direction and not in an upward direction). For example, height 722a of representation 702 is decreased in a second direction 734b (e.g., opposite first direction 734a shown in FIG. 7G). As shown in FIG. 7H, a different portion of three-dimensional environment 700 is overlapped (e.g., from the current viewpoint of the user of computer system 101) compared to as shown in FIG. 7G. For example, a different portion of three-dimensional environment 700 (e.g., portion 720d) is visible based on the change in height 722a of representation 702. In some embodiments, computer system 101 changes a size of simulated lighting effect 704 in three-dimensional environment 700 corresponding to the changed size of representation 702.

In FIG. 7H, computer system 101 detects a user input corresponding to a request to display a different representation of a virtual environment in three-dimensional environment 700 (e.g., a representation of a virtual environment of a second type, different from the representation of the virtual environment of the first type shown in FIGS. 7A-7H). For example, the user input includes selection of affordance 718. As shown in FIG. 7H, the user input includes gaze 726 directed to affordance 718 while an air gesture (e.g., an air pinch) is performed with hand 724. In response to detecting the user input (e.g., corresponding to selection of affordance 718), computer system 101 displays a representation of a virtual environment of a second type as illustrated in FIG. 7I.

FIG. 7I illustrates representation 702 displayed within a representation of a virtual environment for displaying video content in three-dimensional environment 700. In some embodiments, the virtual environment is a representation of a theater or cinema room. For example, the virtual environment shown in FIGS. 7I-7M is darker (e.g., less bright or more dim) than the virtual environment shown in FIGS. 7A-7H. For example, the virtual environment includes empty space surrounding representation 702. In some embodiments, the virtual environment includes a virtual surface 764a-764b. For example, virtual surface 764a is a ceiling surface that a simulated lighting effect 736a is displayed on, and virtual surface 764b is a floor surface that a simulated lighting effect 736b is displayed on. In some embodiments, simulated lighting effect 736a-736b have one or more characteristics of simulated lighting effect 704 shown and described with reference to FIGS. 7A-7H and/or the simulated lighting effect described with reference to method 800. For example, one or more visual effects of simulated lighting effects 736a-736b correspond to a visual appearance of the media (e.g., as shown in FIG. 7I, simulated lighting effects 736a-736b and representation 702 include a same fill pattern (e.g., representing that a visual appearance of simulated lighting effects 736a-736b correspond to a visual appearance of content of the media at the current playback location)).

In some embodiments, representation 702 is displayed in three-dimensional environment 700 with a height 722a of a first value H_{1-b} and a width 722b of a first value W_{1-b}. In some embodiments, first value H_{1-b} corresponds to second value H₂₋ₐ (e.g., shown in FIG. 7H) and first value W_{1-b} corresponds to fourth value W_{4-A} (e.g., shown in FIG. 7H). In some embodiments, computer system 101 maintains a same size (e.g., compared to as shown in FIG. 7H) of representation 702 relative to three-dimensional environment 700 when displaying representation 702 within a different virtual environment. In some embodiments, computer system 101 displays representation 702 with a different size (e.g., compared to as shown in FIG. 7H) relative to three-dimensional environment 700 when displaying representation 702 within a different virtual environment. For example, computer system 101 changes height 722a and/or width 722b of representation 702 proportionally (e.g., such that a size of representation 702 continues to correspond to aspect ratio 712c). In some embodiments, computer system 101 changes a display size of representation 702 in three-dimensional environment 700. For example, computer system 101 displays representation 702 at a different distance (e.g., closer or farther) relative to a location corresponding to the current viewpoint of the user of computer system when displaying representation 702 in a different virtual environment (e.g., top-down view 738 illustrates a location of representation 702 relative to a user 742 of computer system 101 in three-dimensional environment 700). In some embodiments, representation 702 overlaps (e.g., from the current viewpoint of user 742) a portion of three-dimensional environment 700 (e.g., the representation of virtual environment) such that the portion is not visible to user 742. For example, as shown in FIG. 7I, when representation 702 is displayed with height 722a of first value H_{1-b} and width 722b of first value W_{1-b}, a portion 740a of three-dimensional environment 700 is visible (e.g., portion 740a includes virtual surfaces 764a-764b, and does not include the portion of three-dimensional environment 700 overlapped by representation 702).

FIG. 7J illustrates computer system 101 changing a size of representation 702 to a different size relative to three-dimensional environment 700 in response to a change in a current playback location of the media (e.g., based on playback of the media in three-dimensional environment 700). For example, FIG. 7J illustrates computer system 101 transitioning from displaying representation 702 with a size corresponding to aspect ratio 712c (e.g., as shown in FIG. 7I) to a size corresponding to aspect ratio 712d. For example, computer system 101 displays an animation of representation 702 gradually changing size relative to three-dimensional environment 700 (e.g., representation 702 expands in size over a period of time (e.g., 1, 2, 5, 10, 15, 20, 25, 30, or 60 seconds)). As shown in FIG. 7I, the current playback location (as represented by playback indicator representation 708b) of the media is within fourth portion 710d of the media corresponding to aspect ratio 712d. In some embodiments, in accordance with a determination that representation 702 is displayed in the representation of the virtual environment (e.g., as shown in FIGS. 7I-7M (e.g., in a representation of a virtual environment of a second type)) when the aspect ratio of the media changes to aspect ratio 712d, computer system 101 expands height of 722a of representation 702 from the center of representation 702 (e.g., as opposed to from the bottom of representation 702, as shown in FIG. 7G). For example, as shown in FIG. 7J, representation 702 expands in height 722a in the first direction 734a (e.g., an upward direction) and in the second direction 734b (e.g., a direction opposite from first direction 734a (e.g., a downward direction)). In some embodiments, representation 702 expands in height 722a symmetrically (e.g., by the same amount in first direction 734a and second direction 734b). In some embodiments, representation 702 does not expand in height 722a symmetrically (e.g., representation 702 does not expand by the same amount in first direction 734a and second direction 734b). As shown in FIG. 7J, representation 702 includes a height 722a of a second value H_{2-b} (e.g., different from first value H₂₋ₐ). For example, second value H_{2-b} is an intermediate value of height 722a displayed during the animation of representation 702 changing in size relative to three-dimensional environment 700 (e.g., a current size of representation 702 illustrated in FIG. 7J does not yet correspond to aspect ratio 712d). In some embodiments, computer system 101 maintains the same width 722b of representation 702 when transitioning representation 702 to a size corresponding to aspect ratio 712d. For example, as shown in FIG. 7J, representation 702 is displayed with a first value W_{1-b} of width 722b (e.g., the same value of width 722b shown in FIG. 7I). As shown in FIG. 7J, a different portion of three-dimensional environment 700 is overlapped (e.g., from the current viewpoint of user 742) when representation 702 is displayed with height 722a of second value H_{2-b} and width 722b of first value W_{1-b}. For example, a different portion of three-dimensional environment 700 is visible (portion 740b) based on the change in height 722a of representation 702 (e.g., a difference between portion 740b and portion 740a (e.g., shown in FIG. 7I) corresponds to a difference between the size of representation 702 in FIG. 7I and representation 702 in FIG. 7J).

In some embodiments, displaying representation 702 with a size corresponding to aspect ratio 712d causes at least a portion of representation 702 to be displayed at locations in three-dimensional environment 700 that include virtual surfaces 764a-764b. In some embodiments, while changing the size of representation 702 in response to the change in the current playback location to fourth portion 710d of the media, computer system 101 decreases the visibility (e.g., reduces the visual prominence by reducing opacity, brightness, color, and/or size) of virtual surfaces 764a-764b (e.g., to avoid spatial and/or visual conflicts between representation 702 (e.g., the media) and virtual surfaces 764a-764b (e.g., and/or simulated lighting effects 736a-736b)). In some embodiments, as shown in FIG. 7J, computer system 101 reduces the visual prominence of virtual surfaces 764a-764b (e.g., virtual surfaces 764a-764b are displayed with a reduced opacity in FIG. 7J compared to FIG. 7I) while displaying the animation of representation 702 expanding in height 722a (e.g., as representation 702 expands closer to virtual surface 764a and/or virtual surface 764b, computer system 101 increases the transparency (e.g., and/or reduces the opacity) of virtual surface 764a and/or virtual surface 764b). In some embodiments, as shown in FIG. 7J, computer system 101 reduces the visual prominence of simulated lighting effects 736a-736b (e.g., by reducing the opacity, brightness, color and/or size of simulated lighting effects 736a-736b) concurrently with virtual surfaces 736a-736b.

FIG. 7K illustrates computer system 101 displaying representation 702 with a size in three-dimensional environment 700 corresponding to aspect ratio 712d in response to the change in the current playback location of the media (e.g., to within fourth portion 710d). In some embodiments, FIG. 7K illustrates computer system 101 continuing the expansion of height 722a of representation 702 shown in FIG. 7J. As shown in FIG. 7K, computer system 101 expands height 722a of representation 702 to third value H_{3-b} (e.g., different from second value H_{2-b} shown in FIG. 7J) and maintains width 722b of representation 702 at first value W_{1-b}. In some embodiments, computer system 101 expands height 722a from the center of representation 702 (e.g., in first direction 734a and second direction 734b (e.g., as described with reference to FIG. 7J)). As shown in FIG. 7K, a different portion of three-dimensional environment 700 is overlapped (e.g., from the current viewpoint of user 742) when representation 702 is displayed with height 722a of third value H_{3-b} and width 722b of first value W_{1-b}. For example, a different portion of three-dimensional environment 700 is visible (portion 740c) based on the change in height 722a of representation 702 (e.g., a difference between portion 740c and portion 740b (e.g., shown in FIG. 7J) corresponds to a difference between the size of representation 702 in FIG. 7J and representation 702 in FIG. 7K).

In FIG. 7K, when representation 702 is displayed with the size corresponding to aspect ratio 712d (e.g., with height 722a of third value H_{3-b} and width 722b of first value W_{1-b}), representation 702 is displayed in one or more regions of three-dimensional environment 700 corresponding to virtual surfaces 764a-764b. In some embodiments, as computer system 101 continues to expand the size of representation 702 (e.g., from height 722a of second value H_{2-b} shown in FIG. 7J to third value H_{3-b} in FIG. 7K), computer system 101 continues to decrease the visibility of virtual surfaces 764a-764b (e.g., and simulated lighting effects 736a-736b displayed on virtual surfaces 764a-764b). In some embodiments, when representation 702 reaches the size corresponding to aspect ratio 712d (e.g., when representation 702 is displayed with height 722a of third value H_{3-b}), virtual surfaces 764a-764b (e.g., and simulated lighting effects 736a-736b) are not displayed in three-dimensional environment 700 (e.g., computer system 101 ceases to display virtual surfaces 764a-764b and simulated lighting effects 736a-736b while displaying representation 702 with the size corresponding to aspect ratio 712d).

FIG. 7L illustrates an example embodiment that includes computer system 101 changing a curvature of representation 702 in three-dimensional environment 700 in response to the change in the current playback location to within fourth portion 710d of the media (e.g., corresponding to aspect ratio 712d). As shown in FIG. 7L (e.g., in top-down view 738 and side view 744), computer system 101 increases the amount of curvature that representation 702 is displayed with in three-dimensional environment 700 (e.g., compared to as shown in FIG. 7I). In some embodiments, increasing the amount of curvature includes displaying representation 702 to surround a location corresponding to user 742 (e.g., to surround a location in three-dimensional environment 700 corresponding to user 742 by 45, 70, 80, 105, 135, 150, 180, 240, 275, or 360 degrees). For example, as shown in side view 744, representation 702 expands such that the left and right edge of representation 702 move closer to the location corresponding to user 742 (e.g., who is sitting in a chair 746 in a physical environment while wearing computer system 101 and viewing three-dimensional environment 700). Optionally, increasing curvature includes moving a center portion of representation 702 farther from the location corresponding to user 742 than the left and right edges of representation 702. In some embodiments, increasing the curvature of representation 702 includes increasing the arc length of representation 702 relative to three-dimensional environment 700. Optionally, displaying representation 702 with curvature in three-dimensional environment 700 includes displaying simulated lighting effect 738a-738b (or optionally simulated lighting effect 704 shown in FIGS. 7A-7H or simulated lighting effect 748 shown in FIGS. 7N-7Q) with curvature. For example, expanding a curvature of representation 702 (e.g., as described below) includes changing a curvature of simulated lighting effect 738a-738b. It should be appreciated that, in some embodiments, representation 702 is displayed with curvature in a representation of a virtual environment different from the representation of the virtual environment illustrated in FIG. 7L (e.g., in the representation of the virtual environment illustrated in FIGS. 7A-7H), or in a representation of a physical environment (e.g., as shown and described with reference to FIGS. 7N-7Q).

In some embodiments, FIG. 7L illustrates computer system 101 displaying an animation of representation 702 expanding in curvature (e.g., and size) relative to three-dimensional environment 700. For example, the size of representation 702 shown in FIG. 7L is an intermediate size (e.g., displayed while expanding representation 702) that does not correspond to aspect ratio 712d (e.g., as measured by a width and height of representation 702 without curvature). In some embodiments, while computer system 101 increases the curvature and/or size of representation 702 to correspond to aspect ratio 712d, computer system 101 decreases the visibility of surfaces 764a-764b and simulated lighting effect 738a-738b (e.g., as described with reference to FIG. 7J). For example, computer system 101 decreases the visibility of surfaces 764a-764b and simulated lighting effect 738a-738b to avoid visual and/or spatial conflicts with representation 702. In some embodiments, portion 740d of three-dimensional environment 700 is visible (e.g., different from portion 740a shown in FIG. 7I) based on the change in curvature (and size) of representation 702. For example, a difference between portion 740d shown in FIG. 7L and portion 740a shown in FIG. 7I corresponds to a difference in the size and/or curvature of representation 702 in FIG. 7L and representation 702 in FIG. 7I.

In some embodiments, representation 702 is immersive content that is displayed in three-dimensional environment 700. For example, user 742 changes a curvature of representation 702 in response to a user input corresponding to a request to change (e.g., increase) an immersion level of representation 702 (e.g., the user input includes actuation of a hardware input device (e.g., a button and/or a crown), selection of an affordance displayed in three-dimensional environment 700, and/or an audio input (e.g., a verbal command)). In some embodiments, the amount of curvature of representation 702 corresponds to a level of immersion of representation 702. In some embodiments, a level of immersion of representation 702 corresponds to an angular range of three-dimensional environment 700 that is occupied by representation 702, and/or to a respective amount of field of view representation 702 consumes (e.g., as described with reference to method 800). In some embodiments, computer system 101 displays representation 702 with a first level of immersion (e.g., corresponding to a first amount of curvature) in FIG. 7L in response to user input (e.g., and optionally independent of a current playback location of the media). In some embodiments, representation 702 is configured to be displayed as immersive content (e.g., with curvature) based on the type of content included in the media. For example, in accordance with a determination that the content has a respective aspect ratio (e.g., aspect ratio 712d) that is compatible with immersion, computer system 101 displays representation 702 with immersion (e.g., with curvature) in three-dimensional environment 700.

FIG. 7M illustrates computer system 101 displaying representation 702 with a greater amount of curvature than in FIG. 7L. For example, computer system 101 displays representation 702 with the amount of curvature shown in FIG. 7M in response to the change in the current playback location within fourth portion 710d of the media (e.g., corresponding to aspect ratio 712d). For example, computer system 101 continues to expand (e.g., gradually, as described with reference to FIG. 7L) the curvature of representation 702 (e.g., from the curvature shown in FIG. 7L) to the curvature shown in FIG. 7M. In some embodiments, changing an amount of curvature (e.g., and/or immersion) of representation 702 does not change an aspect ratio of representation 702 and/or the media. For example, an aspect ratio (e.g., aspect ratio 712d) of representation 702 displayed with curvature, as shown in FIG. 7M, corresponds to the same aspect ratio (e.g., aspect ratio 712d) of representation 702 displayed without curvature, as shown in FIG. 7K.

As shown in top-down view 738 and side view 744 in FIG. 7M, representation 702 is displayed to surround the location corresponding to user 742 by a greater amount than shown in FIG. 7L. In some embodiments, the size and/or curvature of representation 702 shown in FIG. 7L corresponds to aspect ratio 712d (e.g., computer system 101 ceases to display an animation of representation 702 expanding in size and/or curvature in three-dimensional environment 700 when representation 702 is displayed with the size and/or curvature shown in FIG. 7M). In some embodiments, as shown in FIG. 7M, computer system 101 ceases to display virtual surfaces 764a-764b and simulated lighting effect 738a-738b when representation 702 is displayed with the size and curvature shown in FIG. 7M (e.g., to avoid visual and/or spatial conflicts as described above). In FIG. 7M, portion 740e of three-dimensional environment 700 is visible from the current viewpoint of user 742. In some embodiments, portion 740e is visible based on the curvature (e.g., and optionally size) of representation 702. For example, a difference between portion 740e shown in FIG. 7M and portion 740d shown in FIG. 7L corresponds to a difference in the size and/or curvature of representation 702 in FIG. 7M and representation 702 in FIG. 7J.

In some embodiments, computer system 101 displays representation 702 in FIG. 7M with an increased level of immersion (e.g., with a second level of immersion, greater than the first level of immersion shown in FIG. 7L) in response to a user input corresponding to a request to change (e.g., increase) an immersion level of representation 702 (e.g., the user input includes one or more characteristics of the user input corresponding to the request to change an immersion level of representation 702 described with reference to FIG. 7L). In some embodiments, computer system 101 displays representation 702 with a second level of immersion (e.g., corresponding to a second amount of curvature, different from a first amount of curvature shown in FIG. 7L) in response to user input (e.g., and optionally independent of a current playback location of the media). For example, as shown in FIG. 7M, representation 702 occupies a greater angular range of three-dimensional environment 700 and a greater amount of field of view than shown in FIG. 7L (e.g., because the level of immersion of representation 702 has increased in FIG. 7M from the level of immersion shown in FIG. 7L).

FIG. 7N illustrates computer system 101 displaying representation 702 within a representation of a physical environment of the user of computer system 101. As shown in FIG. 7N, representations of real-world objects (e.g., real-world window 756a and table 756b) are visible in three-dimensional environment 700 (e.g., through optical passthrough visible via display generation component 120). Further, as shown in FIG. 7N, one or more virtual objects different from representation 702 (e.g., virtual windows 752a-752b) are visible (e.g., superimposed on the representation of the physical environment) in three-dimensional environment 700 (e.g., virtual windows 752a-752b are computer-generated and/or displayed by display generation component 120). In some embodiments, representation 702 (e.g., and/or virtual windows 752a-752b) is configured to be moved in three-dimensional environment 700 in response to user input (e.g., representation 702 is not docked at a location in three-dimensional environment 700 (e.g., while the media is played back in three-dimensional environment 700)). As shown in FIG. 7N, representation 702 and virtual windows 752a-752b are displayed with affordances 758a-758c. In some embodiments, affordance 758a is selectable (e.g., through a user input having one or more characteristics of the user input shown and described with reference to FIG. 7C) to move representation 702 in three-dimensional environment 700, affordance 758b is selectable to move virtual window 752a in three-dimensional environment 700, and affordance 758c is selectable to move virtual window 752c in three-dimensional environment 700. Alternatively, in some embodiments, representation 702 is displayed as docked at a location (e.g., not configured to move in response to user input) within the representation of the physical environment (e.g., as described with reference to FIG. 7A). In some embodiments, representation 702 is configured to change size in response to user input while displayed within the representation of the physical environment (e.g., the user input having one or more characteristics of the user input shown and described with reference to FIGS. 7C-7D). In some embodiments, the representation of the physical environment shown in FIGS. 7N-7Q has one or more characteristics of the representation of the physical environment described with reference to method 800.

As shown in FIGS. 7N-7Q, computer system 101 displays playback controls (playback affordance 716, playback indicator 708a, and playback progress bar 706a) within representation 702. In some embodiments, computer system 101 displays the playback controls within representation 702 because representation 702 is not displayed at a fixed location in three-dimensional environment 702 in FIGS. 7N-7Q. Alternatively, in some embodiments, computer system 101 displays representation 702 in FIGS. 7N-7Q with an adjacent virtual object that includes the playback controls, such as virtual object 784 shown and described with reference to FIG. 7A.

In FIG. 7N, a current playback location of the media (e.g., as represented by playback indicator representation 708b) is within first portion 710a of the media associated with aspect ratio 712a (e.g., the first portion 710a is to be displayed at aspect ratio 712a). In some embodiments, computer system 101 displays representation 702 with a size in three-dimensional environment 700 (e.g., within the representation of the physical environment) corresponding to aspect ratio 712a (e.g., such that the media is not displayed in three-dimensional environment 700 with pillarboxing 760). As shown in FIG. 7N, representation 702 is displayed with a height 722a of first value H_{1-c} and a width 722b of first value W_{1-c} (e.g., first value H_{1-c} optionally corresponds to first value H₁₋ₐ (e.g., shown in FIG. 7B), and first value W_{1-c} optionally corresponds to first value W₁₋ₐ (e.g., shown in FIG. 7B)). In some embodiments, displaying representation 702 with height 722a of first value H_{1-c} and width 722b of first value W_{1-c} corresponds to aspect ratio 712a. In some embodiments, a portion of the representation of the physical environment (e.g., including passthrough of the physical environment) is overlapped by representation 702 (e.g., from the current viewpoint of the user of computer system 101) when representation 702 is displayed with height 722a of first value H_{1-c} and width 722b of first value W_{1-c}. For example, a portion 750a of three-dimensional environment 700 is visible (e.g., via display generation component 120) when representation 702 is displayed with the size shown in FIG. 7N (e.g., portion 750a does not include the portion of three-dimensional environment 700 that is overlapped by representation 702 from the current viewpoint of the user of computer system 101).

In FIG. 7N, representation 702 is displayed within the representation of the physical environment with a simulated lighting effect 748. In some embodiments, simulated lighting effect 748 has one or more characteristics of simulated lighting effects 704 and 738a-738b described above, and/or one or more characteristics of the simulated lighting effect described with reference to method 800. As shown in FIG. 7N, simulated lighting effect 748 is displayed on a surface of table 756b. In some embodiments, the surface of table 756b is a real-world surface (e.g., a representation of a real-world surface) and optionally different from a virtual surface that is computer-generated and/or displayed by display generation component 120 (e.g., such as virtual surfaces 764a-764b). In some embodiments, simulated lighting effect 748 is displayed to simulate reflection of light and/or color (e.g., as if emanating from representation 702) off of the surface of table 756b. As shown in FIG. 7N (e.g., by the fill pattern of representation 702 and simulated lighting effect 748), simulated lighting effect 748 is displayed with one or more visual effects corresponding to a visual appearance of representation 702 (e.g., content of the media that is played back in three-dimensional environment 700). In some embodiments, as a visual appearance of the content of the media changes (e.g., as the media is played back in three-dimensional environment 700), computer system 101 changes the one or more visual effects of the simulated lighting effect 748.

FIG. 7O illustrates computer system 101 displaying representation 702 with a different size in the representation of the physical environment (compared to the size of representation 702 shown in FIG. 7N) in response to a change in the current playback location of the media (e.g., based on playback of the media in three-dimensional environment 700). As shown in FIG. 7O, the current playback location (as represented by playback indicator representation 708b) is within second portion 710b of the media corresponding to aspect ratio 712b. In response to detecting the change in the current playback location to the second portion 710b of the media, computer system 101 changes width 722b to second value W_{2-c}(e.g., different from first value W_{1-c}) without changing height 722a (e.g., maintaining value H_{1-c}). In some embodiments, computer system 101 displays an animation of representation 702 gradually changing size relative to three-dimensional environment 700 when the current playback location of the media changes to within second portion 710b until representation 702 is displayed with a size corresponding to aspect ratio 712b (e.g., width 722b of representation 702 expands over a period of time (e.g., 1, 2, 5, 10, 15, 20, 25, 30, or 60 seconds)). In some embodiments, displaying representation 702 with height 722a of first value H_{1-c} and width 722b of second value W_{2-c} corresponds to aspect ratio 712b (e.g., such that the media is not displayed with one or more artifacts in three-dimensional environment 700). In some embodiments, changing width 722b of representation 702 to second value W_{2-c} includes expanding width 722b from the center of representation 702 (e.g., in first direction 732a and second direction 732b). In some embodiments, computer system 101 expands width 722b of representation 702 symmetrically (e.g., by the same amount in first direction 732a and second direction 732b). In some embodiments, computer system 101 does not expand width 722b of representation 702 symmetrically (e.g., computer system 101 expands width 722b of representation by different amounts in first direction 732a and second direction 732b). In some embodiments, changing width 722b of representation 702 causes a different portion of the representation of the physical environment (e.g., including a portion of virtual window 752a, a portion of virtual window 752b, and a portion of real-world window 756a) to be overlapped by representation 702 (e.g., from the current viewpoint of the user of computer system 101). For example, as shown in FIG. 7O, a different portion of three-dimensional environment 700 (portion 750b) is visible based on the change in width 722b of representation 702 (e.g., a difference between portion 750b and portion 750a (e.g., shown in FIG. 7N) of three-dimensional environment 700 corresponds to a difference between the size of representation 702 in FIG. 7N and representation 702 in FIG. 7O). In some embodiments, as shown in FIG. 7O, computer system 101 changes a size (e.g., width) of simulated lighting effect 748 on the surface of table 756b corresponding to the changed size of representation 702 when changing width 722b of representation 702.

FIG. 7P illustrates computer system 101 displaying representation 702 with a different size in the representation of the physical environment (compared to the size of representation 702 shown in FIG. 7O) in response to a change in the current playback location of the media (e.g., based on playback of the media in three-dimensional environment 700). As shown in FIG. 7P, the current playback location (as represented by playback indicator representation 708b) is within third portion 710c of the media corresponding to aspect ratio 712c. In response to detecting the change in the current playback location to the third portion 710c of the media, computer system 101 changes width 722b to third value W_{3-c} (e.g., different from second value W_{2-c}) without changing height 722a (e.g., maintaining first value H_{1-c}). In some embodiments, computer system 101 displays an animation of representation 702 gradually changing size relative to three-dimensional environment 700 when the current playback location of the media changes to within third portion 710c until representation 702 is displayed with a size corresponding to aspect ratio 712c (e.g., width 722b of representation 702 expands over a period of time (e.g., 1, 2, 5, 10, 15, 20, 25, 30, or 60 seconds)). In some embodiments, displaying representation 702 with height 722a of first value H_{1-c} and width 722b of third value W_{3-c} corresponds to aspect ratio 712b (e.g., such that the media is not displayed with one or more artifacts in three-dimensional environment 700). In some embodiments, changing width 722b of representation 702 to third value W_{3-c} includes expanding width 722b from the center of representation 702 (e.g., in first direction 732a and second direction 732b). In some embodiments, computer system 101 expands width 722b of representation 702 symmetrically (e.g., by the same amount in first direction 732a and second direction 732b). In some embodiments, computer system 101 does not expand width 722b of representation 702 symmetrically (e.g., computer system 101 expands width 722b of representation by different amounts in first direction 732a and second direction 732b). In some embodiments, changing width 722b of representation 702 causes a different portion of the representation of the physical environment (e.g., including a portion of virtual window 752a, a portion of virtual window 752b, and a portion of real-world window 756a) to be overlapped by representation 702 (e.g., from the current viewpoint of the user of computer system 101). For example, as shown in FIG. 7P, a different portion of three-dimensional environment 700 (portion 750c) is visible based on the change in width 722b of representation 702 (e.g., a difference between portion 750c and portion 750b (e.g., shown in FIG. 7O) of three-dimensional environment 700 corresponds to a difference between the size of representation 702 in FIG. 7O and representation 702 in FIG. 7P). In some embodiments, as shown in FIG. 7P, computer system 101 changes a size (e.g., width) of simulated lighting effect 748 on the surface of table 756b corresponding to the changed size of representation 702 when changing width 722b of representation 702.

In FIG. 7P, computer system 101 detects a user input corresponding to a request to navigate through the media. For example, the user input corresponding to the request to navigate through the media has one or more characteristics of the user input shown and described with reference to FIG. 7G. In response to the user input shown in FIG. 7P, computer system 101 changes the current playback location (e.g., represented by playback indicator representation 708b) in FIG. 7Q. As shown in FIG. 7Q, the current playback location of the media is within first portion 710a of the media corresponding to aspect ratio 712a. In accordance with a determination that the navigation of the media includes a change to aspect ratio 712a (e.g., from aspect ratio 712c shown in FIG. 7P), computer system 101 changes a size of representation 702 to correspond to aspect ratio 712a by reducing width 722b to first value W_{1-c} (e.g., from third value W_{3-c}, different from first value W_{1-c}, shown in FIG. 7P). In some embodiments, computer system 101 displays an animation of representation 702 gradually changing size relative to three-dimensional environment 700 while and/or after the user input is performed (e.g., computer system 101 changes height 722a over a period of time (e.g., 1, 2, 5, 10, 20, 25, 30, or 60 seconds) during and/or after detecting the user input). In some embodiments, computer system 101 reduces height 722a of representation 702 within 0.1, 0.2, 0.5, 1, 2, or 5 seconds of the user changing the playback location of the media to within first portion 710a (e.g., computer system 101 changes the size of representation immediately upon the user changing the playback location of the media to within first portion 710a). As shown in FIG. 7Q, reducing width 722b to first value W_{1-c} includes decreasing width 722b in first direction 732a and second direction 732b (e.g., toward the center of representation 702) without changing height 722a (e.g., height 722a is displayed with first value H_{1-c}). In some embodiments, computer system 101 reduces width 722b of representation 702 symmetrically (e.g., by the same amount in first direction 732a and second direction 732b). In some embodiments, computer system 101 does not reduce width 722b of representation 702 symmetrically (e.g., computer system 101 reduces width 722b of representation by different amounts in first direction 732a and second direction 732b). As shown in FIG. 7Q, a different portion of the representation of the physical environment is overlapped (e.g., from the current viewpoint of the user of computer system 101) compared to as shown in FIG. 7P. For example, a different portion of three-dimensional environment 700 (portion 750a) is visible based on the change in width 722b of representation 702. In some embodiments, computer system 101 changes a size of simulated lighting effect 748 in three-dimensional environment 700 corresponding to the changed size of representation 702.

FIG. 8 is a flowchart illustrating an example method 800 of changing a size of a representation of respective media in a three-dimensional environment in response to detecting a change in playback location of the respective media. In some embodiments, the method 800 is performed at a computer system (e.g., computer system 101 in FIG. 1 such as a tablet, smartphone, wearable computer, or head mounted device) including a display generation component (e.g., display generation component 120 in FIGS. 1, 3, and 4) (e.g., a heads-up display, a display, a touchscreen, and/or a projector) and one or more cameras (e.g., a camera (e.g., color sensors, infrared sensors, and other depth-sensing cameras) that points downward at a user's hand or a camera that points forward from the user's head). In some embodiments, the method 800 is governed by instructions that are stored in a non-transitory computer-readable storage medium and that are executed by one or more processors of a computer system, such as the one or more processors 202 of computer system 101 (e.g., control unit 110 in FIG. 1A). Some operations in method 800 are, optionally, combined and/or the order of some operations is, optionally, changed.

In some embodiments, method 800 is performed at a computer system (e.g., computer system 101) in communication with a display generation component (e.g., display generation component 120) and one or more input devices (e.g., image sensors 114a-114c). In some embodiments, the computer system is or includes an electronic device, such as a mobile device (e.g., a tablet, a smartphone, a media player, or a wearable device), or a computer. In some embodiments, the display generation component is a display integrated with the electronic device (optionally a touch screen display), external display such as a monitor, projector, television, or a hardware component (optionally integrated or external) for projecting a user interface or causing a user interface to be visible to one or more users. In some embodiments, the one or more input devices include an electronic device or component capable of receiving a user input (e.g., capturing a user input or detecting a user input) and transmitting information associated with the user input to the electronic device. Examples of input devices include an image sensor (e.g., a camera), location sensor, hand tracking sensor, eye-tracking sensor, motion sensor (e.g., hand motion sensor) orientation sensor, microphone (and/or other audio sensors), touch screen (optionally integrated or external), remote control device (e.g., external), another mobile device (e.g., separate from the electronic device), a handheld device (e.g., external), and/or a controller.

In some embodiments, while displaying a representation of respective media in a three-dimensional environment with a first size relative to the three-dimensional environment, wherein the representation of the respective media overlaps a first portion of the three-dimensional environment from a current viewpoint of a user of the computer system, the computer system detects (802a) a change in a current playback location of the respective media (e.g., based on the media playing through different portions of the media and/or based on a user selecting a different current playback location), such as the change in the current playback location (e.g., represented by playback indicator representation 708b) shown in FIG. 7E (e.g., compared to the current playback location shown in FIG. 7D). In some embodiments, the representation of the respective media is a virtual object (e.g., a virtual window and/or container) that includes the respective media. In some embodiments, the respective media includes video content (e.g., such as a movie and/or television show from a streaming service application, and/or an online video from a video sharing service or social media application). In some embodiments, the first size includes a first value along a first axis in the three-dimensional environment (e.g., a width of the representation of the respective media relative to the three-dimensional environment) and a second value along a second axis in the three-dimensional environment that is orthogonal to the first axis (e.g., a height of the representation of the respective media relative to the three-dimensional environment). In some embodiments, a respective size of the representation of the respective media corresponds to a respective aspect ratio of the respective media (e.g., a relationship between a first dimension (e.g., width) and a second dimension (e.g., height), different from the first dimension, of the respective media). For example, a first dimension of the representation (e.g., along the first axis) of the respective media corresponds to a first dimension of the respective media (e.g., a width of the respective media). For example, the second dimension of the representation (e.g., along the second axis) of the respective media corresponds to a second dimension of the respective media (e.g., a height of the respective media). In some embodiments, the respective media includes an aspect ratio of 0.46:1 (6:13) (e.g., 0.46), 1:1, 1.3:1 (4:3), 1.375:1 (11:8), 1.43:1, 1.55:1 (14:9), 1.6:1 (16:10), 1.66:1 (5:3), 1.77:1 (16:9), 1.85:1, 1.90:1, 2:1, 2.2:1, 2.37:1 (21:9), 2.35:1, 2.39:1, or 2.4:1 (12:5). In some embodiments, the respective media includes video content that includes portions with different aspect ratios (e.g., the aspect ratio of the respective media changes when transitioning from a first portion of the video content (e.g., including a first aspect ratio) to a second portion of the video content (e.g., including a second aspect ratio different from the first aspect ratio)). In some embodiments, detecting the change in the current playback location of the respective media includes detecting a change in the aspect ratio of the respective media. For example, the playback location of the respective media changes from a first playback location (e.g., including a first aspect ratio) to a second playback location (e.g., including a second aspect ratio, different from the first aspect ratio) of the respective media. In some embodiments, the first portion of the three-dimensional environment that is overlapped by the representation of the respective media corresponds to the first size of the representation of the respective media from the current viewpoint of the user of the computer system. In some embodiments, the representation of the respective media is a first distance from a location corresponding to the current viewpoint of the user in the three-dimensional environment, and the first portion of the three-dimensional environment is a second distance, greater than the first distance, from the location corresponding to the current viewpoint of the user in the three-dimensional environment (e.g., the first portion of the three-dimensional environment is not visible from the current viewpoint of the user (e.g., because the first portion of the three-dimensional environment is obscured by the representation associated with the respective media from the current viewpoint of the user)). In some embodiments, the first portion of the three-dimensional environment includes one or more objects (e.g., one or more objects of the physical environment of the user (e.g., visible through passthrough) and/or one or more virtual objects (e.g., generated and/or displayed by the display generation component)).

In some embodiments, in response to detecting the change in the current playback location of the respective media, the computer system displays (802b) the representation of the respective media with a second size relative to the three-dimensional environment such that the representation of the respective media overlaps a second portion of the three-dimensional environment from the current viewpoint of the user, different from the first portion of the three-dimensional environment (e.g., the first portion has a different size and/or shape than a size and/or shape of the second portion), such as displaying representation 702 with the changed width 722b in FIG. 7E such that a different portion of environment 700 (portion 720c) is visible from the current viewpoint of the user (e.g., compared to portion 720b of environment 700 that is visible from the current viewpoint of the user in FIG. 7D). In some embodiments, the current viewpoint of the user does not change between displaying the representation of the respective media with the first size and displaying the representation of the respective media with the second size (e.g., detecting the change in the one or more dimensions of the respective media does not include detecting a change in the current viewpoint of the user). In some embodiments, displaying the representation of the respective media with the second size includes changing the size of the representation of the respective media from the first size to the second size relative to the three-dimensional environment. For example, changing the size of the representation of the respective media includes changing the first dimension (e.g., width) of the representation of the respective media from the first value to a third value, different from the first value, along the first axis in the three-dimensional environment, and/or the second dimension (e.g., height) of the representation of the respective media from the second value to a fourth value, different from the second value, along the second axis in the three-dimensional environment (e.g., the second size of the representation of the respective media includes a first dimension of the third value and a second dimension of the fourth value). In some embodiments, changing the size of the representation of the respective media includes changing a first dimension (e.g., width or height) of the representation of the respective media and not changing a second dimension, different from the first dimension, (e.g., and optionally a third dimension, different from the first dimension and the second dimension) of the representation of the respective media. For example, changing the size of the representation of the respective media includes changing the width of the representation of the respective media and not the height of the representation of the respective media. For example, changing the size of the representation of the respective media includes changing the height of the representation of the respective media and not the width of the representation of the respective media. In some embodiments, changing the size of the representation of the respective media from the first size to the second size relative to the three-dimensional environment includes changing the size of the representation of the respective media while the respective media is played back in the three-dimensional environment (e.g., while the respective media continues to be played back in the three-dimensional environment). In some embodiments, the size of the representation of the respective media is changed relative to the three-dimensional environment over a period of time (e.g., gradually). For example, a respective dimension of the representation of the respective media is changed over 0.01, 0.05, 0.1, 0.2, 0.5, 1, 2, 5 or 10 seconds. In some embodiments, a respective dimension of the representation of the respective media is changed in less than 0.01, 0.02, 0.1, 0.2, 0.5 or 1 second (e.g., the computer system does not display a transition (e.g., a gradual change) of the representation of the respective media changing in size relative to the three-dimensional environment (e.g., the size of the representation of the respective media changes instantaneously)). In some embodiments, the change in size of the representation of the respective media corresponds to a change in aspect ratio of the respective media. For example, the first size of the representation of the respective media corresponds to a first aspect ratio of the respective media, and the second size of the representation of the respective media corresponds to a second aspect ratio of the respective media. In some embodiments, displaying the representation of the respective media with the second size relative to the three-dimensional environment includes displaying the representation of the respective media with the same display size as displaying the representation of the respective media with the first size relative to the three-dimensional environment (e.g., the representation of the respective media is displayed at a different location in the three-dimensional environment to maintain the same display size relative to the viewpoint of the user). In some embodiments, displaying the representation of the respective media with the second size relative to the three-dimensional environment includes displaying the representation of the respective media with a different (e.g., larger or smaller) display size than displaying the representation of the respective media with the first size relative to the three-dimensional environment (e.g., the representation of the respective media is displayed at the same location in the three-dimensional environment). In some embodiments, the second portion of the three-dimensional environment that is overlapped by the representation of the respective media corresponds to the second size of the representation of the respective media from the current viewpoint of the user of the computer system. In some embodiments, the second portion of the three-dimensional environment has one or more characteristics of the first portion of the three-dimensional environment described above. For example, the second portion of the three-dimensional environment includes one or more objects (e.g., one or more virtual objects) and is a greater distance in the three-dimensional environment from the current viewpoint of the user than the representation of the respective media. In some embodiments, the second portion of the three-dimensional environment is larger than the first portion of the three-dimensional environment (e.g., and the second size of the representation of the respective media is larger than the first size of the representation of the respective media). In some embodiments, the first portion of the three-dimensional environment is larger than the second portion of the three-dimensional environment (e.g., and the first size of the representation of the respective media is larger than the second size of the representation of the respective media). In some embodiments, the first portion of the three-dimensional environment is included within the second portion of the three-dimensional environment (e.g., the first portion of the three-dimensional environment is also overlapped by the representation of the respective media (e.g., from the current viewpoint of the user) when the representation of the respective media is the second size). In some embodiments, the second portion of the three-dimensional environment is included within the first portion of the three-dimensional environment (e.g., the second portion of the three-dimensional environment is also overlapped by the representation of the respective media (e.g., from the current viewpoint of the user) when the representation of the respective media is the first size). In some embodiments, in accordance with a determination that the change in current playback location does not correspond to a change in aspect ratio of the respective media, the computer system maintains display of the representation of the respective media with the first size (e.g., such that the representation of the respective media continues to overlap the first portion of the three-dimensional environment (e.g., and optionally such that the representation of the respective media does not overlap the second portion of the three-dimensional environment)). Changing a size of a representation of respective media in a three-dimensional environment such that a portion of the three-dimensional environment that the representation overlaps changes in response to a change in playback location of the respective media maintains a consistent position of the representation in the three-dimensional environment when one or more dimensions (e.g., an aspect ratio) of the respective media change and prevents the need for user input to change the representation and/or the three-dimensional environment to accommodate a change in one or more dimensions of the respective media, thereby improving user device interaction and conserving computing resources associated with user inputs to change the representation.

In some embodiments, the detected change in the current playback location of the respective media occurs during playback of the respective media (e.g., without a specific user input directed to the representation of the media that causes the media to change its playback location), as shown by the playback of the media (e.g., represented by playback indicator representation 708b) from FIG. 7D to FIG. 7E. In some embodiments, the representation of the respective media changes size (e.g., from the first size to the second size) automatically while the respective media is played back in the three-dimensional environment (e.g., without a user input corresponding to a request to change the size and/or playback position of the respective media). For example, after playback of the respective media is initiated in the three-dimensional environment (e.g., through selection of one or more playback controls, or by selecting the respective media (e.g., an icon or representation) in a user interface of an application), the playback location of the respective media changes from a first portion of the respective media including a first aspect ratio to a second portion of the respective media, different from the first portion of the respective media, including a second aspect ratio, different from the first aspect ratio. In some embodiments, the computer system changes the size of the representation of the respective media in response to the change of the playback location from the first portion to the second portion of the respective media (e.g., in response to the change in the aspect ratio of the respective media). For example, the respective media is video content (e.g., a movie) including a first scene with a first aspect ratio and a second scene, different from the first scene, with a second aspect ratio, different from the first aspect ratio (e.g., the computer system detects the change in aspect ratio from the first aspect ratio to the second aspect ratio as the current playback location of the respective media changes from the first scene to the second scene). In some embodiments, the three-dimensional environment includes one or more playback controls for controlling playback of the respective media. For example, the playback controls are displayed adjacent to the representation of the respective media (e.g., in a virtual object). For example, the playback controls are displayed within the representation of the respective media. In some embodiments, the respective media plays back in the three-dimensional environment in response to user input (e.g., corresponding to selection of a playback control of the one or more playback controls displayed in the three-dimensional environment). Changing a size of a representation of respective media in a three-dimensional environment in response to a change in playback location of the respective media and without user input maintains a consistent position of the representation in the three-dimensional environment when one or more dimensions of the respective media change and prevents the need for user input to change the representation and/or the three-dimensional environment to accommodate a change in one or more dimensions of the respective media, thereby improving user device interaction and conserving computing resources associated with user inputs to change the representation.

In some embodiments, the detected change in the current playback location of the respective media is in response to a user input corresponding to changing the current playback location of the respective media (e.g., based on user input directed to a scrubbing control for the media), such as the change in the playback location of the media in FIG. 7H that occurs in response to the user input (e.g., gaze 726 with an air gesture from hand 724) corresponding to the request to navigate through the media shown in FIG. 7G. In some embodiments, the respective media is played back in the three-dimensional environment while the user input is detected by the computer system. In some embodiments, the respective media is not played back (e.g., is paused) in the three-dimensional environment while the user input is detected by the computer system. In some embodiments, the user input corresponding to navigation through the respective media includes selection of one or more playback controls displayed in the three-dimensional environment (e.g., having one or more characteristics of the one or more playback controls described above). In some embodiments, the user input includes a user of the computer system directing attention (e.g., based on gaze, cursor, and/or hand position) toward a selectable option (e.g., a playback control, such as a scrub icon) while concurrently performing a respective air gesture (e.g., an air tap, air drag, air pinch, or air long pinch (e.g., an air pinch for a threshold amount of time, such as 0.1, 0.2, 0.5, 1, 2, 5 or 10 seconds)). For example, the user input includes gaze directed at a playback location indicator displayed on a playback progress bar (e.g., displayed within the representation of the respective media) and hand movement (e.g., while performing an air gesture, such as an air pinch of a thumb and a finger) in a direction corresponding to a desired playback location on the playback progress bar (e.g., a first direction corresponds to scrubbing forward (e.g., to a later portion of the respective media), and a second direction, different from the first direction, corresponds to scrubbing backwards (e.g., to an earlier portion of the respective media)). In some embodiments, the user input includes an input on a touch-sensitive surface (e.g., a touchpad) of (e.g., and/or in communication with) the computer system and/or a verbal input (e.g., a voice command). In some embodiments, the current playback location of the respective media is changed based on a magnitude and/or direction of movement of the user input. For example, in accordance with a determination that the user input includes a first magnitude and/or direction of movement (e.g., of a hand of the user (e.g., optionally while performing an air gesture)), the current playback location of the respective media is changed to within a first portion of the respective media, the first portion of the respective media including a first aspect ratio, and in accordance with a determination that the user input includes a second magnitude and/or direction of movement, different from the first magnitude and/or direction of movement, the current playback location of the respective media is changed to within a second portion of the respective media, different from the first portion of the respective media, the second portion of the respective media including a second aspect ratio (e.g., optionally different from the first aspect ratio). For example, the representation of the respective media is displayed with a respective size relative to the three-dimensional environment corresponding to the first aspect ratio when the current playback location of the respective media is within the first portion of the respective media, and the representation of the respective media is displayed with a respective size relative to the three-dimensional environment corresponding to the second aspect ratio when the current playback location of the respective media is within the second portion of the respective media (e.g., the representation of the respective media is displayed with a different size relative to the three-dimensional environment when the current playback location is within the first portion of the respective media than when the current playback location is within the second portion of the respective media (e.g., because the first aspect ratio of the first portion of the respective media is different from the second aspect ratio of the second portion of the respective media)). In some embodiments, in accordance with a determination the user input corresponding to navigation through the respective media is not detected by the computer system, the computer system maintains the current playback location of the respective media (e.g., the respective media is not played back in the three-dimensional environment when the user input corresponding to navigation through the respective media is detected). In some embodiments, the respective media is video content includes a first scene including a first aspect ratio and a second scene, different from the first scene, including a second aspect ratio, different from the first aspect ratio (e.g., as described above). For example, the user input corresponds to changing the current playback location of the respective media from a first playback location of the first scene to a second playback location, different from the first playback location, of the second scene. In some embodiments, while detecting the user input corresponding to changing the current playback location of the respective media, the computer system changes a size of the representation of the respective media (e.g., prior to detecting termination of the user input). For example, while navigating from a first playback location including a first aspect ratio to a second playback location, different from the first playback location, including a second aspect ratio, different from the first aspect ratio, the current playback location passes a third playback location, different from the first playback location and the second playback location, including a third aspect ratio (e.g., different from the first aspect ratio and the second aspect ratio). For example, the computer system changes a size of the representation of the respective media to a third size, different from the first size and the second size, corresponding to the third aspect ratio of the respective media (e.g., while detecting the user input and prior to changing the representation of the respective media to the second size). Changing a size of a representation of respective media in a three-dimensional environment in response to a user input corresponding to navigation through respective media maintains a consistent position of the representation in the three-dimensional environment when one or more dimensions of the respective media change and prevents the need for user input to change the representation and/or the three-dimensional environment to accommodate a change in one or more dimensions of the respective media, thereby improving user device interaction and conserving computing resources associated with user inputs to change the representation.

In some embodiments, displaying the representation of the respective media with the first size relative to the three-dimensional environment includes displaying the representation of the respective media with a first aspect ratio, such as displaying representation 702 with a size corresponding to aspect ratio 712a in FIG. 7D. In some embodiments, displaying the representation of the respective media with the second size relative to the three-dimensional environment includes displaying the representation of the respective media with a second aspect ratio, different from the first aspect ratio, such as displaying representation 702 with a size corresponding to aspect ratio 712b in FIG. 7E. In some embodiments, the aspect ratio of the respective media refers to a ratio of the length (e.g., width) of the representation of the respective media to the height of the representation of the respective media (e.g., the aspect ratio is optionally expressed as a number (e.g., corresponding to the ratio of the width to the height of the representation of the respective media). For example, one or more aspect ratios (e.g., the first aspect ratio and/or second aspect ratio) of the respective media include 4:3 (e.g., 1.33), 16:9 (e.g., 1.77), 1.85:1 (e.g., 1.85), 1.90:1 (e.g., 1.9), 2:1 (e.g., 2.0), 21:9 (e.g., 2.33), 2.35:1 (e.g., 2.35), 2.39:1 (e.g., 2.39), or 12:5 (e.g., 2.4). In some embodiments, the aspect ratio of the respective media changes while the respective media is played back in the three-dimensional environment. For example, the respective media includes one or more portions with different aspect ratios. In some embodiments, the aspect ratio of the respective media changes automatically without user input (e.g., the change in the aspect ratio is caused by the playback of the respective media to a portion of the respective media that includes a different aspect ratio). In some embodiments, the aspect ratio of the respective media changes in response to user input (e.g., in response to a user input corresponding to navigation through the respective media as described above). In some embodiments, the respective media changes from a first media including a first aspect ratio to a second media (e.g., different from the first media) including a second aspect ratio, different from the first aspect ratio. For example, the first media corresponds to a first portion of the respective media (e.g., a first scene of a movie) that includes a first aspect ratio, and the second media corresponds to a second portion of the respective media, different from the first portion of the respective media, (e.g., a second scene of a movie) that includes a second aspect ratio different from the first aspect ratio. In some embodiments, the user of the computer system changes the respective media from first media including a first aspect ratio to second media including a second aspect ratio, different from the first aspect ratio, through a user input (e.g., through selection of content in a respective application). In some embodiments, multiple versions of the respective media are accessible to a user of the computer system, and the multiple versions of the respective media include different aspect ratios. For example, the aspect ratio of the respective media changes in response to a user input corresponding to selection of a respective version of the respective media (e.g., the respective version of the respective media has a different aspect ratio from a current version of the respective media that is displayed (e.g., within the representation of the respective media) in the three-dimensional environment). In some embodiments, the respective media continues to be played back in the three-dimensional environment during the change in the aspect ratio of the respective media (e.g., the respective media continues to be played back in the three-dimensional environment while the representation of the respective media transitions from the first size to the second size). Changing a size of a representation of respective media in a three-dimensional environment when a current playback location of the respective media includes a different aspect ratio maintains a consistent position of the representation in the three-dimensional environment when the aspect ratio of the respective media changes and prevents the need for user input to change the representation and/or the three-dimensional environment to accommodate the change in the aspect ratio of the respective media, thereby improving user device interaction and conserving computing resources associated with user inputs to change the representation.

In some embodiments, detecting the change in a current playback location of the respective media includes detecting a change in the aspect ratio of the respective media from information (e.g., metadata) associated with the respective media, such as if computer system 101 detected the change from aspect ratio 712a to aspect ratio 712b in FIGS. 7D-7E from information associated with the media. In some embodiments, the computer system detects the change in the aspect ratio of the respective media from metadata associated with the respective media (e.g., the metadata is embedded in a media file of the respective media) without user input (e.g., automatically). In some embodiments, the change in the aspect ratio of the respective media occurs based on information received from a source external to the computer system. For example, the computer system is in communication with an external server associated with the respective media, and the change in the aspect ratio of the respective media is detected by the computer system based on information (e.g., metadata) received from the external server. In some embodiments, in accordance with a determination that first information associated with the respective media is detected, the representation of the respective media is displayed with the first size in the three-dimensional environment (e.g., the first information is associated with a first aspect ratio of the respective media). In some embodiments, in accordance with a determination that second information, different from the first information, associated with the respective media is detected, the representation of the respective media is displayed with the second size in the three-dimensional environment (e.g., the first information is associated with a second aspect ratio, different from the first aspect ratio, of the respective media). In some embodiments, the information (e.g., metadata) is embedded in data that is used by the computer system to playback the respective media in the three-dimensional environment. For example, the computer system parses the data that is used to playback the respective media to detect metadata corresponding to a change in the aspect ratio of the respective media. Changing a size of a representation of respective media in a three-dimensional environment when detecting a change in the aspect ratio from information (e.g., metadata) associated with the respective media maintains a consistent position of the representation when the change in aspect ratio is detected (e.g., efficiently by detecting the change in aspect ratio through metadata associated with the respective media) and prevents the need for user input to change the representation and/or the three-dimensional environment to accommodate the change in the aspect ratio of the respective media, thereby conserving computing resources associated with user inputs (e.g., to change the representation) and memory and/or processing resources by preventing the need to parse a separate data source from the information associated with the respective media.

In some embodiments, detecting the change in the current playback location of the respective media includes, in accordance with a determination that the respective media includes first content at the changed current playback location, such as the content associated with second portion 710b of the media shown in FIG. 7E (e.g., different from the content associated with first portion 710a), detecting a first change in the aspect ratio of the respective media, such as the change to aspect ratio 712b shown in FIG. 7E. In some embodiments, the computer system detects the first content of the respective media from information (e.g., metadata) associated with the respective media (e.g., as described above). In some embodiments, the computer system detects that the first content at the changed playback location will be displayed in the three-dimensional environment with one or more artifacts (e.g., because of the first change in the aspect ratio of the respective media). In some embodiments, in accordance with a determination that the first content at the changed playback location will be displayed in the three-dimensional environment with the one or more artifacts, the computer system changes the display of the representation of the respective media from the first size relative to the three-dimensional environment to the second size relative to the three-dimensional environment (e.g., to prevent the respective media from being displayed with the one or more artifacts). In some embodiments, the first content includes letter-boxing (e.g., the first content includes empty space (e.g., a matted black region) above and below a video associated with the respective media). In some embodiments, the first content includes pillar-boxing (e.g., the first content includes empty space (e.g., a matted black region) to either side of a video associated with the respective media). In some embodiments, the first content includes window-boxing (e.g., the first content includes empty space (e.g., a matted black region) above, below, and to either side of a video associated with the respective media). In some embodiments, the computer system does not display the respective media (e.g., within the representation of the respective media) in the three-dimensional environment with letter-boxing, pillar-boxing and/or window-boxing. For example, the computer system removes the letter-boxing, pillar-boxing, and/or window-boxing from the respective media. For example, in response to detecting letter-boxing, pillar-boxing, and/or window-boxing, the computer system changes one or more dimensions (e.g., changes a size) of the representation of the respective media in the three-dimensional environment (e.g., to prevent the respective media from being displayed with letter-boxing, pillar-boxing, and/or window-boxing).

In some embodiments, detecting the change in the current playback location of the respective media includes, in accordance with a determination that the respective media includes second content, different from the first content, at the changed current playback location, such as the content associated with third portion 710c of the media shown in FIG. 7F (e.g., different from the content associated with first portion 710a), detecting a second change in the aspect ratio, different from the first change in the aspect ratio, such as the change to aspect ratio 712c shown in FIG. 7F. In some embodiments, the first content has one or more characteristics of the second content. For example, the second content includes one or more artifacts (e.g., different from the one or more artifacts of the first content) and/or empty space (e.g., the first content includes pillar-boxing, and the second content includes letter-boxing, or the first content does not include letter-boxing, pillar-boxing and/or window-boxing, and the second content does include letter-boxing, pillar-boxing and/or window-boxing). In some embodiments, the computer system does not display the respective media (e.g., within the representation of the respective media) with the one or more artifacts and/or with letter-boxing, pillar-boxing, and/or window-boxing (e.g., as described with reference to the first content). In some embodiments, the first content corresponds to a first playback location of the respective media and the second content corresponds to a second playback location, different from the first playback location, of the respective media. In some embodiments, displaying the representation of the respective media with the second size relative to the three-dimensional environment includes, in accordance with a determination that the current playback location is changed to the first playback location including the first content, displaying the representation of the respective media with one or more first dimensions in the three-dimensional environment. In some embodiments, displaying the representation of the respective media with the second size relative to the three-dimensional environment includes, in accordance with a determination that the current playback location is changed to the second playback location including the second content, displaying the representation of the respective media with one or more second dimensions, different from the one or more first dimensions, in the three-dimensional environment. Changing a size of a representation of respective media in a three-dimensional environment when detecting a change in the aspect ratio from content of the respective media maintains consistent position of the representation when the change in aspect ratio is detected (e.g., efficiently by detecting the change in aspect ratio from the content of the respective media) and prevents the need for user input to change the representation and/or the three-dimensional environment to accommodate the change in the aspect ratio of the respective media, thereby improving user device interaction and conserving computing resources associated with user inputs to change the representation.

In some embodiments, the first portion of the three-dimensional environment includes a representation of a physical environment of the user, such as the representation of the physical environment of the user of computer system 101 visible in three-dimensional environment 700 in FIGS. 7N-7Q. In some embodiments, the three-dimensional environment is an augmented reality environment that displays one or more virtual objects onto the representation of the physical environment (e.g., the computer system superimposes one or more virtual objects onto a real-world environment of the user). In some embodiments, the representation of the physical environment includes one or more first representations of objects (e.g., visible to the user of the computer system through passthrough) of the physical environment of the user (e.g., the one or more first representations are displayed via the display generation component, or are passively visible via a transparent or translucent display of the computer system (e.g., when not overlapped by the representation of the respective media from the viewpoint of the user)). For example, the one or more first representations correspond to real-world objects of a physical space where the user is located, such as furniture, windows, doors and/or walls. In some embodiments, the second portion of the three-dimensional environment includes the representation of the physical environment. For example, the first portion of the three-dimensional environment includes a first region of the representation of the physical environment, and the second portion of the three-dimensional environment includes a second region of the representation of the physical environment, different from the first region of the representation of the physical environment. For example, the second region of the representation of the physical environment includes one or more second representations of objects of the physical environment of the user (e.g., optionally different from the one or more first representation of objects of the physical environment). In some embodiments, the representation of the respective media overlaps (e.g., from the current viewpoint of the user) the one or more first representations of the objects of the physical environment when the representation of the respective media is displayed with the first size relative to the three-dimensional environment. In some embodiments, the representation of the respective media overlaps (e.g., from the current viewpoint of the user) the one or more second representations of the objects of the physical environment when the representation of the respective media is displayed with the second size relative to the three-dimensional environment. In some embodiments, the first region of the representation of the physical environment of the user is included within the second region of the representation of the physical environment of the user (e.g., the second region is larger than the first region (e.g., because the second size of the representation of the respective media is larger than the first size of the representation of the respective media)). In some embodiments, the second region of the representation of the physical environment of the user is included within the first region of the representation of the physical environment of the user (e.g., the first region is larger than the second region (e.g., because the first size of the representation of the respective media is larger than the second size of the representation of the respective media)). Changing a size of a representation of respective media in a three-dimensional environment such that a portion of a representation of a physical environment of a user (e.g., included within the three-dimensional environment) that is overlapped by the representation of the respective media changes maintains a consistent position of the representation of the respective media relative to the representation of the physical environment when one or more dimensions (e.g., an aspect ratio) of the respective media change and prevents the need for user input to change the representation of the respective media or the representation of the physical environment to accommodate a change in one or more dimensions of the respective media, thereby improving user device interaction and conserving computing resources associated with user inputs to change the representation of the respective media.

In some embodiments, the first portion of the three-dimensional environment includes a representation of a virtual environment, such as the representation of the virtual environment visible in three-dimensional environment 700 in FIGS. 7A-7H (or the representation of the virtual environment visible in three-dimensional environment 700 in FIGS. 7I-7M). In some embodiments, the representation of the virtual environment includes one or more virtual objects displayed by the display generation component (e.g., the one or more virtual objects include one or more content windows (e.g., a user interface of an application accessible to the user through the computer system)). In some embodiments, the virtual environment is displayed (e.g., via the display generation component) within the three-dimensional environment, optionally instead of the representations of the physical environment of the user of the computer system (e.g., full immersion) or optionally concurrently with the representation of the physical environment (e.g., partial immersion). Some examples of a virtual environment include a lake environment, a mountain environment, a sunset scene, a sunrise scene, a nighttime environment, a grassland environment, and/or a concert scene. In some embodiments, a virtual environment is based on a real physical location, such as a museum, an aquarium and/or a geographical landmark (e.g., Mount Hood). In some embodiments, the virtual environment is a virtual environment for displaying media with a simulated lighting effect (e.g., as described below). For example, the virtual environment is a representation of a cinema environment and/or a theater. For example, the virtual environment is dark (e.g., including empty space) surrounding the representation of the respective media. For example, the virtual environment includes one or more surfaces (e.g., a floor and/or ceiling surface) that the simulated lighting effect is displayed on. In some embodiments, a virtual environment is an artist-designed location. In some embodiments, the computer system displays an atmospheric effect in the three-dimensional environment (e.g., in the representation of the virtual environment). For example, the computer system displays a virtual tinting (e.g., of physical representations of the user's physical environment and/or virtual content including virtual objects), one or more simulated lighting effects (e.g., virtual lighting simulating the appearance of physical light source(s) projecting light around the three-dimensional environment), virtual shadows (e.g., simulating the appearance of physical shadows caused by physical equivalents of the virtual lighting), and the like overlaying and/or applied to representations of the three-dimensional environment (e.g., including representations of the user's physical environment, and/or one or more virtual objects (e.g., virtual surfaces) included in the representation of the virtual environment). In some embodiments, applying an atmospheric effect to the three-dimensional environment includes modifying one or more visual characteristics of the three-dimensional environment such that it appears as if the three-dimensional environment is located at a different time, place, and/or condition (e.g., morning lighting instead of afternoon lighting, or sunny instead of overcast). In some embodiments, applying the atmospheric effect to the physical environment modifies the three-dimensional environment to appear dimly lit, and/or humid. In some embodiments, the virtual environment includes one or more virtual objects different from the representation of the respective media. For example, the one or more virtual objects correspond to user interfaces of one or more applications (e.g., accessible to the user of the computer system through the computer system). For example, the virtual environment includes a home screen and/or a system user interface of the computer system, and the one or more virtual objects are representations (e.g., icons) of one or more applications and/or virtual environments that are selectable by the user of the computer system. In some embodiments, the representation of the respective media overlaps (e.g., from the current viewpoint of the user of the computer system) a first region of the representation of the virtual environment (e.g., including one or more first virtual objects and/or content that is displayed within the first region of the representation of the virtual environment) when the representation of the respective media is displayed with the first size. In some embodiments, the representation of the respective media overlaps (e.g., from the current viewpoint of the user of the computer system) a second region, different from the first region, of the representation of the virtual environment (e.g., including one or more second virtual objects and/or content that are displayed within the second region of the representation of the virtual environment) when the representation of the respective media is displayed with the second size. In some embodiments, the first region of the representation of the virtual environment is included within the second region of the representation of the virtual environment (e.g., the second region is larger than the first region (e.g., because the second size of the representation of the respective media is larger than the first size of the representation of the respective media)). In some embodiments, the second region of the representation of the virtual environment is included within the first region of the representation of the virtual environment (e.g., the first region is larger than the second region (e.g., because the first size of the representation of the respective media is larger than the second size of the representation of the respective media)). Changing a size of a representation of respective media in a three-dimensional environment such that a portion of a representation of a virtual environment (e.g., included within the three-dimensional environment) that is overlapped by the representation of the respective media changes maintains a consistent position of the representation of the respective media relative to the virtual environment when one or more dimensions (e.g., an aspect ratio) of the respective media change and prevents the need for user input to change the representation of the respective media or the representation of the virtual environment to accommodate a change in one or more dimensions of the respective media, thereby improving user device interaction and conserving computing resources associated with user inputs to change the representation of the respective media.

In some embodiments, while the computer system displays the representation of the respective media in the three-dimensional environment, in accordance with a determination that the respective media includes first content at a current playback position, the computer system displays a simulated lighting effect in a third portion of the three-dimensional environment with a first visual appearance, wherein the third portion of the three-dimensional environment is outside of the representation of the respective media, such as simulated lighting effect 704 displayed in three-dimensional environment 700 in FIG. 7A. In some embodiments, while the computer system displays the representation of the respective media in the three-dimensional environment, in accordance with a determination that the respective media includes second content, different from the first content, at the current playback position, the computer system displays the simulated lighting effect in the third portion of the three-dimensional environment with a second visual appearance, different from the first visual appearance, such as simulated lighting effect 704 displayed in three-dimensional environment 700 in FIG. 7F. In some embodiments, the first content corresponds to a first portion (e.g., a first scene) of the respective media, and the second content corresponds to a second portion (e.g., a second scene, different from the first scene) of the respective media, different from the first portion of the respective media. In some embodiments, the first content is first media, and the second content is second media, different from the first media. In some embodiments, the first content includes a first amount of brightness, color, and/or saturation, and the second content includes a second amount, different from the first amount, of brightness, color, and/or saturation. In some embodiments, the simulated lighting effect includes glow or light displayed as if emanating from the respective media onto one or more portions (e.g., the third portion) of the three-dimensional environment (e.g., to emulate light spill and/or glow that would be visible if the respective media was displayed in a real-world location (e.g., in a theater and/or cinema)). For example, the one or more portions of the three-dimensional environment are different from a portion of the three-dimensional environment that includes or is overlapped by (e.g., from the current viewpoint of the user) the respective media. In some embodiments, the simulated lighting effect corresponds to the color, brightness, and/or saturation of the respective media (e.g., the simulated lighting effect is displayed within a threshold amount (e.g., within 50, 55, 60, 65, 70, 75, 80, 85, 90, or 95 percent) of the amount of color, brightness, and/or saturation of the respective media). For example, the simulated lighting effect includes virtual glow, light, and/or reflection that is displayed in the three-dimensional environment that corresponds to the visual appearance of the respective media (e.g., of the first content or the second content). In some embodiments, the difference between the first visual appearance of the simulated lighting effect and the second visual appearance of the simulated lighting effect corresponds to the difference between the visual appearance of the first content and the second content. For example, the first visual appearance of the simulated lighting effect corresponds to the first amount of color, brightness, and/or saturation of the first content, and the second visual appearance of the simulated lighting effect corresponds to the second amount of the color, brightness, and/or saturation of the second content. In some embodiments, the three-dimensional environment includes a representation of the physical environment of a user (e.g., as described above), and the simulated lighting effect is displayed on one or more objects (e.g., surfaces) within the representation of the physical environment. For example, displaying the simulated lighting effect includes displaying light (e.g., corresponding to the brightness, color, and/or saturation of the respective media) reflecting off of a surface within the representation of the physical environment (e.g., off of a surface of furniture, such as a table, or off of a floor or ceiling). In some embodiments, the three-dimensional environment includes a representation of a virtual environment, and the simulated lighting effect is displayed on one or more virtual elements (e.g., included within the virtual environment). For example, displaying the simulated lighting effect includes displaying a reflection on a virtual representation of water (e.g., in a lake environment) corresponding to the visual appearance (e.g., brightness, color, and/or saturation) of the respective media. For example, the simulated lighting effect is displayed on one or more virtual surfaces (e.g., a floor, wall, and/or ceiling) within the virtual environment. Changing a simulated lighting effect in a three-dimensional environment when a size of a representation of respective media changes in a three-dimensional environment maintains a consistent display of the simulated lighting effect when one or more dimensions (e.g., an aspect ratio) of the respective media changes (e.g., due to a change in a current playback location of the respective media) and prevents the need for user input to change the simulated lighting effect to accommodate a change in one or more dimensions of the respective media, thereby improving user device interaction and conserving computing resources associated with user inputs to change the simulated lighting effect.

In some embodiments, while the computer system displays the representation of the respective media in the three-dimensional environment, in accordance with a determination that the representation of the respective media has (e.g., is displayed at) the first size, the computer system displays the simulated lighting effect in the third portion of the three-dimensional environment with a third size, such as the size of simulated lighting effect 748 shown in FIG. 7O. In some embodiments, the third size of the simulated lighting effect corresponds the first size of the representation of the respective media. In some embodiments, while the computer system displays the representation of the respective media in the three-dimensional environment, in accordance with a determination that the representation of the respective media has (e.g., is displayed at) the second size, the computer system displays the simulated lighting effect in the third portion of the three-dimensional environment with a fourth size, different from the third size, such as the size of simulated lighting effect 748 shown in FIG. 7P (e.g., after changing representation 702 from the first size in FIG. 7O to the second size in FIG. 7P). In some embodiments, the fourth size of the simulated lighting effect corresponds to the second size of the representation of the respective media. In some embodiments, in accordance with a determination that the second size of the representation of the respective media is larger than the first size of the representation of the respective media, the simulated lighting effect of the fourth size is larger (e.g., relative to the three-dimensional environment) than the simulated lighting effect of the third size of the simulated lighting effect. In some embodiments, in accordance with a determination that the first size of the representation of the respective media is larger than the second size of the representation of the respective media, the simulated lighting effect of the third size is larger (e.g., relative to the three-dimensional environment) than the simulated lighting effect of the fourth size. In some embodiments, in accordance with a determination that the representation of the respective media is the first size, the computer system displays the simulated lighting effect on a first portion of a surface (e.g., or virtual representation of water) that is displayed and/or visible in the three-dimensional environment. In some embodiments, in accordance with a determination that the representation of the respective media is the second size, the computer system displays the simulated lighting effect on a second portion, different from the first portion, of the surface (e.g., or virtual representation of water) that is displayed and/or visible in the three-dimensional environment. In some embodiments, the size of the simulated lighting effect corresponds to an aspect ratio of the respective media. For example, in accordance with a determination that the aspect ratio of the respective media is a first aspect ratio, the simulated lighting effect is displayed with the third size in the three-dimensional environment (e.g., because the representation of the respective media is displayed with the first size when the aspect ratio of the respective media is the first aspect ratio). For example, in accordance with a determination that the aspect ratio of the respective media is a second aspect ratio, different from the first aspect ratio, the simulated lighting effect is displayed with the fourth size in the three-dimensional environment (e.g., because the representation of the respective media is displayed with the second size when the aspect ratio of the respective media is the second aspect ratio). In some embodiments, the computer system changes the simulated lighting effect (e.g., from the third size to the fourth size) based on a change in one or more dimensions of the representation of the respective media. For example, displaying the representation of the respective media with the second size includes changing a first dimension (e.g., width) of the representation of the respective media and not a second dimension (e.g., height), different from the first dimension, of the representation of the respective media, and displaying the simulated lighting effect with the fourth size includes changing a first dimension (e.g., width) and not a second dimension (e.g., height), different from the first dimension, of the simulated lighting effect in the three-dimensional environment. Changing a size of a simulated lighting effect in a three-dimensional environment when a size of a representation of respective media changes in a three-dimensional environment maintains a consistent display of the simulated lighting effect when one or more dimensions (e.g., an aspect ratio) of the respective media changes (e.g., due to a change in a current playback location of the respective media) and prevents the need for user input to change the simulated lighting effect to accommodate a change in one or more dimensions of the respective media, thereby improving user device interaction and conserving computing resources associated with user inputs to change the simulated lighting effect.

In some embodiments, while the computer system displays the representation of the respective media in the three-dimensional environment (e.g., while playing through the respective media), in accordance with a determination that the current playback location of the respective media is a first playback location including the first content, the computer system displays the simulated lighting effect with a first set of visual effects, such as the content (e.g., as represented by the fill pattern) of simulated lighting effect 748 shown in FIG. 7O. In some embodiments, while the computer system displays the representation of the respective media in the three-dimensional environment, in accordance with a determination that the current playback location of the respective media is a second playback location including the second content, the computer system displays the simulated lighting effect with a second set of visual effects, different from the first set of visual effects, such as content (e.g., as represented by the different fill pattern) of simulated lighting effect 748 shown in FIG. 7P (e.g., compared to the content of simulated lighting effect 748 shown in FIG. 7O). In some embodiments, the content (e.g., the first content and/or the second content) of the respective media is video content that visually changes while the video content is played back in the three-dimensional environment (e.g., an appearance of the representation of the respective media changes in the three-dimensional environment while the respective media is played back). For example, the first content (e.g., a first portion of the respective media including one or more first playback locations) includes a first visual appearance (e.g., a first amount of brightness, color, and/or saturation), and the first set of visual effects corresponds to the first visual appearance. For example, the second content (e.g., a second portion of the respective media including one or more second playback locations) includes a second visual appearance (e.g., a second amount, different from the first amount, of brightness, color, and/or saturation), different from the first visual appearance, and the second set of visual effects corresponds to the second visual appearance. In some embodiments, the first set of visual effects correspond to a first value of one or more first visual effects (e.g., brightness, color, and/or saturation), and the second set of visual effects correspond to a second value, different from the first value, of the one or more first visual effects. In some embodiments, the first set of visual effects include one or more first visual effects, and the second set of visual effects include one or more second visual effects, different from the one or more first visual effects (e.g., the second set of visual effects includes one or more visual effects not included in the first set of visual effects). In some embodiments, the first set of visual effects include a first effect of a first value and a second effect of a second value, and the second set of visual effects include the first effect of the first value and the second effect of a third value, different from the second value (e.g., displaying the second set of visual effects includes displaying one or more same visual effects and one or more different visual effects compared to displaying the first set of visual effects). In some embodiments, a simulated lighting effect displayed in the three-dimensional environment changes in visual appearance (e.g., in brightness, color, and/or saturation) as the respective media is played back. For example, the simulated lighting effect changes from the first visual appearance to the second visual appearance while the respective media is played back in the three-dimensional environment (e.g., the first visual appearance of the simulated lighting effect corresponds to a first playback location of the respective media, and the second visual appearance of the simulated lighting effect corresponds to a second playback location, different from the first playback location, of the respective media that is after the first playback location). In some embodiments, a simulated lighting effect displayed in the three-dimensional environment changes from the first visual appearance to the second visual appearance in response to user input. For example, the user input is a request to navigate from the first playback location of the respective media to the second playback location, different from the first playback location, of the respective media, and the simulated lighting effect changes (e.g., continuously) while the user performs the user input (e.g., a respective visual appearance of the simulated lighting effect displayed corresponds to a current playback location (e.g., between the first playback location and the second playback location) of the respective media while the user is performing the user input). For example, the user input is a request to navigate from the first playback location of the respective media to the second playback location of the respective media, and the simulated lighting effect changes after the user performs (e.g., in response to) the user input (e.g., the first visual appearance of the simulated lighting effect corresponds to the first playback location, and the second visual appearance of the simulated lighting effect corresponds to the second playback location). Changing a set of visual effects of a simulated lighting effect in a three-dimensional environment when a current playback location of the respective media changes maintains a consistent display of the simulated lighting effect when an appearance of the respective media changes (e.g., due to the change in the current playback location) and prevents the need for user input to change the simulated lighting effect to accommodate a change in appearance of the respective media, thereby improving user device interaction and conserving computing resources associated with user inputs to change the simulated lighting effect.

In some embodiments, while displaying the representation of the respective media with the second size relative to the three-dimensional environment, the computer system detects, via the one or more input devices, a user input corresponding to a request to change a size of the representation of the respective media from the second size to a third size, different from the second size, relative to the three-dimensional environment, such as the user input (e.g., gaze 726 and the air gesture performed by hand 724) corresponding to the request to change the size of representation 702 shown in FIG. 7C. In some embodiments, the representation of the respective media is displayed with an affordance that is selectable to change a size of the representation of the respective media. For example, the affordance is displayed adjacent to the representation of the respective media (e.g., adjacent to a corner of the representation of the respective media). Additionally or alternatively, the affordance is optionally displayed within the representation of the respective media. In some embodiments, the affordance is consistently displayed in the three-dimensional environment (e.g., without a user input to display the affordance). In some embodiments, the affordance is displayed in response to user input (e.g., in response to detecting attention (e.g., based on gaze, cursor, and/or hand position) directed to a location in the three-dimensional environment associated with the affordance (e.g., the location is within, or adjacent to (e.g., near a corner of), the representation of the respective media)). In some embodiments, the user input corresponding to the request to change the size of the representation of the respective media includes attention (e.g., based on gaze, cursor, and/or hand position) directed toward the affordance (e.g., for a threshold period of time (e.g., 0.01, 0.05, 0.1, 0.2, 0.5, 1, 2, or 5 seconds) and a hand gesture. For example, the hand gesture includes an air gesture, such as an air pinch of the thumb and a finger. For example, the hand gesture includes movement (e.g., while performing an air gesture) corresponding to a requested size of the representation of the respective media (e.g., in accordance with a determination that the user input includes movement in a first direction (e.g., away from a center of the representation of the respective media), the computer system increases the size of the representation of the respective media, and in accordance with a determination that the user input includes movement in a second direction, opposite the first direction (e.g., toward a center of the representation of the respective media), the computer system decreases a size of the representation of the respective media). The size of the representation of the respective media optionally changes while the user input is detected (e.g., the computer system changes the size of the representation of the respective media based on hand movement (e.g., while performing an air gesture) while the user input is detected). In some embodiments, the user input includes an input on a touch-sensitive surface (e.g., a touchpad) of the computer system (e.g., a force-sensitive input (e.g., a click of a touchpad), a capacitive touch input (e.g., a swipe of a finger on a touch-sensitive display)) and/or a verbal input (e.g., a voice command). In some embodiments, the computer system maintains playback of the respective media in the three-dimensional environment while the user input is detected.

In some embodiments, in response to detecting the user input, the computer system displays the representation of the respective media with the third size relative to the three-dimensional environment (e.g., such that the representation of the respective media overlaps a third portion, different from the second portion, of the three-dimensional environment from the current viewpoint of the user), such as displaying representation 702 with the changed size in FIG. 7D (e.g., compared to the size of representation 702 shown in FIG. 7C). In some embodiments, the representation of the respective media is displayed with the third size after detecting termination of the user input (e.g., the user ceases to perform an air gesture). In some embodiments, the third size of the representation of the respective media corresponds to a magnitude of movement (e.g., hand movement while a user performs an air gesture (e.g., an air pinch)) of the user input. For example, in accordance with a determination that the user input includes a first amount of movement (e.g., in a first direction (e.g., away from a center of the representation of the respective media)), displaying the representation of the respective media with the third size includes displaying the representation of the respective media with one or more first dimensions of a first value in the three-dimensional environment. For example, in accordance with a determination that the user input includes a second amount of movement (e.g., in the first direction (e.g., away from the center of the representation of the respective media)), greater than the first amount of movement, displaying the representation of the respective media with the third size includes displaying the representation of the respective media with one or more second dimensions, greater than the one or more first dimensions. In some embodiments, in accordance with a determination that the user input includes movement in a first direction (e.g., away from a center of the representation of the respective media), the computer system increases the size of the representation of the respective media. In some embodiments, in accordance with a determination that the user input includes movement in a second direction (e.g., toward a center of the representation of the respective media), different from the first direction, the computer system decreases the size of the representation of the respective media. In some embodiments, displaying the representation of the respective media with the third size relative to the three-dimensional environment includes changing a height and/or width of the representation of the respective media (e.g., corresponding to the user input). In some embodiments, displaying the representation of the respective media with the third size relative to the three-dimensional environment includes changing a location of the representation of the respective media in the three-dimensional environment based on the user input (e.g., the representation of the respective media is moved farther from or closer to a location corresponding to the current viewpoint of the user in the three-dimensional environment). Changing the size of the representation of the respective media in response to the user input optionally includes changing a size of a simulated lighting effect displayed in the three-dimensional environment (e.g., having one or more characteristics of changing a size of a simulated lighting effect described above). Changing a size of a representation of respective media in a three-dimensional environment in response to user input while the representation of the respective media is displayed provides a user discretion in displaying the representation with a preferred size while limiting interruption of the display of the representation (e.g., including playback of the respective media) in the three-dimensional environment, thereby minimizing input errors associated with the user viewing the representation of the media in a non-preferred size, and thus preserving computing resources associated with correcting input errors.

In some embodiments, the representation of the respective media has a first aspect ratio when the representation of the respective media is displayed with the second size relative to the three-dimensional environment, such as the aspect ratio of representation 702 shown in FIG. 7C. In some embodiments, displaying the representation of the respective media with the third size relative to the three-dimensional environment includes maintaining the first aspect ratio of the representation of the respective media, such as computer system 101 maintaining the aspect ratio of representation 702 in FIG. 7D in response to the user input (e.g., gaze 726 and the air gesture performed by hand 724) corresponding to the request to change the size of representation 702 shown in FIG. 7C. In some embodiments, displaying the representation of the respective media with the third size relative to the three-dimensional environment includes changing a first dimension (e.g., height) and a second dimension (e.g., width), different from the first dimension, of the representation of the respective media in the three-dimensional environment. In some embodiments, the first dimension and the second dimension of the representation of the respective media are changed proportionally in response to the user input corresponding to the request to change the size of the representation of the respective media from the second size to the third size. For example, displaying the representation of the respective media with the third size relative to the three-dimensional environment includes increasing the first dimension and the second dimension of the representation of the respective media at a constant rate (e.g., optionally while receiving the user input, as described above) such that the ratio between the first dimension and the second dimension is maintained and held constant despite the change in overall size of the representation. In some embodiments, the second size of the representation of the respective media includes a first dimension of a first value and a second dimension, different from the first dimension, of a second value (e.g., optionally different from the first value). In some embodiments, the first value of the first dimension and the second value of the second dimension include a first ratio (e.g., a proportional relationship between width and height). In some embodiments, the third size of the representation of the respective media includes a first dimension of a third value, different from the first value, and a second dimension, different from the first dimension, of a fourth value, different from the second value. In some embodiments, the third value of the first dimension and the fourth value of the second dimension include the first ratio (e.g., the representation of the respective media displayed with the third size includes the same proportional relationship between width and the height as the representation of the respective media displayed with the second size). In some embodiments, displaying the representation of the respective media with the third size includes increasing the first dimension and the second dimension (e.g., proportionally) of the representation of the respective media in the three-dimensional environment. In some embodiments, displaying the representation of the respective media with the third size includes decreasing the first dimension and the second dimension (e.g., proportionally) of the representation of the respective media in the three-dimensional environment. Changing a size of a representation of respective media in a three-dimensional environment in response to user input without changing an aspect ratio of the representation maintains a consistent display of the respective media in the three-dimensional environment (e.g., by displaying the representation according to an aspect ratio of the respective media as opposed to an aspect ratio requested through the user input (e.g., preventing distortion of the respective media and/or the display of artifacts)), thereby improving user device interaction and conserving computing resources associated with user inputs directed to the representation to correct a change in aspect ratio of the representation.

In some embodiments, displaying the representation of the respective media with the first size relative to the three-dimensional environment includes displaying the representation of the respective media with a first dimension of a first value, such as displaying height 722a of representation 702 with second value H2-a in FIG. 7D. In some embodiments, the first dimension is a height of the representation of the respective media relative to the three-dimensional environment. In some embodiments, the first dimension is a width of the representation of the respective media relative to the three-dimensional environment. In some embodiments, displaying the representation of the respective media with the first size relative to the three-dimensional environment includes displaying the representation of the respective media with a second dimension, different from the first dimension, of a second value (e.g., optionally different from the first value). In some embodiments, the second dimension is a width of the representation of the respective media relative to the three-dimensional environment.

In some embodiments, displaying the representation of the respective media with the second size relative to the three-dimensional environment includes displaying the representation of the respective media with the first dimension of the first value, such as maintaining second value H2-a height 722a of representation 702 in FIG. 7E (e.g., compared to FIG. 7D). In some embodiments, displaying the representation of the respective media with the second size relative to the three-dimensional environment includes displaying the representation of the respective media with a second dimension of a third value, different from the second value. For example, displaying the representation of the respective media with the second size relative to the three-dimensional environment includes changing a width of the representation of the respective media and not the height of the representation of the respective media. For example, displaying the representation of the respective media with the second size relative to the three-dimensional environment includes changing a height of the representation of the respective media and not the width of the representation of the respective media. In some embodiments, the change in the current playback location of the respective media corresponds to a change in aspect ratio of the respective media from a first aspect ratio to a second aspect ratio, different from the first aspect ratio. For example, the first aspect ratio includes a first dimension of a first value and a second dimension, different from the first dimension, of a second value, and the second aspect ratio includes a first dimension of a third value, different from the first value, and a second dimension, different from the first dimension, of a fourth value, different from the second value. In some embodiments, in response to the change in aspect ratio of the respective media from the first aspect ratio to the second aspect ratio, the computer system maintains the value of the first dimension of the representation of the respective media and changes the value of the second dimension of the representation of the respective media (e.g., despite the second aspect ratio including both a different first dimension and a different second dimension from the first aspect ratio). In some embodiments, the first aspect ratio includes a different value of the first dimension (e.g., height) and the same value of the second dimension (e.g., width) compared to the second aspect ratio. In some embodiments, in response to the change in aspect ratio of the respective media from the first aspect ratio to the second aspect ratio (e.g., including different values of the first dimension (e.g., different values of height) and the same value of the second dimension (e.g. same value of width)), the computer system maintains the value of the first dimension (e.g., height) of the representation of the respective media and changes the value of the second dimension (e.g., width) of the representation of the respective media (e.g., despite the second aspect ratio including different values of the first dimension (e.g., different values of height) and the same value of the second dimension (e.g., same value of width)). Changing a size of a representation of respective media in a three-dimensional environment by maintaining a first dimension of the representation in response to a change in playback location of the respective media maintains a consistent position of the representation in the three-dimensional environment when an aspect ratio of the respective media changes, minimizes the amount of change of the representation that is needed to accommodate a change in aspect ratio of the respective media (e.g., by only changing one dimension of the representation), and prevents the need for user input to change the representation and/or the three-dimensional environment to accommodate a change in aspect ratio of the respective media, thereby improving user device interaction and conserving computing resources associated with user inputs to change the representation.

In some embodiments, displaying the representation of the respective media with the second size relative to the three-dimensional environment includes, in accordance with a determination that the change in the current playback location of the respective media corresponds to a change from a first aspect ratio to a second aspect ratio of the respective media, changing a first dimension (e.g., width) of the representation of the respective media without changing a second dimension (e.g., height), different from the first dimension, of the representation of the respective media, such as changing width 722b of representation 702 and not height of representation 702 from FIG. 7D to FIG. 7E in response to the change in the aspect ratio of the respective media to aspect ratio 712b. In some embodiments, displaying the representation of the respective media with the second size relative to the three-dimensional environment includes changing the width of the representation of the respective media without changing the height of the representation of the respective media (e.g., such that the ratio of the width of the representation of the respective media to the height of the representation of the respective media corresponds to the second aspect ratio of the respective media). In some embodiments, the first aspect ratio and/or second aspect ratio is 16:9, 1.18:1, 1.85:1, 2:1, 2.35:1, 21:9, 2.39:1, or 2.40:1. In some embodiments, changing the first dimension of the representation of the respective media without changing the second dimension of the representation of the respective media includes changing the first dimension of the representation of the respective media along a first axis (e.g., a horizontal axis) in the three-dimensional environment in a first direction and in a second direction, opposite from the first direction (e.g., the representation of the respective media expands in width equally in a leftward direction (e.g., from the current viewpoint of the user) and in a rightward direction). In some embodiments, the computer system changes the first dimension of the representation of the respective media gradually (e.g., over a period of time (e.g., 0.01, 0.05, 0.1, 0.2, 0.5, 1, 2, 5 or 10 seconds). In some embodiments, the computer system maintains playback of the respective media while changing the first dimension of the representation of the respective media.

In some embodiments, displaying the representation of the respective media with the second size relative to the three-dimensional environment includes in accordance with a determination that the change in the current playback location of the respective media corresponds to a change from the first aspect ratio to a third aspect ratio, different from the second aspect ratio, of the respective media, changing the second dimension (e.g., height) of the representation of the respective media (e.g., and optionally changing the first dimension (e.g., width) of the representation of the respective media), such as changing height 722a of representation 702 in FIGS. 7F-7G in response to the change in the aspect ratio of the respective media to aspect ratio 712d. In some embodiments, displaying the representation of the respective media with the second size relative to the three-dimensional environment includes changing the height of the representation of the respective media and not the width of the representation of the respective media (e.g., such that the ratio of the width of the representation of the respective media to the height of the representation of the respective media corresponds to the third aspect ratio of the respective media). In some embodiments, the third aspect ratio is 1.43:1 or 1.90:1. In some embodiments, in accordance with a determination that the change in the current playback location of the respective media includes a change from the first aspect ratio to a respective aspect ratio, different from the third aspect ratio (e.g., the respective aspect ratio is not 1.43:1 or 1.90:1), the computer system changes the first dimension (e.g., width) of the representation of the respective media and not the second dimension (e.g., height) of the representation of the respective media. In some embodiments, in accordance with a determination that the change in the current playback location of the respective media corresponds to the change from the first aspect ratio to the third aspect ratio (e.g., or optionally a fourth aspect ratio, different from the third aspect ratio), the computer system changes the second dimension (e.g., height) of the representation of the respective media and not the first dimension (e.g., width) of the representation of the respective media. In some embodiments, in accordance with a determination that the change in the current playback location of the respective media corresponds to a change from a fourth aspect ratio, different from the first aspect ratio, to the third aspect ratio, the computer system changes the second dimension (e.g., height) of the representation of the respective media and the first dimension (e.g., width) of the representation of the respective media. Changing a first dimension and not a second dimension, different from the first dimension, of a representation of respective media when the aspect ratio of the respective media changes to a first aspect ratio, and changing the second dimension of the representation when the aspect ratio of the respective media changes to a second aspect ratio minimizes the amount of change of the representation needed to accommodate different aspect ratios of the respective media (e.g., by only changing a second dimension when the change in the aspect ratio of the respective media requires it) and maintains a consistent position of the representation in the three-dimensional environment, thereby improving user device interaction and conserving computing resources associated with user inputs to change the representation to accommodate a change in aspect ratio of the respective media.

In some embodiments, displaying the representation of the respective media with the second size relative to the three-dimensional environment includes, in accordance with a determination that the three-dimensional environment includes a virtual environment of a first type (e.g., the virtual environment shown and described with reference to FIGS. 7A-7H), changing a first dimension (e.g., height) of the representation of the respective media in a first direction along a first axis in the three-dimensional environment without changing the first dimension in a second direction opposite the first direction along the first axis, such as changing height 722a of representation 702 in first direction 734a and not second direction 734b in FIG. 7G. In some embodiments, the environment of the first type includes one or more characteristics of a representation of a physical environment of the user as described above. In some embodiments, the environment of the first type includes one or more characteristics of a representation of a virtual environment as described above. In some embodiments, the environment of the first type corresponds to a virtual environment of a first type. For example, the virtual environment of the first type includes a virtual representation of a landscape or scene (e.g., as described above, such as a lake environment, or a mountain environment). For example, the virtual environment of the first type includes a virtual representation of a real-world location or landmark (e.g., Mount Hood). In some embodiments, displaying the representation of the respective media with the second size relative to the three-dimensional environment includes increasing a height of the representation of the respective media upward along a vertical axis (e.g., from the current viewpoint of the user) and not downward along the vertical axis in the three-dimensional environment (e.g., increasing the height of the representation of the respective media from the bottom of the representation of the respective media). For example, displaying the representation of the respective media with the second size relative to the three-dimensional environment includes expanding the height of the representation of the respective media such that the representation of the respective media appears to be expanding from the top and not from the bottom (e.g., a bottom portion (e.g., the bottom edge) of the representation of the respective media is displayed at the same location in the three-dimensional environment when the representation of the respective media is displayed with the first size as when the representation of the respective media is displayed with the second size). In some embodiments, displaying the representation of the respective media with the second size relative to the three-dimensional environment includes decreasing the height of the representation of the respective media downward along the vertical axis without decreasing the height of the representation of the respective media upward along the vertical axis in the three-dimensional environment. In some embodiments, a simulated lighting effect (e.g., as described above) is displayed within the environment of the first type (e.g., when the representation of the respective media is displayed with the first size and when the representation of the respective media is displayed with the second size). For example, the simulated lighting effect is displayed below the representation of the respective media (e.g., from the current viewpoint of the user), and changing the first dimension of the representation of the respective media in the first direction along the first axis prevents a spatial conflict with the simulated lighting effect (e.g., that would require the simulated lighting effect to be shifted to a new location in the three-dimensional environment to accommodate the change in size of the representation of the respective media).

In some embodiments, displaying the representation of the respective media with the second size relative to the three-dimensional environment includes in accordance with a determination that the three-dimensional environment includes a virtual environment of a second type (e.g., the virtual environment shown and described with reference to FIGS. 7I-7M), different from the first type, changing the first dimension of the representation of the respective media in the first direction and the second direction, opposite from the first direction, along the first axis in the three-dimensional environment, such as changing height 722a of representation 702 in first direction 734a and second direction 734b along a vertical axis (with respect to the viewpoint of the user) in FIGS. 7J-7K. In some embodiments, the computer system changes the first dimension of the respective media symmetrically. For example, the first dimension of the respective media changes by the same amount in the first direction and the second direction along the first axis in the three-dimensional environment. In some embodiments, the computer system does not change the first dimension of the respective media symmetrically. For example, the first dimension of the respective media changes by a first amount in the first direction, and by a second amount, different from the first amount, in the second direction along the first axis in the three-dimensional environment. In some embodiments, the environment of the second type corresponds to a virtual environment of a second type, different from the virtual environment of the first type (e.g., as described above). For example, the virtual environment of the second type is a representation of a cinema environment and/or a theater (e.g., as described above). In some embodiments, the virtual environment of the second type includes one or more virtual surfaces (e.g., a floor and/or ceiling surface) that a simulated lighting effect is displayed on. In some embodiments, displaying the representation of the respective media with the second size relative to the three-dimensional environment includes, in accordance with a determination that the three-dimensional environment includes the environment of the second type, increasing a height of the representation of the respective media in an upward direction (e.g., from the current viewpoint of the user) and in a downward direction (e.g., the representation of the respective media increases in height from the center of the representation of the respective media concurrently in an upward direction and in a downward direction). For example, displaying the representation of the respective media with the second size relative to the three-dimensional environment includes expanding the height of the representation of the respective media such that the representation of the respective media appears to be expanding from its center (e.g., from the top and the bottom). For example, a top portion (e.g., the top edge) and a bottom portion (e.g., the bottom edge) of the representation of the respective media are displayed at different locations in the three-dimensional environment when the representation of the respective media is displayed with the first size as when the representation of the respective media is displayed with the second size. In some embodiments, displaying the representation of the respective media with the second size relative to the three-dimensional environment includes, in accordance with a determination that the three-dimensional environment includes the environment of the second type, decreasing a height of the representation of the respective media in an upward direction and in a downward direction (e.g., the representation of the respective media decreases from the first direction and the second direction toward the center of the representation of the respective media). In some embodiments, displaying the representation of the respective media with the second size relative to the three-dimensional environment includes changing a location of a bottom portion (e.g., the bottom edge) and a top portion (e.g., the top edge) of the representation of the respective media in the three-dimensional environment (e.g., moving the bottom portion and the top portion farther from (e.g., if increasing size) or closer to (e.g., if decreasing size) the center of the representation of the respective media). Displaying the representation of the respective media with the second size relative to the three-dimensional environment optionally does not include changing a second dimension (e.g., width), different from the first dimension, of the representation of the respective media. Displaying the representation of the respective media with the second size relative to the three-dimensional environment optionally includes changing a second dimension (e.g., width), different from the first dimension, of the representation of the respective media (e.g., in addition to changing the first dimension of the representation of the respective media). Changing a dimension of a representation of respective media in response to a change in playback location of the respective media in a different manner based on a type of environment the representation is displayed in maintains a position of the representation in the environment that is consistent with one or more visual effects (e.g., lighting effects) included in the environment when an aspect ratio of the respective media changes and prevents the need for user input to change the representation and/or environment to accommodate a change in the aspect ratio of the respective media, thereby improving user device interaction and conserving computing resources associated with user inputs to change the representation and/or environment.

In some embodiments, the three-dimensional environment includes one or more virtual surfaces that are visible from the current viewpoint of the user in a third portion of the three-dimensional environment (e.g., the one or more surfaces are not included in the first portion of the three-dimensional environment), such as virtual surfaces 764a and 764b shown in FIG. 7I. In some embodiments, in response to detecting the change in the current playback location of the respective media, the computer system decreases a visibility of the one or more virtual surfaces in the three-dimensional environment, such as decreasing the visibility of virtual surfaces 764a and 764b in FIG. 7J, and expands (e.g., the computer system decreases the visibility of the one or more virtual surfaces while expanding) the representation of the respective media at least partially into the third portion of the three-dimensional environment, such as the expansion of representation 702 shown in FIGS. 7J-7K. In some embodiments, the computer system decreases the visibility of the one or more virtual surfaces gradually while changing a size of the representation of the respective media from the first size to the second size (e.g., displaying the representation of the respective media with the second size includes displaying the representation of the respective media at least partially within the third portion of the three-dimensional environment). In some embodiments, the one or more virtual surfaces include one or more characteristics of one or more surfaces described above. In some embodiments, the one or more virtual surfaces include a first surface displayed above the representation of the respective media (e.g., a ceiling surface), and a second surface, different from the first surface, displayed below the representation of the respective media (e.g., a floor surface). For example, the third portion of the three-dimensional environment is above the representation of the respective media of the first size (e.g., from the current viewpoint of the user). For example, the third portion of the three-dimensional environment is below the representation of the respective media of the first size (e.g., from the current viewpoint of the user). In some embodiments, the computer system decreases the visibility of the one or more virtual surfaces as the computer system changes the first dimension of the representation of the respective media in the first direction and the second direction. For example, displaying the representation of the respective media with the second size includes increasing a height of the representation of the respective media (e.g., from its center) toward the first surface (e.g., the ceiling surface) and toward the second surface (e.g., the floor surface). In some embodiments, decreasing the visibility of the one or more virtual surfaces includes increasing the transparency (e.g., or decreasing the opacity) of the one or more virtual surfaces in the three-dimensional environment (e.g., by 50, 60, 70, 75, 80, 85, 90, 95, or 100 percent). In some embodiments, decreasing the visibility of the one or more virtual surfaces include ceasing to display the one or more virtual surfaces in the three-dimensional environment. In some embodiments, decreasing the visibility of the one or more virtual surfaces includes changing (e.g., decreasing) a brightness, color, and/or saturation of the one or more virtual surfaces in the three-dimensional environment. In some embodiments, the computer system decreases the visibility of the one or more virtual surfaces gradually (e.g., over a period of time (e.g., 0.01, 0.05, 0.1, 0.2, 0.5, 1, 2, 5, 10, 15, 20, 25, 30, or 60 seconds)). In some embodiments, displaying the representation of the respective media with the second size includes displaying the representation of the respective media in a portion of the three-dimensional environment that included the one or more virtual surfaces (e.g., when the representation of the respective media was displayed with the first size). In some embodiments, the computer system decreases the visibility of the one or more virtual surfaces of the three-dimensional environment in accordance with a determination that the change in the current playback location of the respective media corresponds to a first aspect ratio of the respective media (e.g., 1.43:1 or 1.90:1). In some embodiments, in accordance with a determination that the change in the current playback location of the respective media does not correspond to the first aspect ratio (e.g., the change in the current playback location of the respective media corresponds to a second aspect ratio, different from the first aspect ratio), the computer system forgoes decreasing the visibility of the one or more virtual surfaces of the three-dimensional environment (e.g., the computer system maintains the visibility of the one or more virtual surfaces of the three-dimensional environment). In some embodiments, after decreasing the visibility of the one or more virtual surfaces, the computer system detects a second change in the current playback location of the respective media (e.g., corresponding to a change in the aspect ratio of the respective media). In some embodiments, in response to detecting the second change in the current playback location of the respective media, the computer system increases the visibility of the one or more virtual surfaces of the three-dimensional environment. Decreasing a visibility of one or more virtual surfaces in a three-dimensional environment in response to detecting a change in the playback location of respective media prevents visual conflicts between the respective media and the one or more virtual surfaces when a representation of the respective media changes in size in the three-dimensional environment to accommodate a change in aspect ratio of the respective media (e.g., associated with the change in the playback location), thereby improving user device interaction and conserving computing resources associated with user inputs to correct the visual conflicts.

In some embodiments, the three-dimensional environment includes a simulated lighting effect on the one or more virtual surfaces, such as simulated lighting effect 736a-736b shown on virtual surfaces 764a-764b in FIG. 7I. In some embodiments, decreasing the visibility of the one or more virtual surfaces in the three-dimensional environment includes reducing a visual prominence of the simulated lighting effect on the one or more virtual surfaces in the three-dimensional environment, such as reducing the visual prominence of simulated lighting effect 736a-736b shown in FIG. 7J (as compared to simulated lighting effect 736a-736b illustrated in FIG. 7I). In some embodiments, reducing the visual prominence of the simulated lighting effect includes ceasing to display the simulated lighting effect in the three-dimensional environment. In some embodiments, the simulated lighting effect has one or more characteristics of the simulated lighting effect described above. In some embodiments, reducing a visual prominence of the simulated lighting effect includes increasing the transparency (e.g., or decreasing the opacity) of the simulated lighting effect in the three-dimensional environment (e.g., by 50, 60, 70, 75, 80, 85, 90, 95, or 100 percent). In some embodiments, reducing a visual prominence of the simulated lighting effect includes reducing a value of a set of visual effects (e.g., the first set of visual effects or the second set of visual effects described above). For example, reducing the visual prominence of the simulated lighting effect includes reducing the brightness, color, and/or saturation of the simulated lighting effect. In some embodiments, reducing the visual prominence of the simulated lighting effect includes decreasing the visibility of the simulated lighting effect gradually (e.g., over a period of time (e.g., 0.01, 0.05, 0.1, 0.2, 0.5, 1, 2, 5, 10, 15, 20, 25, 30, or 60 seconds)). In some embodiments, the computer system decreases the visibility of the simulated lighting effect concurrently with the one or more surfaces (e.g., the computer system gradually increases the transparency of the one or more surfaces and the simulated lighting effect concurrently (e.g., until the one or more virtual surfaces and the simulated lighting effect are not visible in the three-dimensional environment from the current viewpoint of the user)). In some embodiments, the computer system reduces the visual prominence of the simulated lighting effect (e.g., gradually) while changing the size of the representation of the respective media in the three-dimensional environment (e.g., while changing the representation of the respective media from the first size to the second size relative to the three-dimensional environment). Reducing a visual prominence of a simulated lighting effect in a three-dimensional environment in response to detecting a change in the playback location of respective media prevents visual conflicts between the respective media and the simulated lighting effect when a representation of respective media changes in size in the three-dimensional environment to accommodate a change in aspect ratio of the respective media (e.g., associated with the change in playback location), thereby improving user device interaction and conserving computing resources associated with user inputs to correct the visual conflicts.

In some embodiments, displaying the representation of the respective media with the first size relative to the three-dimensional environment includes displaying the representation of the respective media with a first amount of curvature relative to the three-dimensional environment (and/or relative to the current viewpoint of the user), such as with the amount of curvature of representation 702 shown in FIG. 7I and/or FIG. 7L. In some embodiments, the curvature of the representation of the respective media is about a first axis in the three-dimensional environment (e.g., the curvature is cylindrical). In some embodiments, the curvature of the representation of the respective media is about multiple axes in the three-dimensional environment (e.g., the curvature is spherical or parabolic). In some embodiments, the representation of the respective media is displayed with the first amount of curvature relative to the three-dimensional environment in accordance with a determination that a current playback location of the respective media corresponds to a first aspect ratio. For example, the representation of the respective media is displayed (e.g., with curvature) to at least partially surround a location corresponding to a current viewpoint of the user in the three-dimensional environment (e.g., the representation of the respective media is displayed to surround the location corresponding to the current viewpoint of the user by 45, 70, 90, 105, 135, 150, or 180 degrees). In some embodiments, displaying the representation of the respective media with curvature in the three-dimensional environment includes curving the representation of the respective media about a location (e.g., about a focal point) in the three-dimensional environment corresponding to the current viewpoint of the user (e.g., the curvature of the representation of the respective media is directed toward the current viewpoint of the user). In some embodiments, displaying the representation of the respective media with the first size relative to the three-dimensional environment includes displaying the representation of the respective media with no curvature relative to the three-dimensional environment.

In some embodiments, displaying the representation of the respective media with the second size relative to the three-dimensional environment includes displaying the representation of the respective media with a second amount, different from the first amount (e.g. greater than the first amount or less than the first amount), of curvature relative to the three-dimensional environment (and/or relative to the current viewpoint of the user), such as with the amount of curvature of representation 702 shown in FIG. 7M (as compared to the amount of curvature of representation shown in FIG. 7I and/or FIG. 7L). In some embodiments, the computer system increases the curvature of the representation of the respective media in accordance with a determination that the change in the current playback location of the respective media corresponds to a first aspect ratio (e.g., 1.43:1 or 1.90:1). For example, the first aspect ratio corresponds to a ratio between the length (e.g., width) and height of the respective media when it is displayed without curvature. In some embodiments, displaying the representation of the respective media with the second size relative to the three-dimensional environment includes displaying the representation of the respective media with a length (e.g., width) of the representation of the respective media that is based on the second amount of curvature of the representation of the respective media (e.g., the computer system determines a first dimension (e.g., width) of the representation of the respective media based on the amount of curvature that the representation of the respective media will be displayed with). In some embodiments, in accordance with a determination that the change in the current playback location of the respective media does not correspond to the first aspect ratio (e.g., the aspect ratio does not change based on the change in the current playback location, or the aspect ratio changes to a second aspect ratio, different from the first aspect ratio), the computer system forgoes increasing the curvature of the representation of the respective media. In some embodiments, the computer system changes the curvature of the representation of the respective media in response to user input (e.g., corresponding to a request to display the representation of the respective media with curvature in the three-dimensional environment). In some embodiments, displaying the representation of the respective media with the second size relative to the three-dimensional environment includes increasing a curvature (e.g., increasing the degrees of curvature and/or the arc length) of the representation of the respective media relative to the three-dimensional environment. For example, the representation of the respective media of the second size surrounds the location corresponding to the current viewpoint of the user in the three-dimensional environment by a greater amount than the representation of the respective media of the first size. In some embodiments, displaying the representation of the respective media with the second size relative to the three-dimensional environment includes decreasing a curvature (e.g., decreasing the degrees of curvature and/or arc length) of the representation of the respective media relative to the three-dimensional environment. For example, the representation of the respective media of the first size surrounds the location corresponding to the current viewpoint of the user in the three-dimensional environment by a greater amount than the representation of the respective media of the second size. In some embodiments, displaying the representation of the respective media with the second size relative to the three-dimensional environment includes increasing a surface area (e.g., a height and/or width) of the representation of the respective media relative to the three-dimensional environment (e.g., while increasing the curvature of the representation of the respective media). In some embodiments, displaying the representation of the respective media with the second size relative to the three-dimensional environment includes decreasing a surface area (e.g., a height and/or width) of the representation of the respective media relative to the three-dimensional environment (e.g., while decreasing the curvature of the representation of the respective media). In some embodiments, displaying the representation of the respective media with the second size relative to the three-dimensional environment includes displaying the representation of the respective media with no curvature relative to the three-dimensional environment (e.g., and displaying the representation of the respective media with the first size relative to the three-dimensional environment includes displaying the representation of the respective media with curvature relative to the three-dimensional environment).

The representation of the respective media is optionally immersive content displayed in the three-dimensional environment (e.g., the immersive content shown in FIGS. 7L-7M). For example, the computer system changes a curvature of the representation of the respective media in the three-dimensional environment in response to a user input to change a level of immersion of the representation of the respective media or changes the curvature—optionally corresponding to immersion of the respective media—in response to the changing of the playback position (and therefore the size and/or aspect ratio) of the respective media (e.g., the first amount of curvature corresponds to a first level of immersion, and the second amount of curvature corresponds to a second level of immersion). In some embodiments, a particular level of immersion corresponds to the angular range of the three-dimensional environment that is occupied by the representation of the respective media displayed via the display generation component (e.g., 9 degrees, 15 degrees, 30 degrees, 45 degrees, 60 degrees, 80 degrees, 100 degrees, 120 degrees, 160 degrees, 240 degrees, 275 degrees, 360 degrees, or another angular distance between opposite edges (e.g., a left and a right edge) of the representation of the respective media from a location corresponding to the current viewpoint of the user), optionally independent of whether an edge of the representation of the respective media is visible from a current viewpoint of the user. In some embodiments a particular level of immersion corresponds to minimum immersion, low immersion, medium immersion, high immersion, or maximum immersion (e.g., 60 degrees of content displayed at low immersion, 120 degrees of content displayed at medium immersion, 180 degrees of content displayed at high immersion, or 360 degrees of content displayed at maximum immersion). In some embodiments, the maximum level of immersion corresponds to an angular range of the three-dimensional environment that is occupied by the representation of the respective media displayed via the display generation component that is a value less than 360 degrees, such as 180 degrees.

In some embodiments, the computer system displays, via the display generation component, the representation of the respective media at a respective level of immersion (e.g., the level of immersion of representation 702 shown in FIG. 7L or 7M). In some embodiments, the respective level of immersion corresponds to a respective amount of field of view that the representation of the respective media consumes. For example, when the computer system displays the representation of the respective media at a first level of immersion (optionally from a viewpoint of a user of the computer system), the representation of the respective media optionally consumes (e.g., is bounded within) a first amount of field of view of the three-dimensional environment that is visible via the display generation component, and when the computer system displays the representation of the respective media at a second level of immersion (optionally from the viewpoint of the user of the computer system), different from the first level of immersion, the virtual environment optionally consumes (e.g., is bounded within) a second amount of field of view different from the first amount of field of view of the three-dimensional environment that is visible via the display generation component.

Changing a curvature of a representation of respective media in a three-dimensional environment in response to a change in playback location of the respective media minimizes the need for user input to accommodate a change in aspect ratio of the respective media (e.g., associated with the change in the playback location) that is designed to be viewed with a curved representation in the three-dimensional environment, thereby improving user device interaction and conserving computing resources associated with user input to change the representation

It should be understood that the particular order in which the operations in method 800 have been described is merely an example and is not intended to indicate that the described order is the only order in which the operations could be performed. One of ordinary skill in the art would recognize various ways to reorder the operations described herein. In some embodiments, aspects/operations of method 800 may be interchanged, substituted, and/or added between these methods. For example, various techniques for displaying a representation of respective media and/or detecting changes in aspect ratio of respective media and/or displaying simulated lighting effects of method 800 are optionally interchanged, substituted, and/or added between these methods. For brevity, these details are not repeated here.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best use the invention and various described embodiments with various modifications as are suited to the particular use contemplated.

As described above, one aspect of the present technology is the gathering and use of data available from various sources to improve XR experiences of users. The present disclosure contemplates that in some instances, this gathered data may include personal information data that uniquely identifies or can be used to contact or locate a specific person. Such personal information data can include demographic data, location-based data, telephone numbers, email addresses, social media IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to improve an XR experience of a user. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of XR experiences, the present technology can be configured to allow users to select to “opt in” or “opt out” of participation in the collection of personal information data during registration for services or anytime thereafter. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, an XR experience can be generated by inferring preferences based on non-personal information data or a bare minimum amount of personal information, such as the content being requested by the device associated with a user, other non-personal information available to the service, or publicly available information.

1. A method, comprising:
at a computer system in communication with a display generation component and one or more input devices:
while displaying a representation of respective media in a three-dimensional environment with a first size relative to the three-dimensional environment, wherein the representation of the respective media overlaps a first portion of the three-dimensional environment from a current viewpoint of a user of the computer system, detecting a change in a current playback location of the respective media; and
in response to detecting the change in the current playback location of the respective media, displaying the representation of the respective media with a second size relative to the three-dimensional environment such that the representation of the respective media overlaps a second portion of the three-dimensional environment from the current viewpoint of the user, different from the first portion of the three-dimensional environment.

2. The method of claim 1, wherein the detected change in the current playback location of the respective media occurs during playback of the respective media.

3. The method of claim 1, wherein the detected change in the current playback location of the respective media is in response to a user input corresponding to changing the current playback location of the respective media.

4. The method of claim 1, wherein displaying the representation of the respective media with the first size relative to the three-dimensional environment includes displaying the representation of the respective media with a first aspect ratio, and wherein displaying the representation of the respective media with the second size relative to the three-dimensional environment includes displaying the representation of the respective media with a second aspect ratio, different from the first aspect ratio.

5. The method of claim 4, wherein detecting the change in a current playback location of the respective media includes detecting a change in aspect ratio of the respective media from information associated with the respective media.

6. The method of claim 4, wherein detecting the change in the current playback location of the respective media includes:
in accordance with a determination that the respective media includes first content at the changed current playback location, detecting a first change in aspect ratio of the respective media; and
in accordance with a determination that the respective media includes second content, different from the first content, at the changed current playback location, detecting a second change in aspect ratio, different from the first change in aspect ratio.

7. The method of claim 1, wherein the first portion of the three-dimensional environment includes a representation of a physical environment of the user.

8. The method of claim 1, wherein the first portion of the three-dimensional environment includes a representation of a virtual environment.

9. The method of claim 1, further comprising:
while displaying the representation of the respective media in the three-dimensional environment:
in accordance with a determination that the respective media includes first content at a current playback position, displaying a simulated lighting effect in a third portion of the three-dimensional environment with a first visual appearance, wherein the third portion of the three-dimensional environment is outside of the representation of the respective media; and
in accordance with a determination that the respective media includes second content, different from the first content, at the current playback position, displaying the simulated lighting effect in the third portion of the three-dimensional environment with a second visual appearance, different from the first visual appearance.

10. The method of claim 9, further comprising:
while displaying the representation of the respective media in the three-dimensional environment:
in accordance with a determination that the representation of the respective media has the first size, displaying the simulated lighting effect in the third portion of the three-dimensional environment with a third size; and
in accordance with a determination that the representation of the respective media has the second size, displaying the simulated lighting effect in the third portion of the three-dimensional environment with a fourth size, different from the third size.

11. The method of claim 9, further comprising:
while displaying the representation of the respective media in the three-dimensional environment:
in accordance with a determination that the current playback location of the respective media is a first playback location including the first content, displaying the simulated lighting effect with a first set of visual effects; and
in accordance with a determination that the current playback location of the respective media is a second playback location including the second content, displaying the simulated lighting effect with a second set of visual effects, different from the first set of visual effects.

12. The method of claim 1, further comprising:
while displaying the representation of the respective media with the second size relative to the three-dimensional environment, detecting, via the one or more input devices, a user input corresponding to a request to change a size of the representation of the respective media from the second size to a third size, different from the second size, relative to the three-dimensional environment; and
in response to detecting the user input, displaying the representation of the respective media with the third size relative to the three-dimensional environment.

13. The method of claim 12, wherein:
the representation of the respective media has a first aspect ratio when the representation of the respective media is displayed with the second size relative to the three-dimensional environment, and
displaying the representation of the respective media with the third size relative to the three-dimensional environment includes maintaining the first aspect ratio of the representation of the respective media.

14. The method of claim 1, wherein:
displaying the representation of the respective media with the first size relative to the three-dimensional environment includes displaying the representation of the respective media with a first dimension of a first value, and
displaying the representation of the respective media with the second size relative to the three-dimensional environment includes displaying the representation of the respective media with the first dimension of the first value.

15. The method of claim 1, wherein displaying the representation of the respective media with the second size relative to the three-dimensional environment includes:
in accordance with a determination that the change in the current playback location of the respective media corresponds to a change from a first aspect ratio to a second aspect ratio of the respective media, changing a first dimension of the representation of the respective media without changing a second dimension, different from the first dimension, of the representation of the respective media; and
in accordance with a determination that the change in the current playback location of the respective media corresponds to a change from the first aspect ratio to a third aspect ratio, different from the second aspect ratio, of the respective media, changing the second dimension of the representation of the respective media.

16. The method of claim 1, wherein displaying the representation of the respective media with the second size relative to the three-dimensional environment includes:
in accordance with a determination that the three-dimensional environment includes a virtual environment of a first type, changing a first dimension of the representation of the respective media in a first direction along a first axis in the three-dimensional environment without changing the first dimension in a second direction opposite the first direction along the first axis; and
in accordance with a determination that the three-dimensional environment includes a virtual environment of a second type, different from the first type, changing the first dimension of the representation of the respective media in the first direction and the second direction, opposite from the first direction, along the first axis in the three-dimensional environment.

17. The method of claim 1, wherein the three-dimensional environment includes one or more virtual surfaces that are visible from the current viewpoint of the user in a third portion of the three-dimensional environment, the method further comprising:
in response to detecting the change in the current playback location of the respective media, decreasing a visibility of the one or more virtual surfaces in the three-dimensional environment and expanding the representation of the respective media at least partially into the third portion of the three-dimensional environment.

18. The method of claim 17, wherein the three-dimensional environment includes a simulated lighting effect on the one or more virtual surfaces, and wherein decreasing the visibility of the one or more virtual surfaces in the three-dimensional environment includes reducing a visual prominence of the simulated lighting effect on the one or more virtual surfaces in the three-dimensional environment.

19. The method of claim 1, wherein:
displaying the representation of the respective media with the first size relative to the three-dimensional environment includes displaying the representation of the respective media with a first amount of curvature relative to the three-dimensional environment, and
displaying the representation of the respective media with the second size relative to the three-dimensional environment includes displaying the representation of the respective media with a second amount, different from the first amount, of curvature relative to the three-dimensional environment.

20. A computer system that is in communication with a display generation component and one or more input devices, the computer system comprising:
one or more processors;
memory; and
one or more programs, wherein the one or more programs are stored in the memory and configured to be executed by the one or more processors, the one or more programs including instructions for:
while displaying a representation of respective media in a three-dimensional environment with a first size relative to the three-dimensional environment, wherein the representation of the respective media overlaps a first portion of the three-dimensional environment from a current viewpoint of a user of the computer system, detecting a change in a current playback location of the respective media; and
in response to detecting the change in the current playback location of the respective media, displaying the representation of the respective media with a second size relative to the three-dimensional environment such that the representation of the respective media overlaps a second portion of the three-dimensional environment from the current viewpoint of the user, different from the first portion of the three-dimensional environment.

21. A non-transitory computer readable storage medium storing one or more programs, the one or more programs comprising instructions, which when executed by one or more processors of a computer system that is in communication with a display generation component and one or more input devices, cause the computer system to perform a method comprising:
while displaying a representation of respective media in a three-dimensional environment with a first size relative to the three-dimensional environment, wherein the representation of the respective media overlaps a first portion of the three-dimensional environment from a current viewpoint of a user of the computer system, detecting a change in a current playback location of the respective media; and
in response to detecting the change in the current playback location of the respective media, displaying the representation of the respective media with a second size relative to the three-dimensional environment such that the representation of the respective media overlaps a second portion of the three-dimensional environment from the current viewpoint of the user, different from the first portion of the three-dimensional environment.
